(19) United States
(12) Patent Application Publication
(10) Pub. No.: US 2006/0256072 A1
(43) Pub. Date: Nov. 16, 2006

(54) Information processing device, information processing system, operating article, information processing method, information processing program, and game system

(75) Inventors: Hiromu Ueshima, Shiga (JP); Keiichi Yasumura, Shiga (JP); Mitsuru Okayama, Shiga (JP)

Correspondence Address: OSHA LIANG L.L.P., 1221 MCKINNEY STREET, SUITE 2800, HOUSTON, TX, 77010, US

(73) Assignee: SSD Company Limited, Shiga (JP)

(21) Appl. No.: 10/562,592

(22) PCT Filed: Jun. 29, 2004
(86) PCT No.: PCT/JP04/09490

§ 371 Date: Jul. 5, 2006

(30) Foreign Application Priority Data
Jul. 2, 2003 (JP) 2003-270245

(51) Int. Cl. G09G 5/00

(52) U.S. Cl. 345/156

(57) ABSTRACT

A sword (3: FIG. 2) which is intermittently irradiated infrared light by infrared emitting diodes (7: FIG. 2) is photograph by an imaging unit (5: FIG. 2), and thereby motion of the sword is detected. The sword locus object (117: FIG. 14) representing a movement locus of the sword is displayed on a television monitor (90: FIG. 1) in response to detection of swing of the sword as a trigger.

### TECHNICAL FIELD

This invention relates to an information processing apparatus and the related arts for displaying an image on a display device based on the result of detecting an operation article grasped and operated by an operator by means of a stroboscope.

### BACKGROUND ART

A prior art image generation system which is disclosed in the Jpn. Unexamined Patent Publication No. 2003-79943 (FIG. 1 and FIG. 3) will be explained with reference to diagrams.

FIG. 65 is a view showing the prior art image generation system. As shown in FIG. 65, a two dimensional detection plane 1100 is formed in a detection plane forming frame 1000. The detection plane forming frame 1000 is provided with sensors s1 and s2 at each end of a side sd1 thereof.

The sensor s1 has a light emission unit and a light receiving unit. The light emission unit emits an infrared-ray within the range of the angle “θ1” which is between 0 degree and 90 degree, and the light receiving unit receives the return light. An operation article as a subject is provided with a reflective member. Therefore, the infrared-ray is reflected by the reflective member, and then received by the light receiving unit. For the sensor s2, a similar manner is adopted.

The result that the sensor s1 receives the light is obtained as an image-formation “im1”, and the result that the sensor s2 receives the light is obtained as an image-formation “im2”. When the operation article as the subject crosses the detection plane 1100, shaded parts appear in the image-formation “im1” and “im2” because there is the light which is not reflected by the operation article. Because of this, unshaded parts can be distinguished as an angle θ1 and an angle θ2. In addition, since the sensors s1 and s2 are secured, the position p(x, y) where the operation article crosses the detection plane 1100 can be specified in accordance with the angle θ1 and the angle θ2.

It is possible to specify the position on a screen corresponding to the position where the operation article crosses the detection plane 1100 by relating each position on the detection plane 1100 which is formed within the detection plane frame 1000 to each position on the screen in one-to-one correspondence.

In this way, a position of the operation article or a change amount of the position of the operation article can be obtained, and it is reflected on a movement of an object on the screen.

However, as mentioned above, in the prior art image generation system, the detection plane frame 1000 has to be built and further the sensors s1 and s2 have to be set up on two corners. Because of this, the system becomes large-scale and thereby becomes expensive, and furthermore a large installation site is necessary. Therefore, it is hard to say that the prior art system is suitable for general families.

Besides, since it is necessary to relate each position on the detection plane 1100 to each position on the screen in one-to-one correspondence, a restriction on deciding a shape of the detection plane frame 1000 increases. This is one of reasons why an installation site is limited.

In addition, since an operator has to operate the operation article within the detection plane frame 1000, a restraint when operating the operation article increases. On the other hand, it is necessary to form the bigger detection plane frame 1000 to decrease a restraint when operating the operation article. This causes that a restriction of an installation site increases and it becomes more expansive, therefore, it is more difficult to buy for general families.

Furthermore, the operation article has to be operated so that it crosses the two dimensional detection plane 1100. This also increases a restriction on operating the operation article. In other words, since the operation article has to cross through the two dimensional detection plane 1100, the operator can not move the operation article in z-axis direction which is perpendicular to the detection plane 1100 and therefore freedom degree of operation becomes smaller. As disclosed in above reference, even if two detection plane frames are formed, this problem can not be improved completely. In addition, if the number of detection plane frames increase, this causes more the matter of an installation cite and the matter of a price. Therefore it is harder to buy for general families.

### DISCLOSURE OF INVENTION

It is therefore the object of the present invention to provide an information processing apparatus and techniques related thereto capable of displaying an image that reflects the results of detecting an operation article operated by an operator while reducing occupied space and improving freedom degree of operation.

In accordance with a first aspect of the present invention, an information processing apparatus for displaying on a display device an image reflected a motion of an operation article which is held and given the motion by an operator, said information processing apparatus comprising: a stroboscope operable to emit light to the operation article which has a reflecting surface in a predetermined cycle; an imaging unit operable to photograph the operation article with and without light emitted from said stroboscope and acquire a lighted image and an unlighted image; a differential signal generating unit operable to generate a differential signal between the lighted image and the unlighted image; a state information computing unit operable to compute state information of the operation article on the basis of the differential signal and generate a first trigger on the basis of the state information; and an image display processing unit operable to display a first object representing a movement locus of the operation article in response to the first trigger on the display device.

By this configuration, the state information of the operation article is obtained by capturing an image of the operation article intermittently illuminated by the stroboscope. Thus, it is possible to acquire the state information of the operation article within a (three dimensional) detection space, that is the photographing range of the imaging unit, without forming a (two dimensional) detection plane in the real space. Accordingly, the operable range of the operation article is not restricted to the two dimensional plane so that the restriction of the operation of the operation article by the operator 94 decreases, and thereby it is possible to increase the flexibility of the operation of the operation article.

Also, it is not necessary to create a detection face corresponding to the screen of the display device in real space. Therefore, it is possible to reduce the limitation on the installation places (the saving of a space).

Furthermore, the first object representing the movement locus of the operation article is displayed on the display device in response to the first trigger on the basis of the state information of the operation article. Because of this, the operator can see on the display device the movement locus which is actually invisible and therefore can operate the operation article with more feeling.

Still further, the movement locus of the operation article operated by the operator appears in a virtual world displayed on the display device. The operator can make contact with the virtual world through the movement locus of the operation article, and furthermore enjoy the virtual world. For example, in the case where the information processing apparatus according to the present invention is used as a game machine, it is possible for the operator to have an experience as if he were enjoying a game in a game world displayed on the display device.

Still further, the detection can be performed with a high degree of accuracy, reducing the dependency upon the influences of noise and external disturbance, only by a simple process of generating a differential signal between the lighted image signal and the non-lighted image signal, and therefore it is possible to realize the system with ease even under the limitation on the performance of the information processing apparatus due to a cost and a tolerable power consumption.

In the present specification, the “operation” of the operation article means moving the operation article, rotating the operation article, and so forth, but does not mean pressing a switch, moving an analog stick, and so forth.

In the above information processing apparatus, the first object representing the movement locus comprises a beltlike object, said image display processing unit is representative of the movement locus of the operation article by displaying the beltlike object on the display device so that a width varies for each frame, and the width of the beltlike object increases as the frame is updated, and thereafter decreases as the frame is updated.

By this configuration, it is possible to display a movement locus like a sharp flash. Particularly, the effect can be enhanced by appropriately selecting the color of the beltlike object.

In the above information processing apparatus, said image display processing unit displays a second object on the display device, said state information computing unit generates a second trigger when positional relation between the second object and the first object representing the movement locus of the operation article meets a predetermined condition, and said image display processing unit displays the second object given a predetermined effect on the display device in response to the second trigger.

By this configuration, it is possible to give an effect to the second object of a so-called virtual world displayed on the display device through the first object representing the movement locus of the operation article when the operator operates the operation article in order that the positional relationship satisfies the predetermined requirement. The operator can therefore furthermore enjoy the virtual world.

In the above information processing apparatus, said state information computing unit computes positional information as the state information of the operation article after speed information as the state information of the operation article exceeds a predetermined first threshold value until the speed information becomes less than a predetermined second threshold value, or computes the positional information of the operation article after the speed information of the operation article exceeds the predetermined first threshold value before the operation article deviates beyond the photographing range of said imaging unit, determines, when the positional information of the operation article is obtained for three or more times, the appearance of the first object representing the movement locus of the operation article on the basis of the first positional information of the operation article and the last positional information of the operation article, and generates, when the positional information of the operation article is obtained for three or more times, the first trigger on the basis of the state information.

By this configuration, since the first trigger is generated when the number of times the positional information of the operation article is obtained, i.e., the number of times the operation article is detected is three or more, it is possible to prevent the first object from unintentionally appearing when the operator involuntarily operates.

Also, in the case where the number of times the positional information of the operation article is obtained (the number of times the operation article is detected) is three or more, the appearance of the first object representing the movement locus of the operation article is determined on the basis of the positional information as firstly obtained of the operation article and the positional information as lastly obtained of the operation article. Because of this, it is possible to decide the appearance of the first object reflected the movement locus of the operation article in a more appropriate manner.

Incidentally, if the appearance of the first object is determined on the basis of the positional information relating to two adjacent positions of the operation article, for example, the following shortcomings would result. Even though the operator intends to move the operation article linearly, it may be moved with drawing like an arc in practice. In this case, the operation article is naturally photographed so as to draw an arc by the imaging unit. If the appearance of the first object is determined on the basis of the positional information relating to the two adjacent positions in the above situation, the first object would be displayed in such an appearance as departing from the intention of the operator.

In this case, the appearance of first object corresponds to, for example, the form of the first object to be displayed such as an angle and/or a direction of the first object.

In the above information processing apparatus, said state information computing unit computes area information as the state information of the operation article, and generates a third trigger when the area information exceeds a predetermined third threshold value, and said image display processing unit displays a third object on the display device in response to the third trigger.

By this configuration, when an image of a large reflecting surface of the operation article is captured, the third object is displayed. In other words, when the operator turns the large reflecting surface of the operation article towards the imaging unit, the third object is displayed. Consequently, it is possible to display various kinds of images by operating the single operation article. In addition, there is no need to use a plurality of operation articles, nor provide a switch, an analog stick and the like on the operation article for displaying various images, resulting in not only the reduction of the production cost of the operation article but also the improvement of the user-friendliness.

In the above information processing apparatus, said image display processing unit displays a character string on the display device, said state information computing unit generates a fourth trigger on the basis of the state information of the operation article, and said image display processing unit displays a character string differing from the character string on the display device in response to the fourth trigger.

By this configuration, since a character string can be displayed one after another on the display device on the basis of the state information of the operation article, there is no need to provide a switch, an analog stick and the like on the operation article for updating a character string, resulting in not only the reduction of the production cost of the operation article but also the improvement of the user-friendliness.

In the above information processing apparatus, said state information computing unit generates a fifth trigger on the basis of the state information of the operation article, and said image display processing unit updates a background image in response to the fifth trigger.

By this configuration, since the background can be updated on the basis of the state information of the operation article, there is no need to provide a switch, an analog stick and the like on the operation article for updating the background, resulting in not only the reduction of the production cost of the operation article but also the improvement of the user-friendliness.

The above information processing apparatus further comprises a correction information acquisition unit operable to acquire correction information for correcting positional information as the state information of the operation article, and said state information computing unit computes corrected positional information by using the correction information.

By this configuration, since it is possible to eliminate, as much as possible, the gap between the feeling of the operator operating the operation article and the state information of the operation article as calculated by the state information calculating unit, a suitable image can be displayed to reflect the operation of the operation article by the operator in a more appropriate manner.

In the above information processing apparatus, said image display processing unit displays a cursor on the display device and moves the cursor in accordance with positional information as the state information of the operation article.

By this configuration, since the cursor can be moved on the basis of the state information of the operation article, there is no need to provide a switch, an analog stick and the like on the operation article for moving the cursor, resulting in not only the reduction of the production cost of the operation article but also the improvement of the user-friendliness.

In the above information processing apparatus, execution of a predetermined process is fixed on the basis of the state information of the operation article.

By this configuration, since it is fix to execute the process on the basis of the state information of the operation article, there is no need to provide a switch, an analog stick and the like on the operation article for fixing the execution of the process, resulting in not only the reduction of the production cost of the operation article but also the improvement of the user-friendliness.

In the above information processing apparatus, when the cursor is displayed overlapping a fourth object, said image display processing unit displays an image associated with the fourth object on the display device.

By this configuration, the operator can display an image associated with the fourth object being displayed only by operating the operation article to move the cursor.

In the above information processing apparatus, said image display processing unit displays a character selected by the cursor on the display device.

By this configuration, since the operator can input a desired character only by operating the operation article to move the cursor and selecting the desired character, there is no need to provide a switch, an analog stick and the like on the operation article for inputting a desired character, resulting in not only the reduction of the production cost of the operation article but also the improvement of the user-friendliness.

In the above information processing apparatus, said state information computing unit generates a sixth trigger on the basis of the state information of the operation article, and said image display processing unit displays on the display device a fifth object corresponding to the motion of the operation article in response to the sixth trigger.

By this configuration, it is possible to provide the operator with a visual effect different than that given by the first object representing the movement locus of the operation article.

In the above information processing apparatus, said image display processing unit displays the first object representing the movement locus of the operation article on the display device after a lapse of a predetermined time from a generation of the first trigger.

By this configuration, it is possible to give the operator different effects as compared to the case that the first object representing the movement locus of the operation article is displayed at the substantially same time (at the same time in terms of human sensibility) as the first trigger is generated.

In the above information processing apparatus, said image display processing unit displays a sixth object on the display device when the state information obtained successively of the operation article meets a predetermined condition.

By this configuration, since the sixth object is displayed only when the operation of the operation article satisfies the predetermined condition requirement, it is possible to arbitrarily control the operation of the operation article by the operator for displaying the sixth object by changing the setting of this predetermined condition.

In the above information processing apparatus, said image display processing unit displays on the display device a guide which instructs an operation direction and operation timing of the operation article.

By this configuration, the operator can visually recognize the operation direction and operation timing of the operation article as required by the information processing apparatus.

In the above information processing apparatus, the state information includes one or a combination of two or more selected from speed information, moving direction information, moving distance information, velocity vector information, acceleration information, movement locus information, area information, and positional information.

By this configuration, it is possible to display objects on the display device in response to a variety of motion patterns of the operation article operated by the operator.

The above information processing apparatus further comprises a sound effect generating unit operable to output a sound effect through a speaker in response to the first trigger.

By this configuration, it is possible to provide the operator with auditory effects in addition to visual effects. The operator can therefore furthermore enjoy the virtual world on the display device. For example, if sound effects are generated at the same time as the movement locus of the operation article appears in the virtual world, the operator can furthermore enjoy the virtual world.

In accordance with a second aspect of the present invention, an information processing apparatus for displaying an image on a display device on the basis of a result of detecting an operation article which is grasped and given a motion by an operator, said information processing apparatus comprising: a stroboscope operable to emit light to the operation article which has a plurality of reflecting surfaces in a predetermined cycle; an imaging unit operable to photograph the operation article with and without light emitted from said stroboscope and acquire a lighted image and an unlighted image; a differential signal generating unit operable to generate a differential signal between the lighted image and the unlighted image; a state information computing unit operable to compute state information of the operation article on the basis of the differential signal and determine which of the plurality of reflecting surfaces is photographed on the basis of the state information; and an image display processing unit operable to display a different image on the display device depending on the determined reflecting surface.

By this configuration, the state information of the operation article is obtained by capturing an image of the operation article intermittently illuminated by the stroboscope. Thus, it is possible to acquire the state information of the operation article within a (three dimensional) detection space, that is the photographing range of the imaging unit, without forming a (two dimensional) detection plane in the real space. Accordingly, the operable range of the operation article is not restricted to the two dimensional plane so that the restriction of the operation of the operation article by the operator 94 decreases, and thereby it is possible to increase the flexibility of the operation of the operation article.

Also, it is not necessary to create a detection face corresponding to the screen of the display device in real space. Therefore, it is possible to reduce the limitation on the installation places (the saving of a space).

Furthermore, since the different image is displayed depending on the reflecting surface which is detected by the imaging unit 5, the different images corresponding to the number of the reflection surfaces can be displayed only by operating the single operation article. For this reason, there is no need to prepare a different operation article for each different image and provide a switch, an analog stick and the like on the operation article. Accordingly, it is possible to reduce the cost of the operation article and improve the operationality of the operation article operated by the operator.

Furthermore, the operator can display a desired image by turning an appropriate one of the reflecting surfaces of the operation article toward the imaging unit. For example, in the case where the information processing apparatus according to the present invention is used as a game machine, it is possible for the operator to display a variety of images by operating the single operation article and smoothly enjoy the game.

Still further, the detection can be performed with a high degree of accuracy, reducing the dependency upon the influences of noise and external disturbance, only by a simple process of generating a differential signal between the lighted image signal and the non-lighted image signal, and therefore it is possible to realize the system with ease even under the limitation on the performance of the information processing apparatus due to a cost and a tolerable power consumption.

In the above information processing apparatus, the state information includes any one of area information, number information, profile information, and ratio information indicative of a profile, or a combination thereof about the reflecting surface.

By this configuration, the state information calculating unit can judge which of the plurality of reflecting surfaces is captured on the basis of the above information. Accordingly, it is easy to decide which of the plurality of reflecting surfaces is photographed only by forming reflecting surfaces which are different in a size or a profile. Particularly, in the case where the reflecting surfaces are distinguished with reference to the area information, it is possible not only to avoid erroneous determination as much as possible but also to facilitate and speed up the processing.

In accordance with a third aspect of the present invention, an information processing apparatus for displaying an image on a display device on the basis of a result of detecting an operation article which is grasped and given a motion by an operator, said information processing apparatus comprising: a stroboscope operable emit light to the operation article which has a plurality of reflecting surfaces in a predetermined cycle; an imaging unit operable to photograph the operation article with and without light emitted from said stroboscope and acquire a lighted image and an unlighted image; a differential signal generating unit operable to generate a differential signal between the lighted image and the unlighted image; a state information computing unit operable to compute state information of each of the reflecting surfaces on the basis of the differential signal; and an image display processing unit operable to display an image on the display device in accordance with the state information of the plurality of reflecting surfaces.

By this configuration, the state information of the operation article is obtained by capturing an image of the operation article intermittently illuminated by the stroboscope. Thus, it is possible to acquire the state information of the operation article within a (three dimensional) detection space, that is the photographing range of the imaging unit, without forming a (two dimensional) detection plane in the real space. Accordingly, the operable range of the operation article is not restricted to the two dimensional plane so that the restriction of the operation of the operation article by the operator 94 decreases, and thereby it is possible to increase the flexibility of the operation of the operation article.

Also, it is not necessary to create a detection face corresponding to the screen of the display device in real space. Therefore, it is possible to reduce the limitation on the installation places (the saving of a space).

Furthermore, since an image is displayed in accordance with the state information of the plurality of reflecting surfaces, the state of the operation article is more effectively reflected to the image as compared to the case where an image is displayed in accordance with the state information of a single reflecting surface.

Still further, the detection can be performed with a high degree of accuracy, reducing the dependency upon the influences of noise and external disturbance, only by a simple process of generating a differential signal between the lighted image signal and the non-lighted image signal, and therefore it is possible to realize the system with ease even under the limitation on the performance of the information processing apparatus due to a cost and a tolerable power consumption.

In accordance with a fourth aspect of the present invention, a game system for playing a game comprising: an operation article actually operated by an operator; an image sensor operable to photograph said operation article operated by the operator; and a processing device which is connected to a display device when playing the game, receives an image signal from said image sensor and displays contents of the game on the display device, wherein said operation article serves a prescribed role in the game on the basis of a image of said operation article photographed by said image sensor, a movement locus of said operation article is simplified as a beltlike image in the contents displayed on the display device by said processing device when playing the game, the beltlike image is a connection between at least two points of a movement locus of said operation article operated by the operator, and the at least two points which is displayed on the display device are obtained in accordance with images given by said image sensor.

The novel features believed characteristic of the invention are set forth in the appended claims. However, the invention itself, other features, and advantages thereof, may be better understood by reference to the following detailed description of an illustrative embodiment when read in conjunction with the accompanying drawings.

### BRIEF DESCRIPTION OF DRAWINGS

FIG. 1 is a view showing an overall configuration of the information processing system in accordance with the embodiment of the present invention.

FIG. 2 is enlarged views of the information processing apparatus and the sword of FIG. 1.

FIG. 3 is a top view of the sword of FIG. 2.

FIG. 4 is an enlarged view of another example of the sword of FIG. 1.

FIG. 5 is a top view of the sword of FIG. 4.

FIG. 6 is a view showing an example of the imaging unit of FIG. 2.

FIG. 7 is a view showing an electrical structure of the information processing apparatus of FIG. 1.

FIG. 8 is a block diagram showing the high speed processor of FIG. 7.

FIG. 9 is a circuit diagram showing a configuration for inputting pixel data from the image sensor to the high speed processor of FIG. 7, and an LED driver circuit.

FIG. 10(a) is a timing chart of a frame status flag signal FSF output from the image sensor of FIG. 9. FIG. 10(b) is a timing chart of a pixel data strobe signal PDS output from the image sensor of FIG. 9. FIG. 10(c) is a timing chart of pixel data D(X,Y) output from the image sensor of FIG. 9. FIG. 10(d) is a timing chart of an LED control signal LEDC output from the high speed processor of FIG. 9. FIG. 10(e) is a timing chart illustrating a flashing status of the infrared-emitting diodes of FIG. 9. FIG. 10(f) is a timing chart of an exposure period of the image sensor of FIG. 9.

FIG. 11(a) is an enlarged timing diagram of the frame status flag signal FSF of FIG. 10. FIG. 11(b) is an enlarged timing diagram of the pixel data strobe signal PDS FIG. 10. FIG. 11(c) is an enlarged timing diagram of the pixel data D(X,Y) FIG. 10.

FIG. 12 is a view showing an example of a selection screen which is displayed on the screen of the television monitor of FIG. 1.

FIG. 13 is a view showing an example of a game screen when the content object corresponding to the story mode is selected in the selection screen of FIG. 12.

FIG. 14 is a view showing another example of a game screen when the content object corresponding to the story mode is selected in the selection screen of FIG. 12.

FIG. 15 is a view showing further example of a game screen when the content object corresponding to the story mode is selected in the selection screen of FIG. 12.

FIG. 16 is a view showing further example of a game screen when the content object corresponding to the story mode is selected in the selection screen of FIG. 12.

FIG. 17 is a view showing further example of a game screen when the content object corresponding to the story mode is selected in the selection screen of FIG. 12.

FIG. 18(a) is a view showing further example of a game screen when the content object corresponding to the story mode is selected in the selection screen of FIG. 12. FIG. 18(b) is a view showing an example of an updated game screen of FIG. 18(a).

FIG. 19 is a view showing an example of a game screen when the content object indicating the battle mode is selected in the selection screen of FIG. 12.

FIG. 20 is a conceptual illustration of the program and data stored in the ROM of FIG. 7.

FIG. 21(a) is a view showing an example of an image which is photographed by a general image sensor and is not applied special processes. FIG. 21(b) is a view showing the image signal which is the result of level-discriminating the image signal of FIG. 21(a) on the basis of a predetermined threshold value. FIG. 21(c) is a view showing an example of an image signal which is a result of level-discriminating an image signal which is photographed by an image sensor through an infrared filter during a light emitting period on the basis of a predetermined threshold value. FIG. 21(d) is a view showing an example of an image signal which is a result of level-discriminating an image signal which is photographed by the image sensor through the infrared filter during a non-light emitting period on the basis of the predetermined threshold value. FIG. 21(e) is a view showing the differential signal between the lighted image signal and the non-lighted image signal.

FIG. 22 is a diagram for explaining the way that the high speed processor of FIG. 7 detects the swing of the sword.

FIG. 23(a) is a view showing a relation between a value of an angle flag and an angle in accordance with the embodiment. FIG. 23(b) is a view showing a relation between a value of a direction flag and a sign representing a direction in accordance with the embodiment. FIG. 23(c) is a view showing a relation among the angle flag, the direction flag and swing information in accordance with the embodiment.

FIG. 24 is a view showing a relation between the swing information of FIG. 23(c) and a swing direction of the sword.

FIG. 25 is a view showing a relation between the swing information of FIG. 23(c) and animation table storage location information.

FIG. 26 is a view showing an example of an animation table which is stored in the ROM of FIG. 7 to animate a sword locus object.

FIG. 27 is an example of object image data to animate the sword locus object of FIG. 14.

FIG. 28 is another example of object image data to animate the sword locus object of FIG. 14.

FIG. 29 is another example of object image data to animate the sword locus object of FIG. 14.

FIG. 30 is a diagram for explaining the hit judging process by the high speed processor of FIG. 7.

FIG. 31 is a view showing an example of a swing correcting screen when the content object indicating the swing correction is selected in the selection screen of FIG. 12.

FIG. 32 is a flowchart showing the overall process flow of the information processing apparatus of FIG. 1.

FIG. 33 is a flowchart showing the process of initialization in step S1 of FIG. 32.

FIG. 34 is a flowchart showing the process flow of initializing the sensor in step S20 of FIG. 33.

FIG. 35 is a flowchart showing the process flow of the command transmission in step S31 of the FIG. 34.

FIG. 36(a) is a timing chart illustrating the register setting clock CLK of FIG. 9. FIG. 36(b) is a timing chart illustrating the register data of FIG. 9.

FIG. 37 is a flowchart showing the flow of the resister setting process in step S33 of FIG. 34.

FIG. 38 is a flowchart showing the process flow of the story mode in step S7 of FIG. 32.

FIG. 39 is a flowchart showing the process flow of acquiring pixel data aggregation in step S60 of FIG. 38.

FIG. 40 is a flowchart showing the process flow of acquiring pixel data in step S81 of FIG. 39.

FIG. 41 is a flowchart showing the process flow of extracting a target area in step S61 of FIG. 38.

FIG. 42 is a flowchart showing the process flow of extracting a target point in step S62 of FIG. 38.

FIG. 43 is a flowchart showing the process flow of detecting a swing in step S63 of FIG. 38.

FIG. 44 is a flowchart showing the process flow of determining a type of a sword locus in step S166 of FIG. 43.

FIG. 45 is a flowchart showing the process flow of calculating coordinates of a sword locus in step S167 of FIG. 43.

FIG. 46 is a flowchart showing the flow of the hit judging process in step S64 of FIG. 38.

FIG. 47 is a flowchart showing the process flow of detecting a shield in step S65 of FIG. 38.

FIG. 48 is a flowchart showing the process flow of proceeding an explanation in step S66 of FIG. 38.

FIG. 49 is a flowchart showing the process flow of forwarding in step S67 of FIG. 38.

FIG. 50 is a flowchart showing the process flow of displaying an image in step S70 of FIG. 38.

FIG. 51 is a flowchart showing the process flow of selecting a mode in step S5 of FIG. 32.

FIG. 52 is a flowchart showing the process flow of moving a cursor in step S303 of FIG. 51.

FIG. 53 is a flowchart showing the process flow of moving a content object in step S304 of FIG. 51.

FIG. 54 is a flowchart showing the process flow of the swing correcting mode in step S6 of FIG. 32.

FIG. 55 is a flowchart showing the process flow of acquiring correction information in step S404 of FIG. 54.

FIG. 56 is a flowchart showing the flow of the stroboscopic imaging process by the imaging unit of FIG. 6.

FIG. 57 is a view showing other example of a game screen in accordance with the embodiment.

FIG. 58 is a view showing further example of a game screen in accordance with the embodiment.

FIG. 59 is a view showing further example of a game screen in accordance with the embodiment.

FIG. 60 is a view showing further example of a game screen in accordance with the embodiment.

FIG. 61(a) is further example of the sword of FIG. 1. FIG. 61(b) is further example of the sword of FIG. 1. FIG. 61(c) is further example of the sword of FIG. 1.

FIG. 62 is a view showing other example of a operation article in accordance with the embodiment.

FIG. 63 is an explanatory diagram of calculating coordinates of a target point of the first reflecting sheet in accordance with the embodiment.

FIG. 64 is an explanatory diagram showing a method to obtain coordinates of a target point of the second reflecting sheet in accordance with the embodiment.

FIG. 65 is a view showing the prior art image generation system.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated.

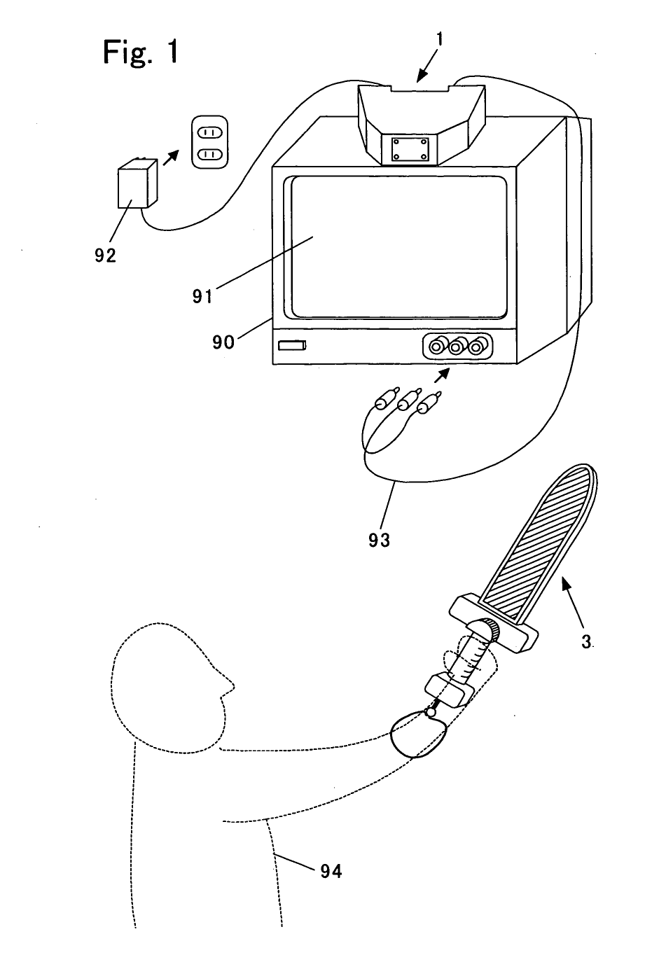

FIG. 1 is a view showing the overall configuration of the information processing system in accordance with the embodiment of the present invention. As illustrated in FIG. 1, this information processing system includes an information processing apparatus 1, an operation article 3, and a television monitor 90.

In this embodiment, the operation article 3 (referred as “sword 3” in the following description in the present embodiment) is designed in the form of a sword as an exemplary design. In addition, game processing is given as an example of information processing in this embodiment.

The information processing apparatus 1 is supplied with a direct current power voltage through an AC adapter 92. Alternatively, it is possible to use a battery (not shown) to supply a direct current power voltage in place of the AC adapter 92.

The television monitor 90 is provided with a screen 91 on its front. The information processing apparatus 1 is connected to the television monitor 90 by an AV cable 93.

For example, the information processing apparatus 1 is set up on an upper surface of the television monitor 90 as illustrated in FIG. 1.

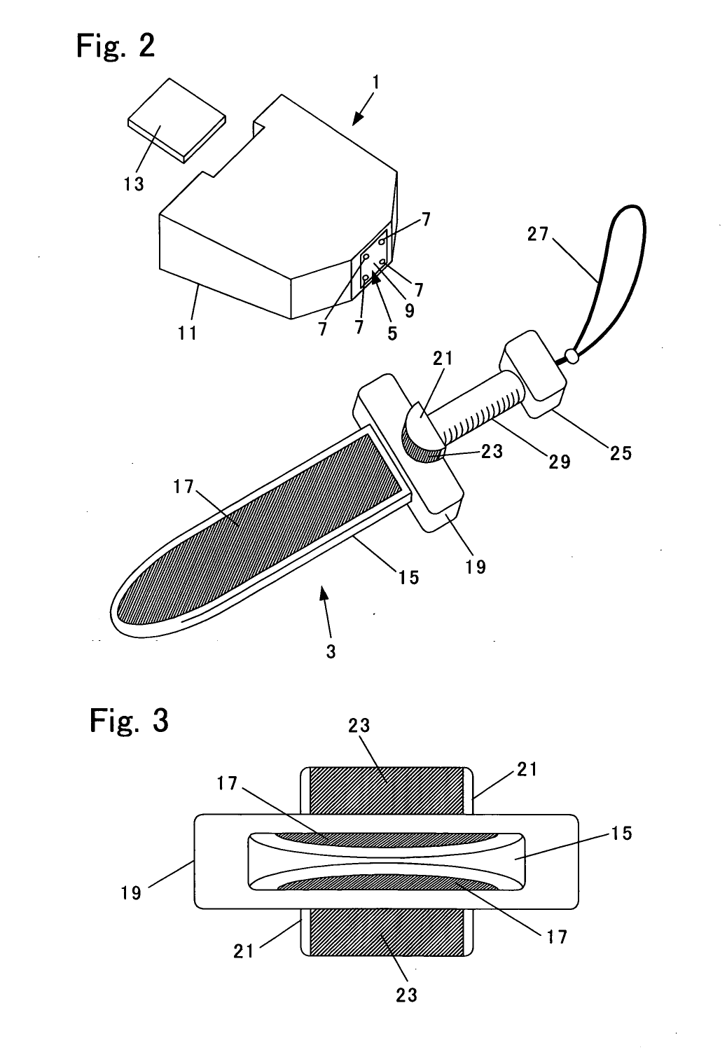

FIG. 2 is enlarged views of the information processing apparatus 1 and the sword 3 of FIG. 1. FIG. 3 is a top view of the sword 3 of FIG. 2.

As illustrated in FIG. 2, the information processing apparatus 1 is provided with an imaging unit 5 in its housing 11. The imaging unit 5 has four infrared-emitting diodes 7 and an infrared filter 9. Light emitting portions of the infrared-emitting diodes 7 are exposed from the infrared filter 9.

The infrared-emitting diodes 7 in the imaging unit 5 emit infrared light intermittently. The infrared light from the infrared-emitting diodes 7 is reflected by the sword 3, and then the return light is input to an imaging device (to be described below) provided behind the infrared filter 9. In this way, the sword 3 is photographed intermittently. Therefore, the information processing apparatus 1 can acquire intermittent image signals of the sword 3 brandished by an operator 94. The information processing apparatus 1 analyzes the image signals, and reflects the result to game processing.

Furthermore, a memory cartridge 13 can be inserted into the back face of the information processing apparatus 1. This memory cartridge 13 has a built-in EEPROM (electrically erasable and programmable read only memory) (not shown). It is possible to save results of a story-mode game played by one player in this EEPROM.

Additionally, as illustrated in FIG. 2 and FIG. 3, the sword 3 is provided with reflecting sheets 17 on both sides of a blade 15. In this way, reflecting surfaces are formed by attaching the reflecting sheets 17. In addition, semicylinder-shaped components 21 are attached on both sides of a guard 19 of the sword 3. The semicylinder-shaped components 21 are provided with reflecting sheets 23 on their curved surfaces. By attaching the reflecting sheets 23, reflecting surfaces are formed. The reflecting sheets 17 and 23 are, for example, retroreflective sheets.

As illustrated in FIG. 2, a strap 27 is fixed on a pommel 25 of the sword 3. The operator 94 put on the strap 27 around a wrist and holds a hilt 29 of the sword 3. As a result, even if the operator 94 releases the hilt 29 from a hand by accident, it is possible to avoid flying off to unexpected direction so that safety can be kept.

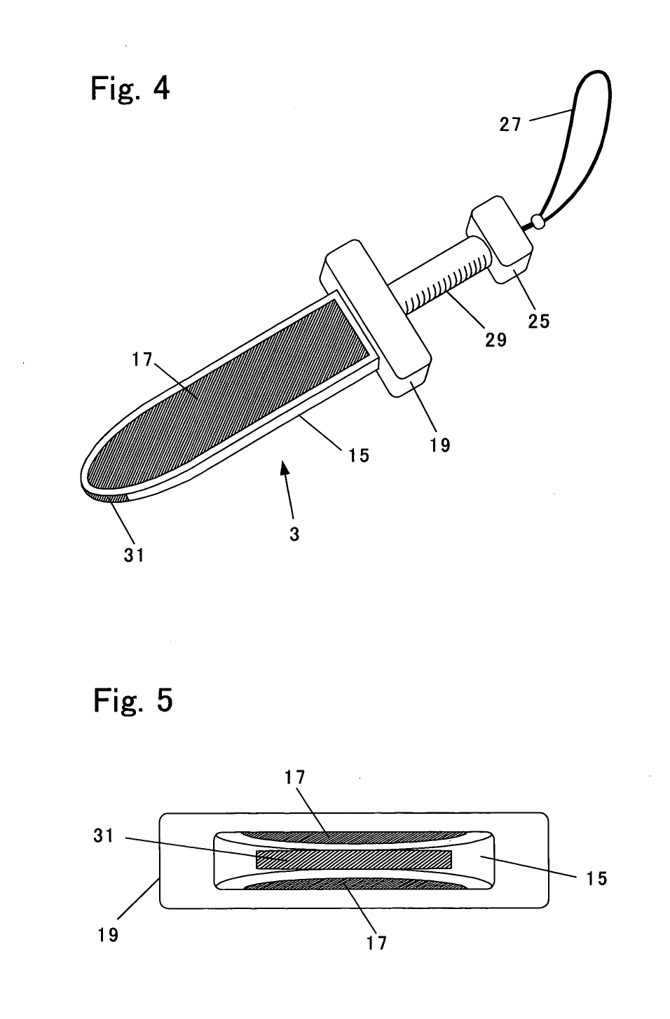

FIG. 4 is an enlarged view of another example of the sword 3 of FIG. 1. FIG. 5 is a top view of the sword 3 of FIG. 4. The sword 3 of FIG. 4 and FIG. 5 is not provided with the semicylinder-shaped components 21 of FIG. 2 and FIG. 3. Alternatively, the sword 3 of FIG. 4 and FIG. 5 is provided with a reflecting sheet 31 (e.g., a retroreflective sheet) on the tip portion. In this case of the sword 3 of FIG. 4 and FIG. 5, the reflecting sheet 31 serves to provide the same function as the reflecting sheets 23 of the sword 3 of FIG. 2 and FIG. 3. In the following description, an explanation will be made with using the sword 3 of FIG. 2 and FIG. 3.

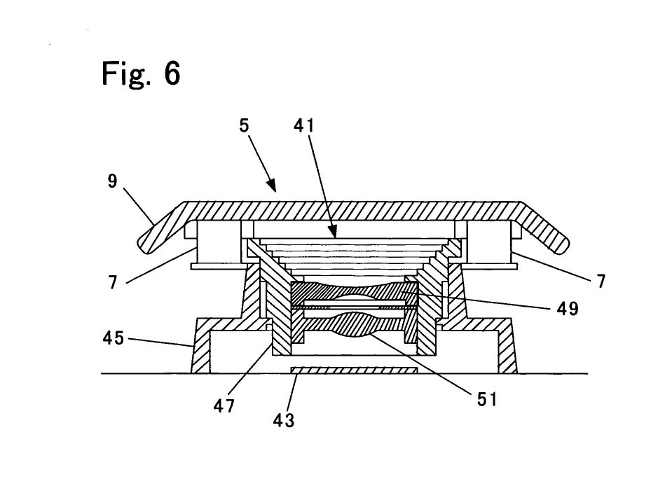

FIG. 6 is a view showing an example of the imaging unit 5 of FIG. 2. As illustrated in FIG. 6, this imaging unit 5 includes a unit base 45, which is, for example, made from plastic, and this unit base 45 is provided with a cylindrical shoring 47 in its inside. In addition, a trumpet shaped aperture 41 which is shaped like inverted cone is formed in the top of the cylindrical shoring 47. Inside the cylindrical part under the aperture 41, an optical system including a concave lens 49 and convex lens 51, which are, for example, made from lucent plastic, is formed. An image sensor 43 as an imaging device is firmly fixed under the convex lens 51. Therefore, the image sensor 43 can photograph an image corresponding to incident light through the concave lends 49 and the convex lends 51 from the aperture 41.

The image sensor 43 is a low-resolution CMOS image sensor (e.g., 32 pixels×32 pixels, gray scale). However, this image sensor 43 can be replaced by a higher resolution image sensor or other device such as CCD. In what follows, it is assumed that the image sensor 43 consists of 32 pixels×32 pixels.

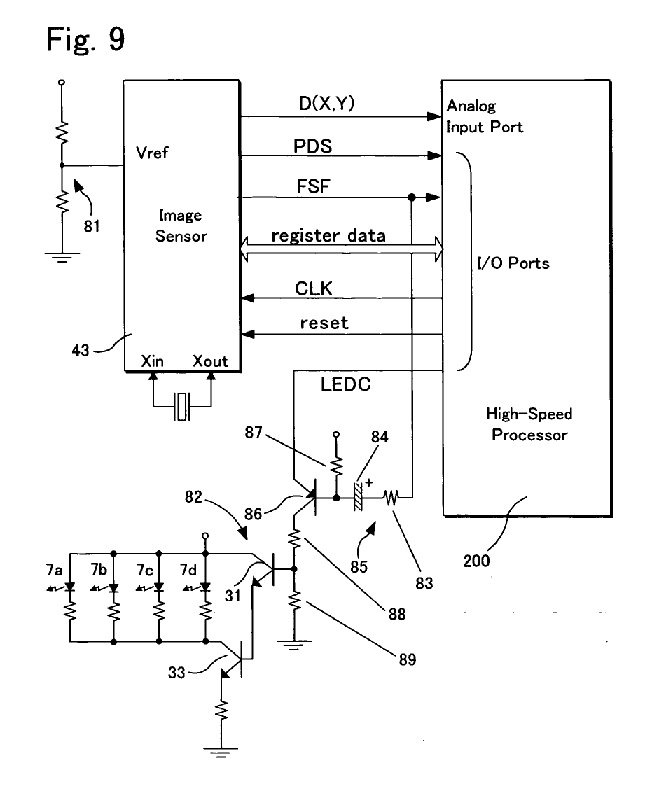

Furthermore, several (four in this embodiment) infrared-emitting diodes 7 which flash upwardly are attached to the unit base 45. The upside of the imaging unit 5 is lighted by infrared right from these infrared-emitting diodes 7. Meanwhile, an infrared filter (a filter which transmits only infrared right) 9 is arranged so as to cover the aperture 41. As explained later, the infrared-emitting diodes 7 repeat flash and un-flash alternately so that they can serve as a stroboscope. The term “stroboscope” is, by the way, a generic term, which indicates an apparatus that irradiates a moving subject intermittently. The above-mentioned image sensor 43 can, therefore, capture an image of a subject that moves within a photographing range of the imaging unit 5, or the sword 3 in this case of embodiment. Referring to after-mentioned FIG. 9, the stroboscope consists of the infrared-emitting diodes 7, a LED drive circuit 82 and a high-speed processor 200 mainly.

The imaging unit 5 is incorporated in the housing 11 in such a manner that its light receiving surface is inclined a prescribed angle (e.g., 90 degrees) from horizontal-plane. In addition, the photographing range of the image sensor 43 depends on the concave lens 49 and the convex lends 51, and in this case, it is a range of 60 degrees.

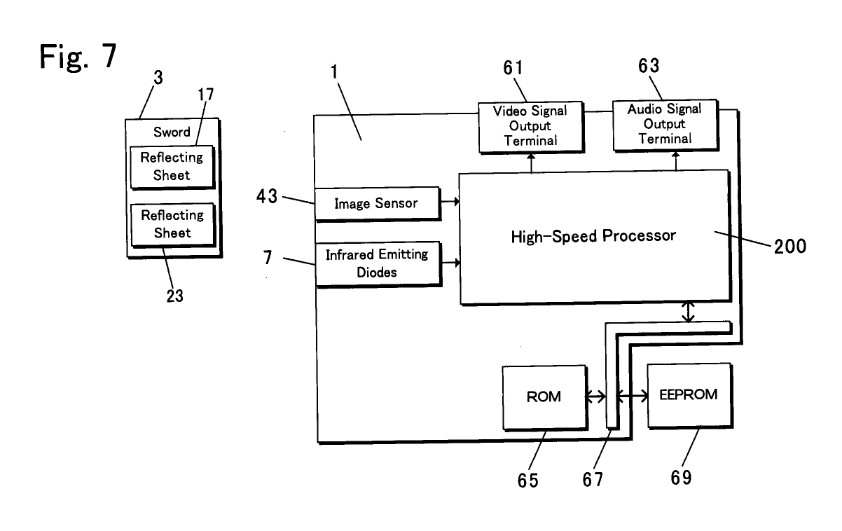

FIG. 7 is a view showing an electrical structure of the information processing apparatus 1 of FIG. 1. As shown in FIG. 7, the information processing apparatus 1 is provided with the image sensor 43, the infrared-emitting diodes 7, a video signal output terminal 61, an audio signal output terminal 63, the high-speed processor 200, a ROM (read only memory) 65 and a bus 67.

The high speed processor 200 is connected with the bus 67. Furthermore, the bus 67 is connected with the ROM 65. Therefore, the high speed processor 200 can access the ROM 65 via the bus 67 so that the high speed processor 200 can read and perform a control program stored in the ROM 65. In addition, the high speed processor 200 reads and processes image data and sound data stored in the ROM 65, then generates a video signal and an audio signal, and outputs them to the video output terminal 61 and the sound output terminal 63.

In addition, the information processing apparatus 1 has a connector (not shown) for inserting the memory cartridge 13 on the back part thereof. The high-speed processor 200 can, therefore, access an EEPROM 69 incorporated in the cartridge 13 inserted to the connector, via the bus 67. In this way, the high-speed processor 200 can read data stored in the EEPROM 69 via the bus 67, and use it for game processing.

By the way, the sword 3 is exposed to infrared light coming from the infrared-emitting diodes 7 and reflects the infrared light by the reflecting sheet 17 or 23. The return light from reflecting sheet 17 or 23 is detected by the image sensor 43, and thereby the image sensor 43 outputs an image signal of the reflecting sheet 17 or 23. The analog image signal from the image sensor 43 is converted into digital data by an A/D converter (to be explained below) incorporated in the high speed processor 200. Then the high speed processor 200 analyzes the digital data and reflects the analysis result to game processing.

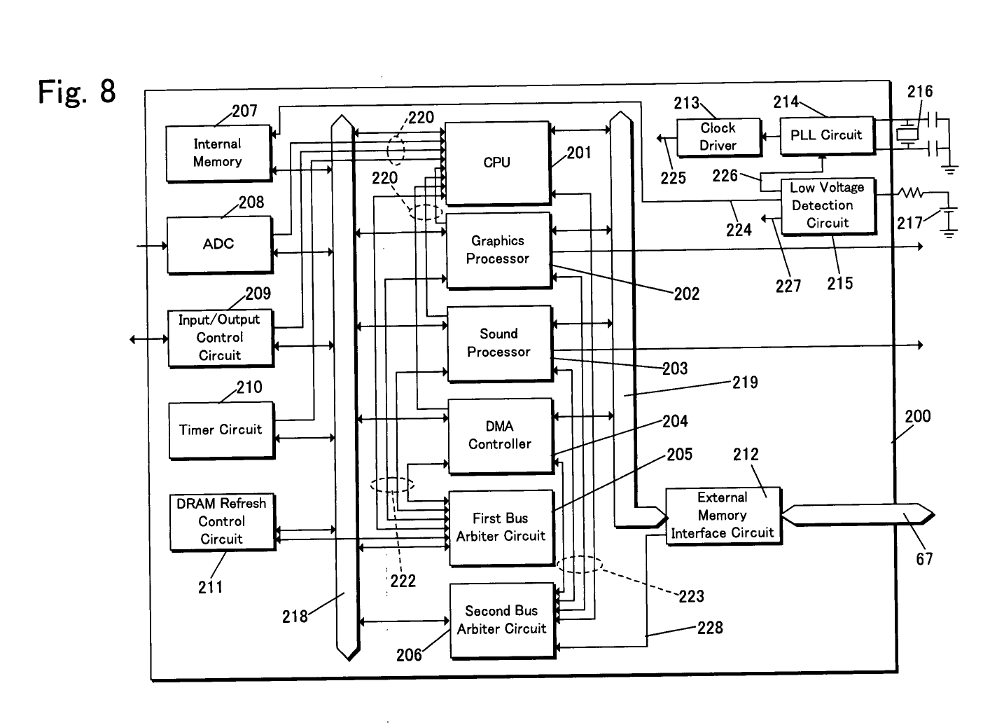

FIG. 8 is a block diagram showing the high speed processor 200 of FIG. 7. As shown in FIG. 8, this high speed processor 200 includes a central processing unit (CPU) 201, a graphics processor 202, a sound processor 203, a DMA (direct memory access) controller 204, a first bus arbiter circuit 205, a second bus arbiter circuit 206, an internal memory 207, an A/D converter (ADC: analog to digital converter) 208, an input/output control circuit 209, a timer circuit 210, a DRAM (dynamic random access memory) refresh cycle control circuit 211, an external memory interface circuit 212, a clock driver 213, a PLL (phase-locked loop) circuit 214, a low voltage detection circuit 215, a first bus 218, and a second bus 219.

The CPU 201 performs various operations and controls the overall system in accordance with a program stored in a memory (the internal memory 207, or the ROM 65). The CPU 201 is a bus master of the first bus 218 and the second bus 219, and can access the resources connected to the respective buses.

The graphics processor 202 is also a bus master of the first bus 218 and the second bus 219, generates a video signal on the basis of the data as stored in the internal memory 207 or the ROM 65, and outputs the video signal to the video signal output terminal 61. The graphics processor 202 is controlled by the CPU 201 through the first bus 218. Also, the graphics processor 202 has the functionality of issuing an interrupt request signal 220 to the CPU 201.

The sound processor 203 is also a bus master of the first bus 218 and the second bus 219, and generates an audio signal on the basis of the data as stored in the internal memory 207 or the ROM 65, and outputs the audio signal to the audio signal output terminal 63. The sound processor 203 is controlled by the CPU 201 through the first bus 218. Also, the sound processor 203 has the functionality of issuing an interrupt request signal 220 to the CPU 201.

The DMA controller 204 serves to transfer data from the ROM 65 and EEPROM 69 to the internal memory 207. Also, the DMA controller 204 has the functionality of issuing, to the CPU 201, an interrupt request signal 220 indicative of the completion of the data transfer. The DMA controller 204 is also a bus master of the first bus 218 and the second bus 219. The DMA controller 204 is controlled by the CPU 201 through the first bus 218.

The first bus arbiter circuit 205 receives a first bus use request signal from the respective bus masters of the first bus 218, performs bus arbitration, and issues a first bus use grant signal to one of the respective bus masters. Each bus master is granted to access the first bus 218 after receiving the first bus use grant signal. In FIG. 8, the first bus use request signals and the first bus use grant signals are illustrated as first bus arbitration signals 222.

The second bus arbiter circuit 206 receives a second bus use request signal from the respective bus masters of the second bus 219, performs bus arbitration, and issues a second bus use grant signal to one of the respective bus masters. Each bus master is granted to access the second bus 219 after receiving the second bus use grant signal. In FIG. 8, the second bus use request signals and the second bus use grant signals are illustrated as second bus arbitration signals 223.

The internal memory 207 may be implemented with one or any necessary combination of a mask ROM, an SRAM (static random access memory) and a DRAM. A battery 217 is necessary if the SRAM has to be powered by the battery for maintaining the data contained therein. In the case where the DRAM is used, the so called refresh cycle is periodically performed to maintain the data contained therein.

The ADC 208 converts analog input signals into digital signals. The digital signals are read by the CPU 201 through the first bus 218. Also, the ADC 208 has the functionality of issuing an interrupt request signal 220 to the CPU 201.

The ADC 208 converts analog pixel data from the image sensor 43 into digital data.

The input/output control circuit 209 serves to perform input and output operations of input/output signals to enable the communication with external input/output devices and/or external semiconductor devices. The input/output signals are read and written by the CPU 201 through the first bus 218. Also, the input/output control circuit 209 has the functionality of issuing an interrupt request signal 220 to the CPU 201.

A LED control signal “LEDC” which controls the infrared-emitting diodes 7 is output from this input/output control circuit 209.

The timer circuit 210 has the functionality of issuing an interrupt request signal 220 to the CPU 201 with a time interval as preset. The setting such as the time interval is performed by the CPU 201 through the first bus 218.

The DRAM refresh cycle control circuit 211 periodically and unconditionally gets the ownership of the first bus 218 to perform the refresh cycle of the DRAM at a certain interval. Needless to say, the DRAM refresh cycle control circuit 211 is provided in the case where the internal memory 207 includes a DRAM.

The PLL circuit 214 generates a high frequency clock signal multiplied a sine wave signal as obtained from a crystal oscillator 216.

The clock driver 213 amplifies the high frequency clock signal as received from the PLL circuit 214 to a sufficient signal level to supply the respective blocks as the clock signal 225.

The low voltage detection circuit 215 monitors the power supply voltage Vcc, and issues the reset signal 226 to the PLL circuit 214 and the reset signal 227 to the other elements of the entire system when the power supply voltage Vcc falls below a certain voltage. In addition, in the case where the internal memory 207 comprises an SRAM and needs to maintain data by the battery 217, the low voltage detection circuit 215 has the functionality of issuing a battery back-up control signal 224 when the power supply voltage Vcc falls below the certain voltage.

The external memory interface circuit 212 has the functionality of connecting the second bus 219 to the bus 67.

With reference to FIG. 9 to FIG. 11, a system of inputting pixel data from the image sensor 43 to the high-speed processor 200 will be explained in detail.

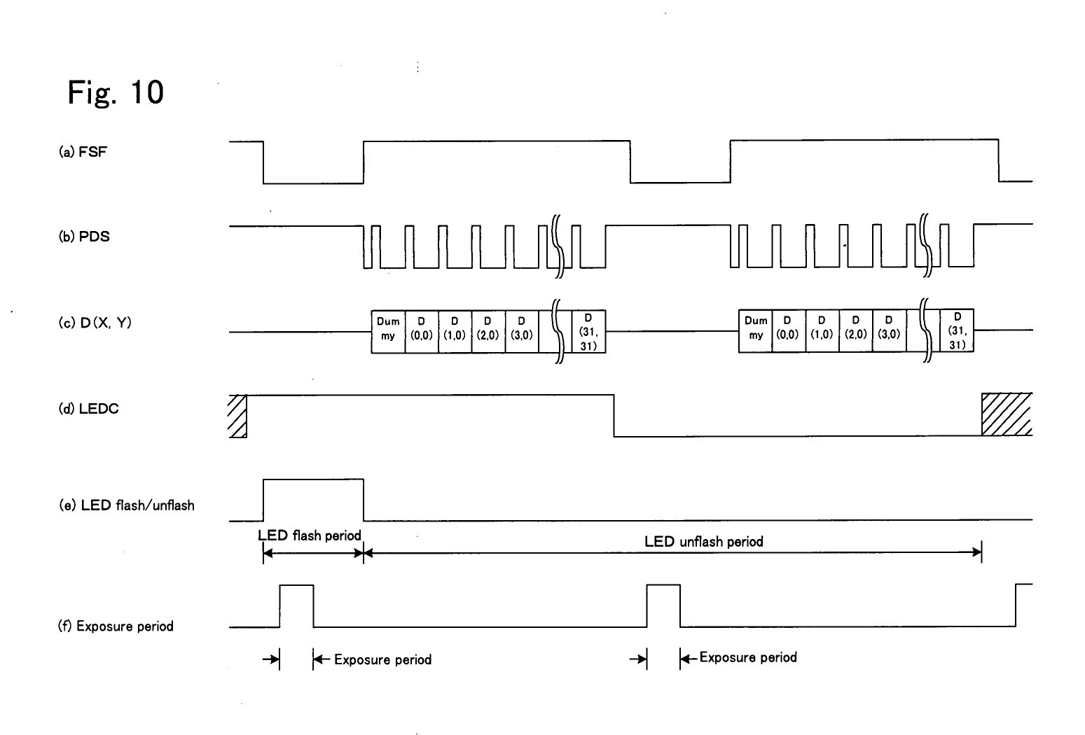

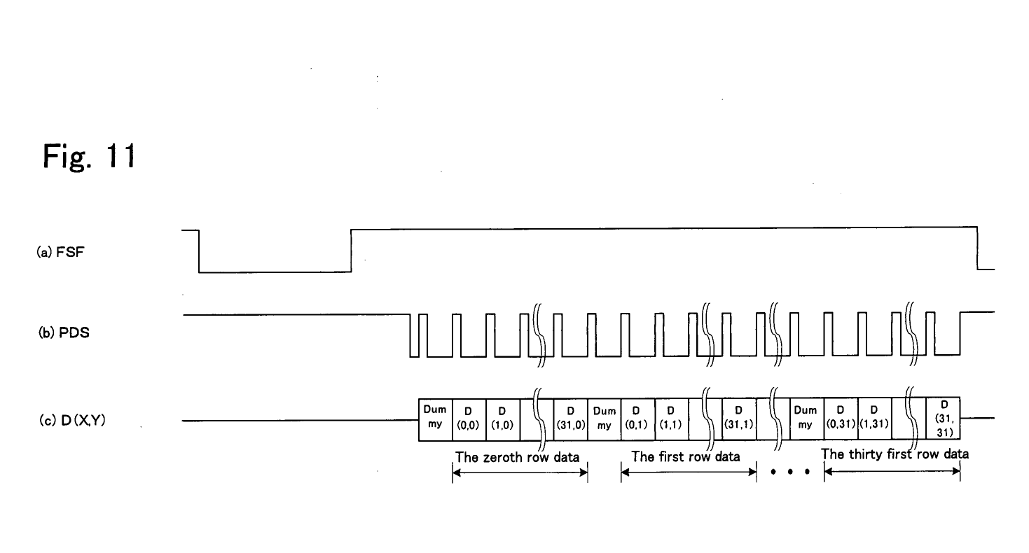

FIG. 9 is a circuit diagram showing the configuration for inputting pixel data from the image sensor 43 to the high speed processor 200 of FIG. 7, and a LED driver circuit. FIG. 10 is a timing chart illustrating the process for inputting pixel data from the image sensor 43 to the high speed processor 200. FIG. 11 is an enlarged timing diagram of a part of FIG. 10.

As illustrated in FIG. 9, pixel data D (X, Y) is input to an analog input port of the high speed processor 200 since the image sensor 43 outputs the pixel data D (X, Y) as an analog signal. The analog input port is connected with the ADC 208 in this high speed processor 200. Therefore, the high speed processor 200 obtains pixel data converted into digital data.

The middle point of above-mentioned analog pixel data D (X, Y) is determined on the basis of a reference voltage applied to a reference voltage terminal “Vref” of the image sensor 43. Therefore, a reference voltage generating circuit 81 comprising a voltage dividing circuit is provided, and this circuit 81 applies the constant reference voltage to the reference voltage terminal “Verf”.

Each digital signal to control the image sensor 43 is input to I/O ports of the high speed processor 200, and output from I/O ports. Each I/O port is a digital port operable to control input and output operation, and connected with the input/output control circuit 209 of the high speed processor 200.

More specifically, a reset signal “reset” to reset the image sensor 43 is output from the output port of the high speed processor 200, and transmitted to the image sensor 43. A pixel data strobe signal “PDS” and a frame status flag signal “FSF” are output from the image sensor 43 to the input ports of the high speed processor 200.

As illustrated in FIG. 10(b), the pixel data strobe signal “PDS” is a strobe signal to read above-mentioned each pixel data D (X, Y). The frame status flag signal “FSF” is a flag signal indicative of a state of the image sensor 43, and as illustrated in FIG. 10(a), it defines an exposure period of the image sensor 43. In other words, a low-level period of the frame status flag signal “FSF” as illustrated in FIG. 10(a) shows an exposure period, and a high-level period as illustrated in FIG. 10(a) shows an unexposure period.

In addition, the high speed processor 200 outputs a command (or a command and data) as register data to be set to a control register (not shown) of the image sensor 43 via the I/O ports. Furthermore, the high speed processor 200 outputs a register setting clock “CLK” which repeats a low-level period and a high-level period alternately. The register data and the register setting clock “CLK” are sent to the image sensor 43.

As illustrated in FIG. 9, the four infrared-emitting diodes 7a, 7b, 7c and 7d which are connected in parallel are used. As explained above, these infrared-emitting diodes 7a to 7d are arranged so as to encompass the image sensor 43, and emit infrared light to the same direction as a viewpoint direction of the image sensor 43 to irradiate the sword 3 with the infrared light. By the way, these diodes 7a, 7b, 7c and 7d are collectively referred as “infrared-emitting diodes 7” except the case where they need to be referred individually.

These infrared-emitting diodes 7 are turned on or turned off by the LED driver circuit 82. The LED driver circuit 82 receives the above-mentioned frame status flag signal “FSF” from the image sensor 43, and then, the flag signal “FSF” is applied to a base terminal of a PNP transistor 86 via a differentiation circuit 85 consisting of a resistor 83 and a capacitor 84. In addition, the base terminal of the PNP transistor 86 is connected with a pull-up resistor 87, and is normally pulled up to a high level. When the frame status flag signal “FSF” becomes low level, the low-level signal is input to the base terminal via the differentiation circuit 85. Therefore, the PNP transistor 86 is turned on only when the level of the flag signal “FSF” is low.

An emitter terminal of the PNP transistor 86 is grounded via resistors 88 and 89. The connecting point of the emitter resistors 88 and 89 is connected with a base terminal of an NPN transistor 31. A collector terminal of this NPN transistor 31 is connected to anodes of the infrared-emitting diodes 7 in common. An emitter terminal of the NPN transistor 31 is connected to a base terminal of an NPN transistor 33 directly. A collector terminal of the NPN transistor 33 is connected to cathodes of the infrared-emitting diodes 7a to 7d in common. An emitter terminal of the NPN transistor 33 is grounded.

This LED driver circuit 82 turns the infrared-emitting diodes 7 on only when the LED control signal “LEDC” which is output from the I/O port of the high speed processor 200 is active (high-level) and also the level of the frame status flag signal “FSF” from the image sensor 43 is low.

As illustrated in FIG. 10(a), when the frame status flag signal “FSF” becomes a low level, the PNP transistor 86 is turned on while the level of the frame status flag signal “FSF” is low (there is actually a time-lag caused by a time constant of the differentiation circuit 85). Therefore, when the LED control signal “LEDC” illustrated in FIG. 10(d) is set to high level by the high speed processor 200, the base terminal of the NPN transistor 31 becomes high level. As a result, this transistor 31 is turned on. Then, when the transistor 31 is turned on, the transistor 33 is also turned on. Therefore, a current passes through each infrared-emitting diode 7a to 7d and the transistor 33 from a power supply (described as a small circle in FIG. 9), and consequently the infrared-emitting diodes 7a to 7d flash as described in FIG. 10(e).

The LED driver circuit 82 turns the infrared-emitting diodes 7 on only while the LED control signal “LEDC” illustrated in FIG. 10(d) is active and also the level of the frame status flag signal “FSF” illustrated in FIG. 10(a) is low. This means that the infrared-emitting diodes 7 flash only during the exposure period of the image sensor 43 (refer to FIG. 10(f)).

Therefore, it is possible to restrain unnecessary power consumption. Besides, since the frame status flag signal “FSF” is coupled by the capacitor 84, even if the flag signal “FSF” retains its low-level because of overrun of the image sensor 43, the transistor 86 is turned off after a predetermined period and also the infrared-emitting diodes 7 are turned off after the prescribed period.

As has been discussed above, it is possible to set and change the exposure period of the image sensor 43 arbitrarily and freely by controlling duration of the flame status signal “FSF”.

In addition, it is possible to set and change arbitrarily and freely the flash period, the unflash period and a light/non-light emitting cycle of the infrared-emitting diodes 7 i.e., the stroboscope by controlling duration and cycles of the frame status flag signal “FSF” and the LED control signal “LEDC”.

As already explained, when the sword 3 is irradiated by the infrared light from the infrared-emitting diodes 7, the image sensor 43 is exposed to the return light from the sword 3. Accordingly, in response to it, the above-mentioned pixel data D (X, Y) is output from the image sensor 43. More specifically, as illustrated FIG. 10(c), when the level of the frame status flag signal “FSF” of FIG. 10(a) is high (the unflash period of the infrared-emitting diodes 7), the image sensor 43 outputs the analog pixel data D (X, Y) in synchronization with the pixel data strobe “PDS” FIG. 10(b).

The high speed processor 200 obtains the digital pixel data via the ADC 208 while monitoring the frame status flag signal “FSF” and the pixel data strobe “PDS”.

As illustrated in FIG. 11(c), the pixel data D (X, Y) is output sequentially in order of row, for example, the zeroth row, the first row, . . . and the thirty first row. As explained later, the first one pixel of each row is dummy data. The horizontal direction (lateral direction, row direction) of the image sensor 43 is defined as X-axis, and the vertical direction (longitudinal direction, column direction) of the image sensor 43 is defined as Y-axis, and the upper left corner is defined as an origin.

Next, game process performed by the information processing apparatus 1 will be explained with specific examples.

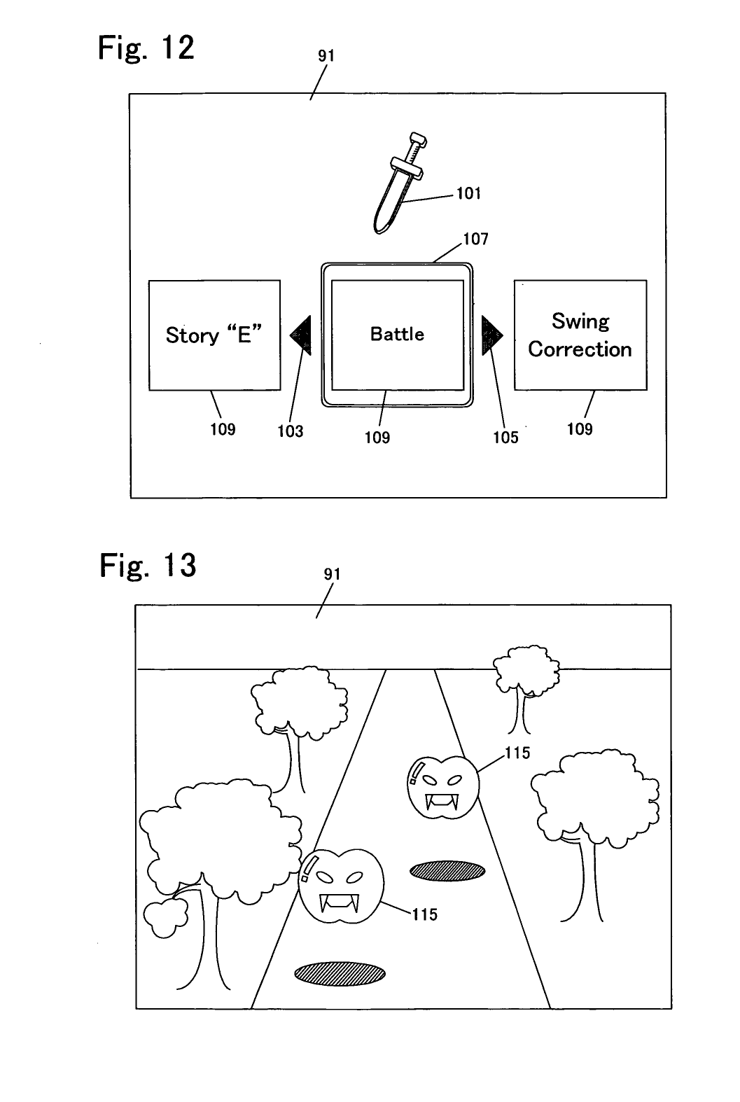

FIG. 12 is a view showing an example of a mode selection screen which is displayed on the screen 91 of the television monitor 90 of FIG. 1. When the operator 94 turns on the power switch (not shown) provided on the back side of the information processing apparatus 1, for example, the selection screen as illustrated in FIG. 12 is displayed. In this embodiment, “story mode A” to “story mode E” (the term “story mode” is generally used to represent “story mode A” to “story mode E”), “battle mode”, and “swing correction mode” are provided as examples of selective contents.

On the selection screen, a sword-shaped cursor 101, a leftward rotation instructing object 103, a rightward rotation instructing object 105, a selection frame 107, and content objects 109 are displayed. When the operator 94 moves the sword 3, the cursor 101 moves on the screen 91 in response to the sword 3. When the cursor 101 overlaps with the leftward rotation instructing object 103, the content objects 109 moves leftwards. In the same way, when the cursor 101 overlaps with the rightward rotation instruction object 105, the content objects 109 moves rightwards.

In this way, the operator 94 stops a desired content object 109 within the selection frame 107 by operating the cursor 101 by the sword 3. A selection is fixed when the operator 94 swings down the sword 3 faster than a predetermined velocity. Then, the information processing apparatus 1 performs a process corresponding to the content object 109 of which a selection is fixed. In what follows, a process of the each content which the operator 94 can select will be explained with reference to figures.

FIG. 13 to FIGS. 18(a) and 18(b) are views showing examples of game screens when the content object 109 indicative of the story mode is selected on the selection screen of FIG. 12. In the story mode, the game screen as illustrated FIG. 13 is displayed on the screen 91, and a game process for a game played by one player is performed. In addition, enemy objects 115 are displayed on the game screen on the basis of the game story.

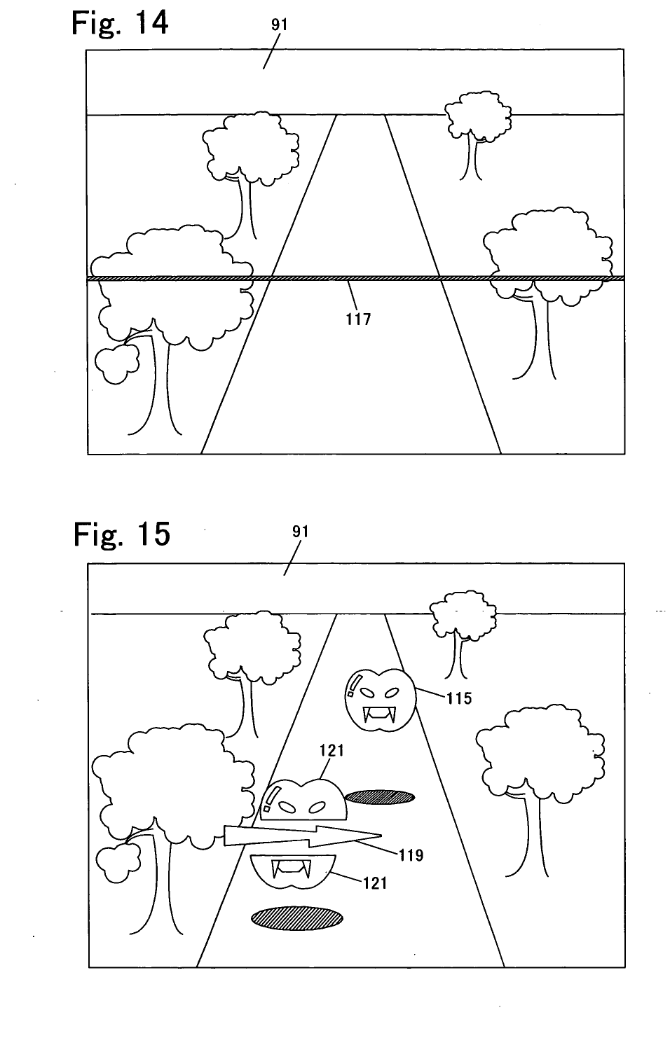

In addition, when the operator 94 swings the sword 3 laterally (horizontally), it triggers an appearance of a lateral sword locus object 117 on the game screen as illustrated in FIG. 14. The sword locus object 117 is an object representing a movement locus (slash mark) of the sword 3 in actual-space. Therefore, while illustration is omitted, if the operator 94 swings the sword 3 obliquely, an oblique sword locus object 117 appears, and if the operator 94 swings the sword 3 longitudinally (vertically), a longitudinal sword locus object 117 appears.

The operator 94 has to swing the sword 3 faster than a predetermined velocity with exposing the edge of the blade 15 to the imaging unit 5 to make the sword locus object 117 appear. In other words, when the operator 94 swings the sword 3 in this manner, images of the reflecting sheets 23 on the semicylinder-shaped elements 21 attached on the sword 3 are captured by the imaging unit 5, and then a trigger for the sword locus object 117 is generated in accordance with the result of processing.

As illustrated in FIG. 15, an enemy object 121 with an effect 119 appears if a part of the sword locus object 117 appeared in response to the swing of the operator 94 exists within a predetermined area including the enemy object 115. In this way, the operator 94 can recognize that the sword locus object 117 hits the enemy object 115. If the number of times which the enemy objects are hit 115 consecutively exceeds a prescribed value, strength information will be updated, and the strength will be increased. The strength information, for example, includes life information showing vitality, point information showing the number of usable special attacks, and so on. For example, the strength information is stored in a memory cartridge 13 for performing the battle mode.

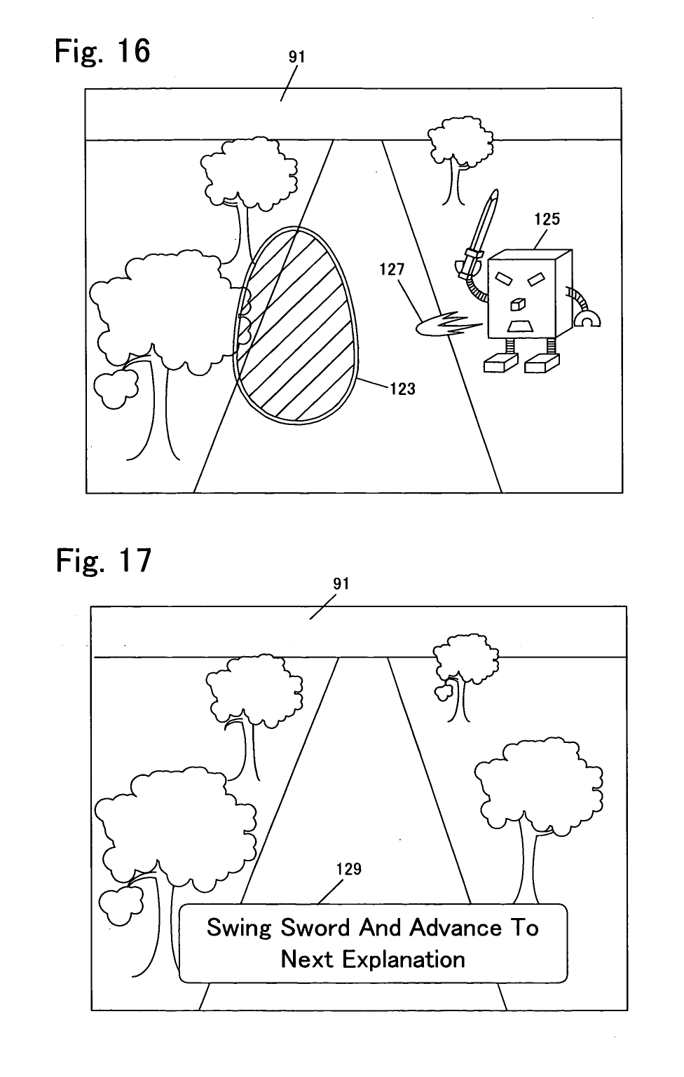

On the other hand, as illustrated in FIG. 16, a shield object 123 appears when the operator 94 directs a face of the blade 15 of the sword 3 to the imaging unit 5. In other words, when the face of the blade 15 of sword 3 is directed to the imaging unit 5, an image of the reflecting sheet 17 attached on the face of the blade 15 is captured by the imaging unit 5, and then a trigger of the shield object 123 is generated in accordance with the result of processing.

When the sword 3 is moved while the face of the blade 15 is directed to the imaging unit 5, this shield object 123 moves on the screen so as to follow motion of the sword 3. Therefore, the operator 94 can defend against the attack (in the example of FIG. 16, a flame object 127) from the enemy object 125 by manipulating the shield object 123 by the sword 3. In other words, the operator 94 manipulates the shield object 123 by moving the sword 3, and if the shield object 123 overlaps the flame object 127 timely, the flame object 127 disappears so that the operator 94 can defend against the attack from the enemy object 125.

An explanation object 129 illustrated in FIG. 17 may appear in the story mode. In this case, the operator 94 operates the sword 3 in accordance with instruction of the explanation object 129 to go on the game. In FIG. 17, when the operator 94 swings the sword 3, the explanation object 129 displaying at present disappears, and then, a next explanation object appears on the screen 91. In other words, when the operator 94 swings the sword 3 with exposing the edge of the blade 15 to the imaging unit 5, images of the reflecting sheets 23 on the semicylinder shaped elements 21 attached on the sword 3 are captured by the imaging unit 5, and then a trigger for the next explanation object is generated on the basis of the result of processing.

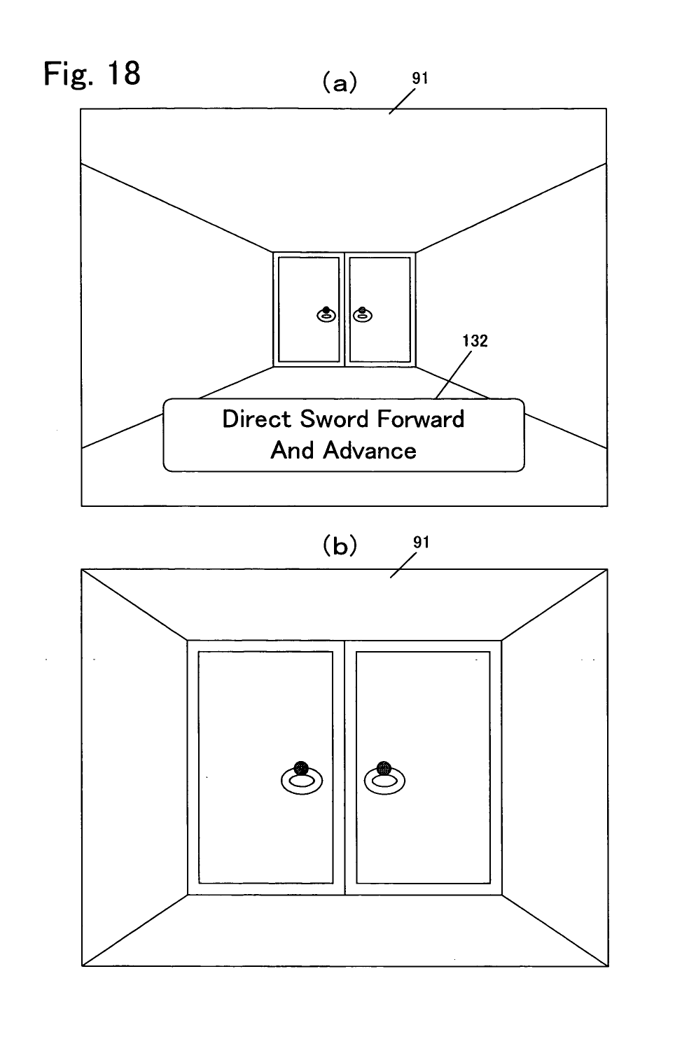

In addition, the explanation object 132 as illustrated in FIG. 18(a) sometimes appears in the story mode. In this case, when the operator 94 directs the tip of the sword 3 to the imaging unit 5, a screen as if the operator 94 were moving forward in actual-space as illustrated in FIG. 18(b) will be displayed. In other words, when the operator 94 directs the tip of the sword 3 to the imaging unit 5, images of the reflecting sheets 23 attached on the semicylinder shaped elements 21 of the stationary sword 3 are captured by the imaging unit 5. Then, a trigger for advancing a screen (a background screen) to the next is generated on the basis of the result of processing.

Next, the battle mode will be explained. In the battle mode, the information processing apparatus 1 reads strength information stored in the two operator 94's memory cartridges 13, and then performs a battle game process based on the strength information. The strength information stored in the respective—memory cartridges 13 is the strength information which the two operators 94 obtained respectively in the story mode. The information processing apparatus 1 reads the strength information for the two operators 94 to display a game screen described below.

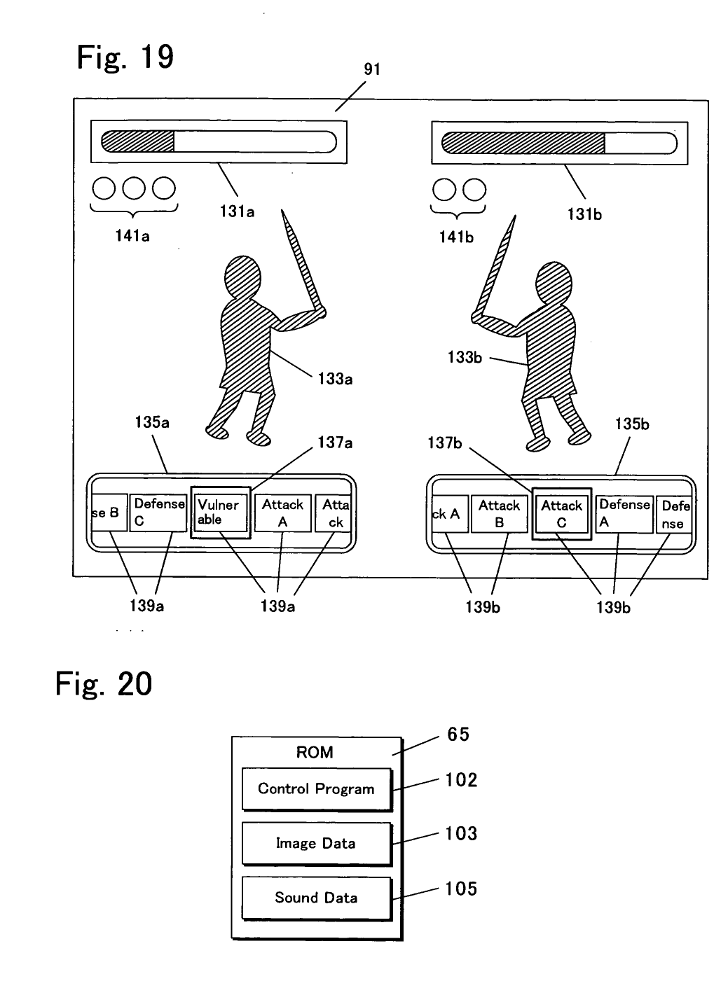

FIG. 19 is a view showing an example of a game screen when the content object 109 indicating the battle mode is selected in the selection screen of FIG. 12. As illustrated in FIG. 19, life information 131a and 131b representing vitality, point information 141a and 141b expressing the number of usable special attacks, fighting objects 133a and 133b, and command selecting sections 135a and 135b are displayed on the game screen of the battle mode. In the command selecting sections 135a and 135b, selecting frames 137a and 137b, and command objects 139a and 139b are displayed.

The life information 131a and 131b is respectively the life information which comes from the each operator 94's memory cartridge 13. In FIG. 19, bar graphs represent remaining vitality. The point information 141a and 141b is respectively the point information which comes from the each operator 94's memory cartridges 13.

The command objects 139a and 139b in the command selecting sections 135a and 135b start rotating leftward when either of two operators 94 swings the sword 3. One of the operators 94 swings the own sword 3 to stop one of the command objects 139a rotating in the command selecting section 135a. In the same way, the other operator 94 swings the own sword 3 to stop one of the command objects 139b rotating in the command selecting section 135b.

After that, a battle process is performed in accordance with the command objects 139a and 139b which stop within the selecting frame 137a and 137b. In FIG. 19, the fighting object 133a becomes vulnerable, and encounters “attack C” from the fighting object 133b. As a result, the life information 131a of the fighting object 133a decreases. In this way, the battle is proceeded according to the command objects 139a and 139b which are stopped by respective operators 94.

The strength of the attack commands 139a and 139b is in order of A, B and C. The strength of the defense commands 139a and 139b is also in order of A, B and C.

If there is a difference of strength between the selected attack commands, the one who selects the weaker attack command is damaged, and the life information is decreased according to the difference of the strength. If the selected attack commands have the same strength, the battle becomes close-pitched. In this case, the fighting object whose operator swings the sword 3 more often than the other does during a predetermined period is able to damage the other fighting object, and the life information is decreased.

If a strong attack command and a weak defense command are selected, the one which selects the weak defense command is damaged and therefore, the life information is decreased according to the difference of the strength. In the case where a weak attack command and a strong defense command are selected, the defense side is not damaged. If same power levels of an attack command and a defense command are selected, the both are not damaged.

Point information 141a and 141b decrease by using a special attack. The special attack is performed when the command object 139a or 139b of the special attack is selected.

Next, game process performed by the information processing apparatus 1 will be explained in detail.

FIG. 20 is a conceptual illustration of program and data stored in the ROM 65 of FIG. 7. As illustrated in FIG. 20, a control program 102, image data 103 and sound data 105 are stored in the ROM 65. The program and data are hereinafter explained.

The CPU 201 of FIG. 8 obtains digital pixel data converted from analog pixel data output from the image sensor 43, and then assigns the data to an array element P[X] [Y]. As mentioned above, a horizontal direction (lateral direction, row direction) of the image sensor 43 is defined as X-axis and a vertical direction (longitudinal direction, column direction) of the image sensor 43 is defined as Y-axis.

The CPU 201 calculates a difference between the pixel data P [X] [Y] with light emitted from the infrared-emitting diodes 7 and the pixel data P [X] [Y] without light, and then assigns the differential data to an array element Dif [X] [Y]. Benefits of calculating the difference will be explained with reference to figures. Incidentally, the pixel data represents luminance. Therefore, the differential data also express luminance.

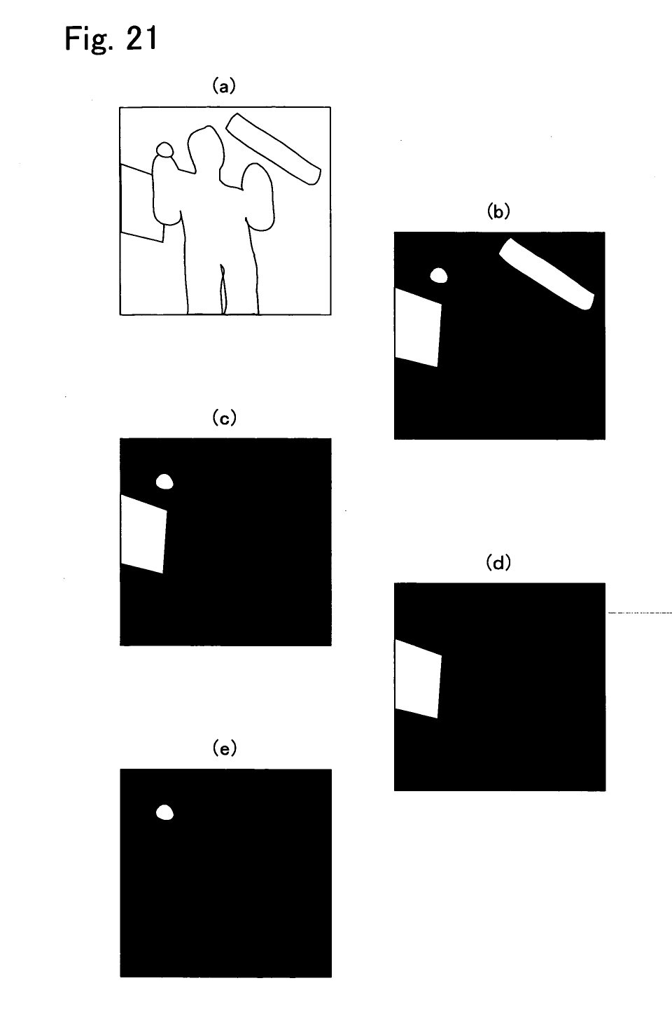

FIG. 21(a) is a view showing an example of an image which is photographed by a general image sensor and is not applied special processes. FIG. 21(b) is a view showing the image signal which is the result of level-discriminating the image signal of FIG. 21(a) on the basis of a predetermined threshold value. FIG. 21(c) is a view showing an example of an image signal which is the result of level-discriminating an image signal which is photographed by image sensor 43 through the infrared filter 9 during a light emitting period on the basis of a predetermined threshold value. FIG. 21(d) is a view showing an example of an image signal which is the result of level-discriminating an image signal which is photographed by the image sensor 43 through the infrared filter 9 during a non-light emitting period on the basis of the predetermined threshold value. FIG. 21(e) is a view showing the differential signal between the lighted image signal and the non-lighted image signal.

As mentioned above, the sword 3 is irradiated with infrared light and the image sensor 43 photographs an image corresponding to the reflected infrared light through the infrared filter 9. When the sword 3 is photographed by using a stroboscope under a general light source in a general condition room, a general image sensor (is equivalent to the image sensor 43 of FIG. 6) captures not only the image of the sword 3 but also images of all other things in the room and images of light sources such as a fluorescent lamp source, an incandescent lamp source, and sunlight (a window). It is, therefore, necessary to use a speedier computer or a speedier processor to process the image of FIG. 21(a) and extract only the image of the sword 3. However, it is impossible to use such a high-performance computer for an apparatus which has to be as cheap as possible. Therefore, it is necessary to execute various kinds of processing, and reduce burden.

By the way, the image of FIG. 21(a) is supposed to be described in gray scale, but it is omitted to do so. Besides, since FIG. 21(a) to FIG. 21(e) show images when the edge of the blade 15 of the sword 3 faces the image sensor, the reflecting sheets 23, not the reflecting sheet 17, are captured. Since the two reflecting sheets 23 are close to each other, they are captured as one image.

FIG. 21(b) is the view showing the example of the image signal which is the result of level-discriminating the image signal of FIG. 21(a) on the basis of the predetermined threshold value. This kind of level-discrimination process can be executed by dedicated hardware circuit or software. Both ways allow eliminating lower luminance images except the images of the sword 3 and light sources by eliminating pixel data which is lower than predetermined amount of light by level-discrimination. In the image of FIG. 21(b), the process of images except images of the sword 3 and the light sources can be omitted. Therefore, it is possible to reduce the computer's burden. However, high luminance images including images of the light sources remain. It is, therefore, difficult to discriminate the sword 3 from the other light sources.

The usage of the infrared filter 9 showed in FIG. 6 enables not to capture images other than images based on infrared light. Therefore, as illustrated in FIG. 21(c), it is possible to eliminate an image of a fluorescent light source which has little infrared light. But, sunlight and an incandescent light are included in an image signal nonetheless. Because of this, a difference between pixel data with and without light emitted from the infrared stroboscope is calculated to further reduce burden.

Accordingly, a difference between pixel data of an image signal with light emitted as illustrated in FIG. 21(c) and pixel data of an image signal without light emitted as illustrated in FIG. 21(d) is calculated. And, as illustrated in FIG. 21(e), an image consisting of only the difference is acquired. Comparing to the image of FIG. 21(a), it is obvious that the image based on the difference data includes only the image of the sword 3. Therefore, it is possible to acquire state information of the sword 3 while processing is reduced. The state information is, for example, any one of or any combination of two or more of speed information, movement direction information, movement distance information, velocity vector information, acceleration information, movement locus information, area information and positional information.

Due to these reasons, the CPU 201 calculates the difference between the pixel data with and without light emitted from the infrared diodes 7 to obtain the differential data.

The CPU 201 detects a reflecting surface (the reflecting sheet 17 or 23) of the sword 3 on the basis of the differential data Dif[X][Y]. More detailed explanation is as follow.

As mentioned above, the image sensor 43, for example, consists of 32 pixels×32 pixels. The CPU 201 counts the number of pixels having the larger differential data than a predetermined threshold value “Th” by scanning the differential data for 32 pixels in the direction of X-axis while incrementing the Y-coordinate in such a manner that the differential data for 32 pixels is scanned in the direction of X-axis, then the Y-coordinate is incremented, then the differential data for 32 pixels is scanned in the direction of X-axis, and then the Y-coordinate is incremented. It is determined that either of the reflecting sheet 17 or 23 is detected if a pixel having the larger differential data than the predetermined threshold value “Th” exists.

And the CPU 201 finds the maximum value from among the differential data which is larger than the predetermined threshold Th. The pixel having the maximum differential data is determined as a target point of the sword 3. Therefore, the X-coordinate and the Y-coordinate of the target point are equivalent to the X-coordinate and the Y-coordinate of the pixel having the maximum differential data. In addition, the CPU 201 converts an X-coordinate and a Y-coordinate on the image sensor 43 (on an image based on the image sensor 43) into an x-coordinate and a y-coordinate on the screen 91 (on a display screen), and then assigns the x-coordinate and y-coordinate into allay elements “Px[M]” and “Py[M]” respectively. The image consisting of 256 pixels (width)×224 pixels (height) generated by the graphics processor 202 is displayed on the screen 91. Therefore, a position (x, y) on the screen 91 is indicate by the position of a pixel as the origin (0, 0) the center of the screen 91. Incidentally, “M” is an integer number indicating an image was captured in the M-th time. In this way, the CPU 201 extracts the target point of the sword 3.

The CPU 201 determines whether or not the sword 3 is swung on the basis of the coordinates of the previous target point and the current target point as extracted. More specific description is provided as follows.

The CPU 201 calculates the velocity vector (Vx[M], Vy[M]) of the target point (M) of the sword 3 using the following formulas with the coordinates (Px[M], Py[M]) of the current target point (M) and the coordinates (Px[M−1], Py[M−1]) of the previous target point (M−1).
Vx[M]=Px[M]−Px[M−1] (1)
Vy[M]=Py[M]−Py[M−1] (2)

Then, the CPU 201 calculates the speed “V [M]” of the target point (M) of the sword 3 using the following formula.
V[M]=\sqrt{(Vx[M]²+Vy[M]²)} (3)

The CPU 201 compares the speed “V[M]” of the target point (M) to the predetermined threshold value “ThV”. If the speed “V[M]” is larger, the CPU 201 determines that the sword 3 has been swung, and then turns the swing flag on.

The CPU 201 detects a direction of a swing of the sword 3. More specific description is as follows.

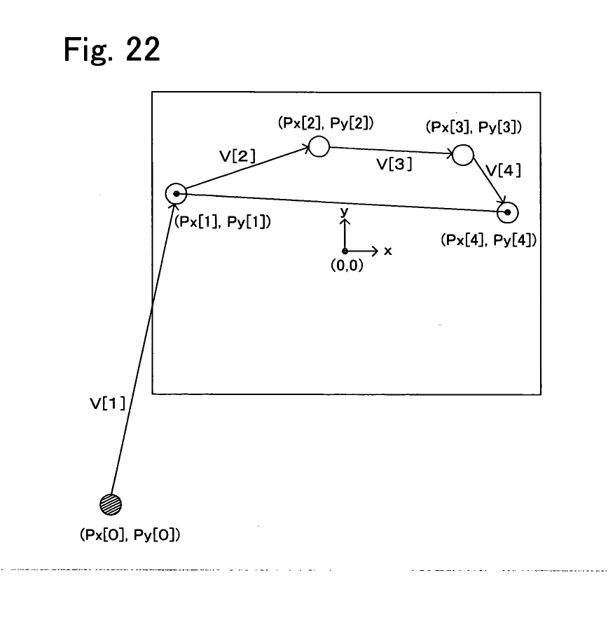

FIG. 22 is an explanation diagram showing a process that the CPU 201 of FIG. 8 detects the direction of the swing of the sword 3. As illustrated in FIG. 22, the center of the screen 91 is defined as the origin, and there is assumed to be a fictive plane consisting of 256 pixels×256 pixels. Coordinates on the fictive plane are equivalent to coordinates on the screen 91. A fictive target point (0) is set outside this fictive plane, and the coordinates of this target point are defined as (Px[0], Py[0]).

It is assumed that the speed “V [1]” of the target point (1) exceeds a predetermined threshold value “ThV”. Furthermore, it is assumed that the speed “V[2]” of the target point (2) and the speed “V[3]” of the target point (3) are also exceed the predetermined threshold value “ThV” and the speed “V[4]” of the target point (4) is less than or equal to the predetermined threshold value “ThV”.

The CPU 201 detects the direction of the swing of the sword 3 on the basis of the coordinates (Px[1], Py[1]) of the target point (1) which exceeds the predetermined threshold value “ThV” for the first time and the coordinates (Px[4], Py[4]) of the target point (4) which is less than or equal to the predetermined threshold value “ThV” for the first time. More detailed explanation will be provided hereinafter. Incidentally, the x-coordinate and y-coordinate of the target point (S) whose speed exceeds the predetermined threshold value “ThV” for the first time are defined as the coordinates Px[S] and Py[S] respectively, and the x-coordinate and y-coordinate of the target point (E) whose speed is less than or equal to the predetermined threshold value “ThV” for the first time are defined as the coordinates Px[E] and Py[E] respectively.

The CPU 201 calculates a distance between these two points using the following formulas.
Lx=Px[E]−Px[S] (4)
Ly=Py[E]−Py[S] (5)

Then, the distance “Lx” and “Ly” are divided by “n” which is the number of the target points exceeding the predetermined threshold value “ThV”. In FIG. 22, n=3.
LxA=Lx/n (6)
LyA=Ly/n (7)

Incidentally, if all target points exceed the predetermined threshold value “ThV” and don't become less than or equal to the predetermined threshold value “ThV” from the target point (S) which exceeds the predetermined threshold value “ThV” for the first time to the target point within the photographing range of the image sensor 43 (in FIG. 22, the target point (4)), the target point extracted just before getting out of the photographing range of the image sensor 43 (in FIG. 22, the target point (4)) is defined as a target point (E). The CPU 201 calculates the formulas (4) to (7) on the basis of this target point (E) and the target point (S) exceeding the predetermined threshold value “ThV” for the first time. In this case, n=n−1.

Next, the CPU 201 discriminates the magnitude correlation between the absolute value of the average value “LxA” of the x direction swing length and a predetermined value “xr”. In addition, the CPU 201 discriminates the magnitude correlation between the absolute value of the average value “LyA” of the y direction swing length and a predetermined value “yr”. On the basis of the results, if the absolute value of the average value “LxA” is larger than the predetermined value “xr” and the absolute value of the average value “LyA” is smaller than the predetermined value “yr”, the CPU 201 determines that the sword 3 has been swung in the lateral direction (horizontal direction), and then sets an angle flag to a corresponding value.

On the other hand, according to the results, if the absolute value of the average value “LxA” is smaller than the predetermined value “xr” and the absolute value of the average value “LyA” is larger than the predetermined value “yr”, the CPU 201 determines that the sword 3 has been swung in the longitudinal direction (vertical direction), and then sets an angle flag to a corresponding value. Furthermore, on the basis of the results, if the absolute value of the average value “LxA” is larger than the predetermined value “xr” and the absolute value of the average value “LyA” is also larger than the predetermined value “yr”, the CPU 201 determines that the sword 3 has been swung in the diagonal direction, and then sets an angle flag to a corresponding value.

Additionally, the CPU 201 judges a sign of the average value “LxA”, and sets an x-direction flag to a corresponding value. Furthermore, the CPU 201 judges a sign of the average value “LyA”, and sets a y-direction flag to a corresponding value. The term “direction flag” is used to generally represent an x-direction flag and a y-direction flag.

The CPU 201 determines the swing information of the sword 3 based on the values set to the angle flag, the x-direction flag and the y-direction flag. The swing information of the sword 3 represents the swing direction of the sword 3. According to this swing information, one of the kinds of the sword locus object 117 is determined. This will be discussed in detail as follow.

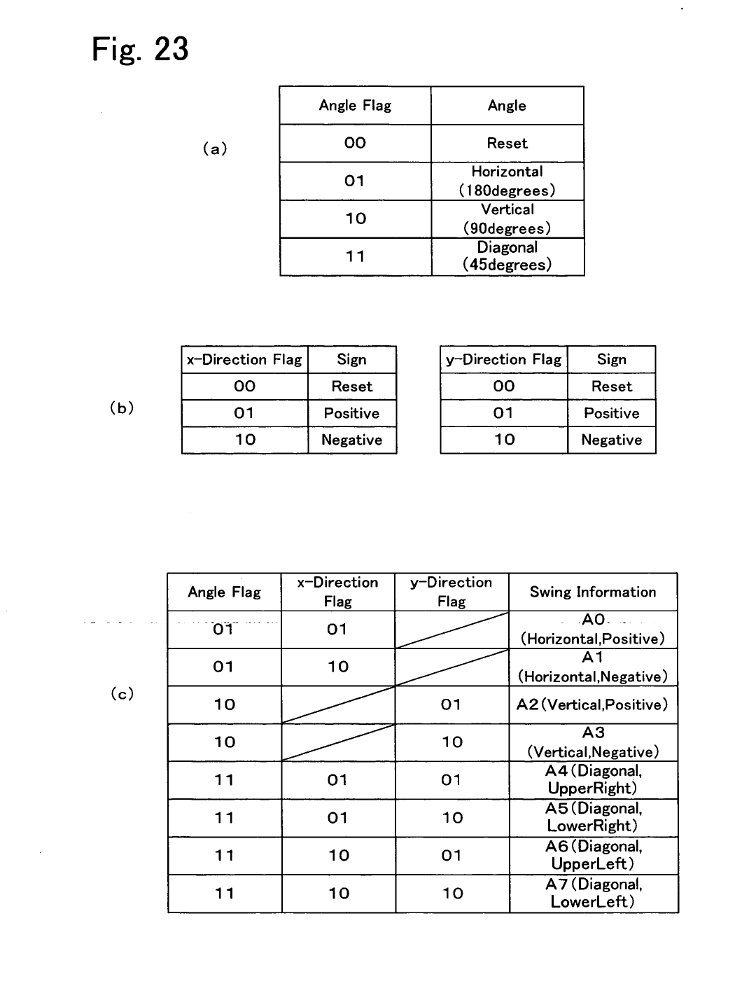

FIG. 23(a) is a view showing a relation between a value of an angle flag and an angle. FIG. 23(b) is a view showing a relation between a value of a direction flag and a sign representing a direction. FIG. 23(c) is a view showing a relation among an angle flag, a direction flag and swing information. As mentioned above, the CPU 201 discriminates the magnitude correlation between the absolute values of the average values “LxA” and “LyA” and the predetermined values “xr” and “yr”, and then sets the angle flag as illustrated in FIG. 23(a).

In addition, as mentioned above, the CPU 201 judges signs of the average values “LxA” and “LyA”, and then sets the x-direction flag and the y-direction flag as illustrated in FIG. 23(b).

Furthermore, as illustrated in FIG. 23(c), the CPU 201 determines the swing information of the sword 3 in accordance with the values set to the angle flag, the x-direction flag and the y-direction flag.

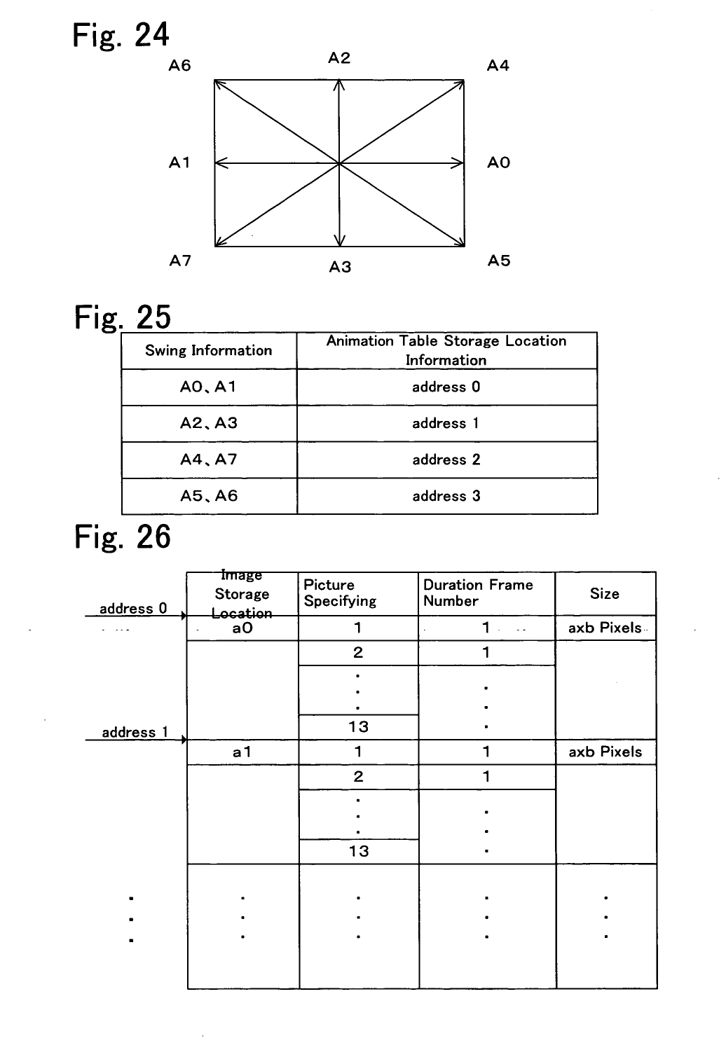

FIG. 24 is a view showing a relation between the swing information of FIG. 23(c) and an operated direction of the sword 3. As illustrated in FIG. 23 and FIG. 24, the swing information “A0” indicates that the sword 3 is swung horizontally to the positive direction of the x-axis (rightward). The swing information “A1” indicates that the sword 3 is swung horizontally to the negative direction of the x-axis (leftward). The swing information “A2” indicates that the sword 3 is swung vertically to the positive direction of the y-axis (upward). The swing information “A3” indicates that the sword 3 is swung vertically to the negative direction of the y-axis (downward). The swing information “A4” indicates that the sword 3 is swung diagonally to the upper right. The swing information “A5” indicates that the sword 3 is swung diagonally to the lower right. The swing information “A6” indicates that the sword 3 is swung diagonally to the upper left. The swing information “A7” indicates that the sword 3 is swung diagonally to the lower left.

The CPU 201 registers animation table storage location information associated with the swing information “A0” to “A7” obtained in the above-mentioned way (sword locus registration or generating trigger). The animation table storage location information indicates a storage location of an animation table. In this case, the animation table includes various information to animate the sword locus object 117.

In the case where there are three or more target points from the target point of which the speed information exceeds the predetermined threshold value “ThV” to the target point of which the speed information becomes less than or equal to the predetermined threshold value “ThV”, the animation table storage location information is registered. On the other hand, if there are less than three, the animation table storage location information is not registered. In other words, if the number of the target points is less than or equal to two points, the above registration is not executed. In addition, in the case where all target points exceed the predetermined threshold value “ThV” and don't become less than or equal to the predetermined threshold value “ThV” from the target point which exceeds the predetermined threshold value “ThV” for the first time to the target point within the photographing range of the image sensor 43, if there are three or more the target points, the animation table storage location information is registered. On the other hand, if there are less than three, the registration is not executed.

FIG. 25 is a view showing relation between swing information “A0” to “A7” and animation table storage location information. In FIG. 25, for example, the swing information “A0” and “A1” are associated with the animation table storage location information “address0”. Incidentally, the animation table storage location information represents the head address information of the area storing the animation table.

FIG. 26 is a view showing an example of the animation table to animate the sword locus object 117. As illustrated in FIG. 26, each of animation tables consists of image storage location information, picture specifying information, duration frame number information and size information. The image storage location information indicates a storage location of image data. Since this image data is for animating, the image data consists of object image data corresponding to respective pictures. Incidentally, the image storage location information is head address information of the area storing the object image data corresponding to the first picture. The picture specifying information indicates order of pictures, each of which corresponds to object image data. The duration frame number information indicates the number of the frames in which the object image data corresponding to the picture specified by the picture specifying information is successively displayed. The size information indicates a size of object image data.

Incidentally, the animation table shown in FIG. 26 is for animating a sword locus object 117. Therefore, for example, since the swing information “A0” and “A1” indicates the sword 3 has been swung horizontally, the image storage location information “a0” of the animation table indicated by the animation table storage location information “address 0” indicates a storage location of the sword locus object 117 which expresses a horizontal sword locus.

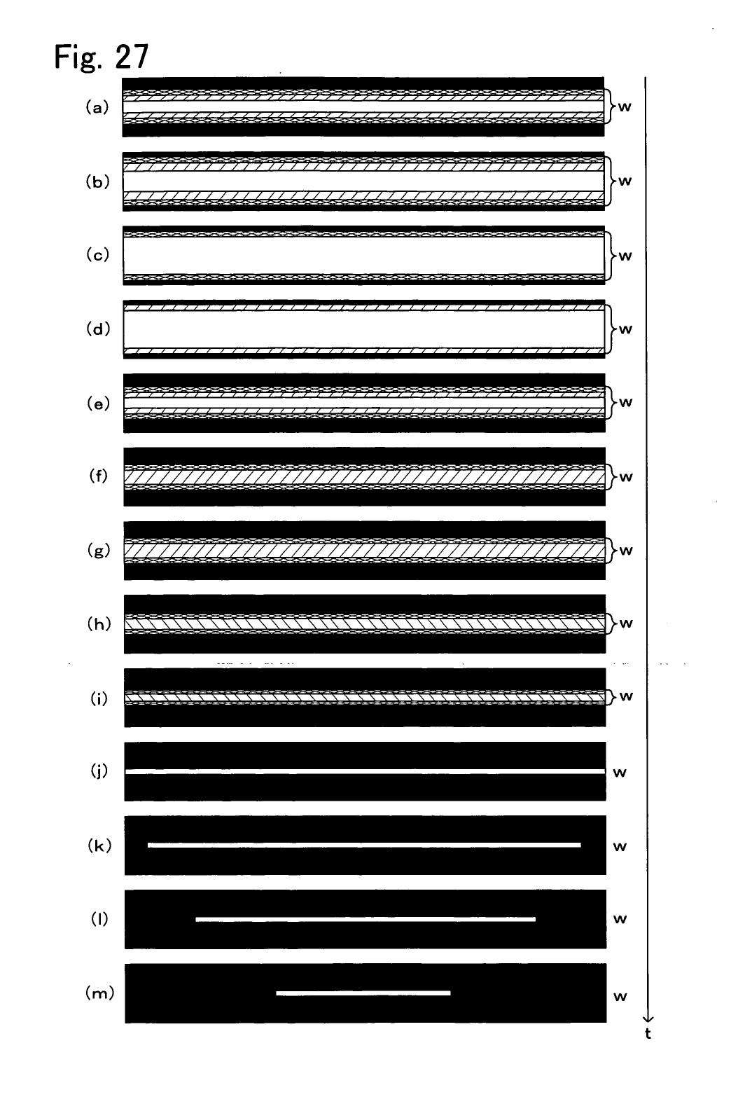

FIG. 27(a) to FIG. 27(m) are examples of object image data to animate a sword locus object 117. Each FIG. 27(a) to 27(m) corresponds to a picture. As illustrated in FIG. 27(a) to FIG. 27(m), the width “w” of the first belt-like image (the sword locus object 117) is narrow. The width “w”, however, increases as the picture (time “t”) proceeds, and further the width “w” decreases as the picture proceeds. This is one of examples of the image data stored in the location indicated by the image storage location information “a0” corresponding to the swing information A0 and A1. Incidentally, the image storage location information “a0” indicates the head address of the object image data of FIG. 27(a).

In what follows, a sprite and background will be briefly explained. The respective objects such as the sword locus object 117 and the shield object 123 consist of a single sprite or a plurality of sprites. The sprite consists of a rectangular pixel aggregation (e.g., 16 pixels×16 pixels) operable to be arranged anywhere in the screen 91. On the other hands, the background consists of a two-dimensional array of rectangular pixel aggregations (e.g., 16 pixels×16 pixels) and size is enough to cover the entire screen 91 (e.g., 256 pixels (width)×256 pixels (height)). The rectangular pixel aggregation constructing a sprite or background is mentioned as a character.

The storage location information (the head address) of each sprite constructing the object image data of FIG. 27(a) is calculated on the basis of the storage location information “a0” of the sword locus object 117 and the size of the sprite. In addition, the storage location information (the head address) of the object image data showed in the respective FIGS. 27(b) to 27(m) is calculated on the basis of the image storage location information “a0”, and the picture specifying information and the size information of the animation table. The storage location information (the head address) of each sprite constructing the object image data is calculated on the basis of the storage location information of the object image data and the size of the spite. However, the storage location information of the object image data and each sprite may be preliminarily prepared in the animation table in place of being obtained by calculating.

Incidentally, the black parts in FIG. 27(a) to FIG. 27(m) represent that they are transparent. Furthermore a difference of hatching shows a difference of color. In this example, since one picture is displayed only during one frame, thirteen pictures need thirteen frames to display. Also, for example, the frame is updated every one-sixtieth second. As mentioned above, by changing the width “w” of the sword locus object 117 from narrow to wide and further from wide to narrow as a picture (time “t”) advances, in response to the swing of the sword 3, it is possible to portray a sword locus like a sharp flash.

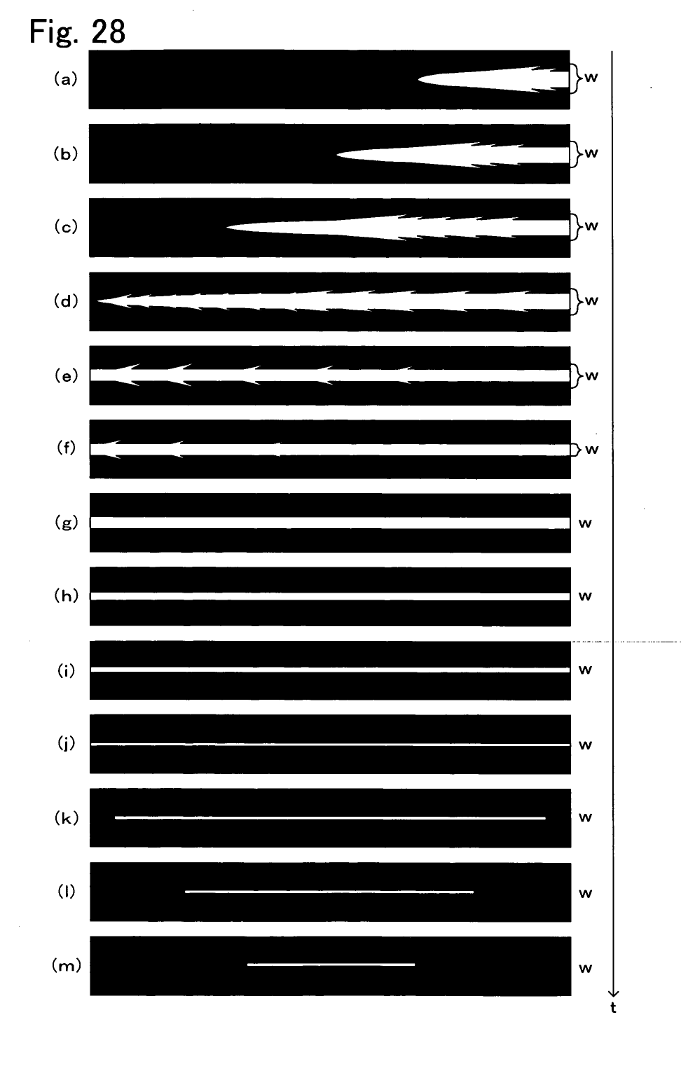

FIG. 28(a) to FIG. 28(m) are other examples of object image data to animate a sword locus object 117. As illustrated in FIG. 28(a) to FIG. 28(m), at first, the width “w” of the belt-like image (the sword locus object 117) is wide, but the width “w” decreases as the picture (time “t”) proceeds. In addition, at first, the length of the sword locus object 117 is short, but it becomes longer as the picture (time “t”) proceeds, and then it keeps a certain length. By the way, this is one of examples of object image data to animate the sword locus object 117 corresponding to the swing information “A1”. The sword locus images, therefore, appear from right side corresponding to the moving direction of the sword 3 (refer to FIG. 24). On the other hand, in case of swing information “A0”, the direction of the object image data of FIG. 28(a) to FIG. 28(m) is opposite. In other words, in FIG. 28(a) to FIG. 28(d), the sword locus images appear from left side. In the same way, in the object image data corresponding to the other swing information “A2” to “A7”, the sword locus images appear from the direction corresponding to the moving direction of the sword 3 (refer to FIG. 24).

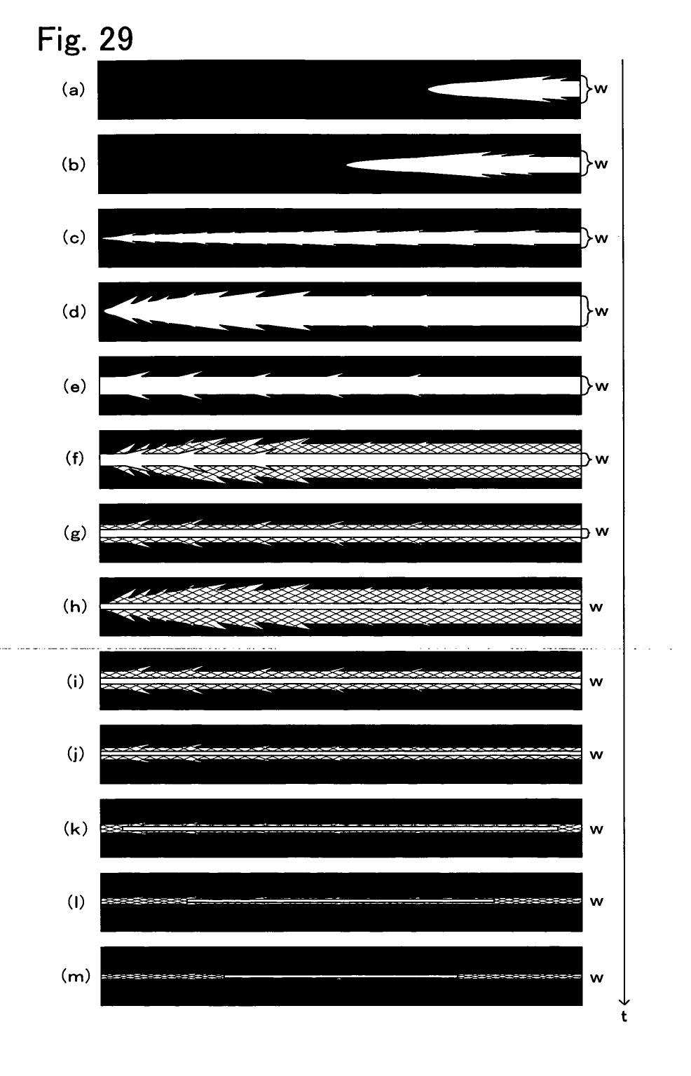

FIG. 29(a) to FIG. 29(m) are further examples of object image data to animate a sword locus object 117. As illustrated in FIG. 29(f) to FIG. 29(m), it is possible to add afterimage effects (described with hatching) to the images having the width “w” (drawn in white). By the way, this is an example of the object image data to animate the sword locus object 117 corresponding to the swing information “A1”. Therefore, the sword locus images appear from right side in response to the moving direction of the sword 3 (refer to FIG. 24). In case of the swing information “A0”, the direction of the object image data of FIG. 29(a) to 29(m) is opposite. In other words, in FIG. 29(a) to 29(d), the sword locus images appear from left side. In the same way, in the object image data corresponding to the other swing information “A2” to “A7”, the sword locus images appear from the direction corresponding to the moving direction of the sword 3 (refer to FIG. 24).

In FIG. 27 to FIG. 29, the white parts of the sword locus images can be any desired color including white.

The CPU 201 calculates coordinates of the sword locus object 117 on the screen 91. First, the case where the swing information is “A0” or “A1” will be explained. Accordingly, the CPU 201 determines the y-coordinate (yt) of the center of the sword locus object 117 on the basis of the y-coordinate (Py[S]) of the target point (S) whose a speed exceeds the predetermined threshold value “ThV” for the first time and the y-coordinate (Py[E]) of the target point (E) whose a speed is less than or equal to the predetermined threshold value “ThV” for the first time. In fact, the following formula is used.
yt=(Py[S]+Py[E])/2 (8)

On the other hand, the x-coordinate (xt) of the center point of the sword locus object 117 is as follow.
xt=0 (9)

In this way, the vertical position of the sword locus object 117 is corresponded to the operation of the sword 3 operated by the operator 94. On the other hand, in this example, it is appropriate to set the x-coordinate (xt) of the center point of the sword locus object 117 to the x-coordinate (=0) of the center of the screen because the swing information is “A0” or “A1”, i.e., the sword 3 is swung horizontally.

Next, the case where swing information is “A2” or “A3”, i.e., the case where the sword 3 is swung vertically, will be explained. In this case, an x-coordinate of the target point (S) where a speed first exceeds the predefined threshold value “ThV” is defined as “Px[S]”, and a x-coordinate of the target point (E) where a speed first is less than or equal to the predefined threshold value “ThV” is defined as “Px[E]”. Therefore, the center coordinates (xt, yt) of the sword locus object 117 is calculated using the following formulas.
xt=(Px[S]+Py[E])/2 (10)
yt=0 (11)

In this way, the horizontal position of the sword locus object 117 is corresponded to the operation of the sword 3 operated by the operator 94. On the other hand, in this example, it is appropriate to set the y-coordinate (yt) of the center point of the sword locus object 117 to y-coordinate of the center of the screen, i.e., “0” because the swing information is “A2” or “A3”, i.e., the sword 3 is swung vertically.

Next, the case where the swing information is “A4” or “A7”, i.e., the case where the sword 3 is swung obliquely in the right upper direction or in the left lower direction, will be discussed as below. In this case, the CPU 201 calculates temporary coordinates (xs, ys) using the following formulas in order to calculate the center coordinates of the sword locus object 117.
xs=(Px[S]+Px[E])/2 (12)
ys=(Py[S]+Py[E])/2 (13)

Then, the CPU 201 calculates the intersecting coordinates (xI, yI) where a straight line passing the coordinates (xs, ys) intersects with a diagonal line sloping down to the right on the screen 91. In this case, the straight line passing the coordinates (xs, ys) is parallel to a diagonal line sloping up to the right on the screen 91. Incidentally, calculating the accurate intersecting coordinates (xI, yI) is not indispensable. The intersecting coordinates (xI, yI) thus calculated is defined as the center coordinates (xt, yt) of the sword locus object 117.

The case where the swing information is “A5” or “A6”, i.e., the case where the sword 3 is swung obliquely in the right lower direction or in the left upper direction, the CPU 201 calculates intersecting coordinates (xI, yI) where a straight line passing the temporary coordinates (xs, ys) intersects with a diagonal line sloping up to the right on the screen 91. In this case, the straight line passing the coordinates (xs, ys) is parallel to a diagonal line sloping down to the right on the screen. Incidentally, calculating the accurate intersecting coordinates (xI, yI) is not indispensable. The intersecting coordinates (xI, yI) thus calculated is defined as the center coordinates (xt, yt) of the sword locus object 117.

Incidentally, In the case where all target points are larger than the predefined threshold value “ThV”, i.e., no target point is less than or equal to the predefined threshold value “ThV” from the target point (S) which first exceeds the predefined threshold value “ThV” to the target point within the photographing range of the image sensor 43 (e.g., the target point (4) in FIG. 22), the target point just before getting out of the photographing range of the image sensor 43 is regarded as the target point (E) (e.g., the target point (4) in FIG. 22). Then, calculation of the formulas (8) to (13) is performed on the basis of this target point (E) and the target point (S) first exceeding the predefined threshold value “ThV”.

Next, the process of determining whether or not the sword locus object 117 hits the enemy object 115 will be explained as below.

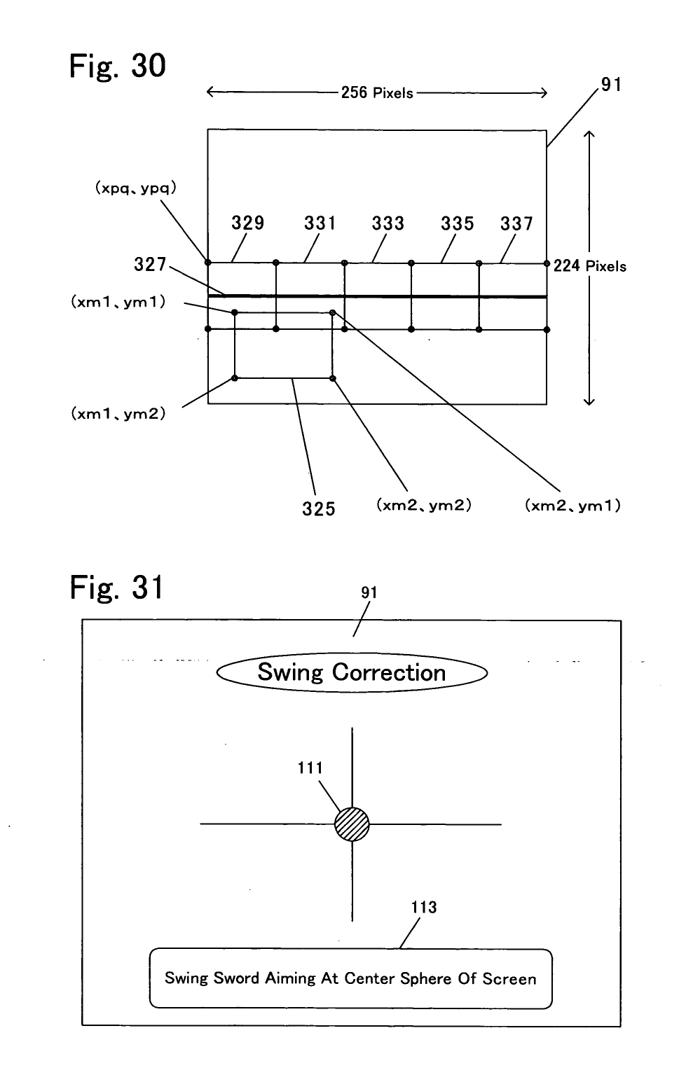

FIG. 30 is a view showing the hit judging process by the CPU 201 of FIG. 8. As illustrated in FIG. 30, there is assumed to be the same fictive plane as the fictive screen of FIG. 22. In addition, there is assumed to be a centerline 317 in the longitudinal direction of the sword locus object 117 of which the swing information is “A0” or “A1”. Also, there is assumed to be fictive rectangles 329 to 337 each of which has center coordinates on the center line 327. Incidentally, vertex coordinates of the fictive rectangles 329 to 337 are comprehensively referred as coordinates (xpq, ypq). The “p” represents the respective fictive rectangles 329 to 337, therefore, in FIG. 30, p=1 to 5. In addition, the “q” represents the respective vertexes of each of the fictive rectangles 329 to 337, therefore, in FIG. 30, q=1 to 4.

On the other hand, there is assumed to be a hit range 325 with center coordinates of the m-th (“m” is a natural number) enemy object 115 as a center. Besides, the coordinates of the vertexes of the m-th hit range 325 are referred as (xm1, ym1), (xm1, ym2), (xm2, ym2) and (xm2, ym1).

The CPU 201 judges the all vertex coordinates (xpq, ypq) of all fictive rectangles 329 to 337 whether or not they satisfy xm1<xpq<xm2 and ym1<ypq<ym2. Then, if there are any vertex coordinates (xpq, ypq) which satisfy these conditions, the CPU 201 determines that the sword locus object 117 hits the m-th enemy object 115. In other wards, if any of fictive rectangles 329 to 337 overlap with the hit range 325, the CPU 201 gives a decision of a hit.

The judgment as mentioned above is performed to all displaying enemy objects 115. In addition, in the case where the swing information is any one of “A2” to “A7”, the hit judgment is applied in the same way as the swing information “A0” and “A1”, i.e., whether or not the fictive rectangles overlap with the hit range. By the way, the fictive rectangles and the hit ranges are not actually displayed as images. They are merely assumptions.

In addition, if the CPU 201 gives a decision of a hit, the CPU 201 performs a hit registration (generation of a trigger) to display an effect 119. More specifically, the CPU 201 registers storage location information of the animation table associated with one of the swing information “A2” to “A7” when a hit is determined. In this case, the storage location information of the animation table indicates the storage location information of the animation table to animate the effect 119. The effect 119 has its direction, and therefore the swing information items “A0” to “A7” are respectively related to the storage location information items of the animation tables. The effect 119 of FIG. 15 is the image based on the animation table stored in the location where the storage location information of the animation table associated with the swing information “A0” indicates. By the way, the animation table for the effect 119 consists of image storage location information, picture specifying information, duration frame number information and size information as well as the animation table for the sword locus object 117.

The CPU 201 calculates coordinates where the effect 119 should appear in accordance with coordinates of the enemy object 115 if the CPU 201 gives a decision of a hit. This is because the effect 119 is made to appear at the position where the enemy object 115 given the decision of the hit is arranged.

Next, the control of the shield object 123 will be explained. The CPU 201 compares the number of pixels which have differential data exceeding the predefined threshold vale “Th” to the predefined threshold value “ThA”. Then, if the number of pixels which have differential data exceeding the predefined threshold value “Th” is larger than the predefined threshold value “ThA”, the CPU 201 determines that the reflecting sheet 17, i.e., the side of the blade 15 of the sword 3 is detected. More specifically, if the number of the pixels which have differential data exceeding the threshold value “Th” is larger than the threshold value “ThA”, it means an area reflecting infrared ray is large. Therefore, the reflecting sheet being detected is not the reflecting sheet 23 which has a small area but the reflecting sheet 17 which has a large area.

The CPU 201 performs a shield registration (generation of a trigger) to display a shield object 123 when the CPU 201 detects the reflecting sheet 17 which has a large area. More specifically, the CPU 201 registers storage location information of the animation table to animate the shield object 123. In addition, the animation table for the shield object 123 consists of image storage location information, picture specifying information, duration frame number information and size information as well as the animation table for the sword locus object 117.

The CPU 201 sets the first coordinates (xs, ys) of the shield object 123 to the coordinates of the target point at the time when the large reflecting sheet 17 is first detected.

Furthermore, the CPU 201 calculates the coordinates after movement of the shield object 123 in order to move the shield object 123 in response to movement of the sword 3. This will be discussed in detail as follows. Incidentally, the coordinates of the target point after movement of the sword 3 after moved is assumed to be (Px[M], Py[M]).

The CPU 201 first calculates a moving distance “lx” in x-direction and a moving distance “ly” in y-direction using the following formulas. Besides, in the following formulas, “N” is an integer number of two or larger and also a predefined value.
lx=(Px[M]−xs)/N (14)
ly=(Py[M]−ys)/N (15)

Then, the CPU 201 sets coordinates (xs, ys) after movement of the shield object 123 to the coordinates moved by the moving distances “lx” and “ly” from the previous coordinates (xs, ys) of the shield object 123. More specifically, the CPU 201 calculates the coordinates after movement of the shield object 123 using the following formulas.
xs=lx+xs (16)
ys=ly+ys (17)

Next, controlling the explanation object 129 will be explained. The CPU 201 performs an explanation proceeding registration (generation of a trigger) if the sword 3 is vertically swung while the explanation object 129 is being displayed. More specifically, the CPU 201 registers storage location information of the animation table to display the next explanation object 129. The animation table for the explanation object 129 consists of image storage location information, picture specifying information, duration frame number information and size information as well as the animation table for the sword locus object 117. A still image which is not animated such as the explanation object 129 only consists of one picture, the maximum value is assigned to its duration frame number information, and further the still image is set to repeat itself. In this way, it is possible to display a still image with using the animation table.

Next, advance control will be explained. The CPU 201 performs a advance registration (generation of trigger) if the target point of the sword 3 exists within the predefined area around center coordinates of the screen 91 during the prescribed number of frames while the guide instructing to forward is being displayed on the screen 91 (refer to FIG. 18(a) and FIG. 18(b)).

The CPU 201 updates the background on the basis of the advanced distance within the virtual space, subject to the advance registration. For example, each time the predetermined distance is advanced within the virtual space, the background is updated. More specific description is as below.

An array having the same number of the elements as all characters constructing the background is prepared in the inner memory 207. In addition, the storage location information (the head address) of the characters is assigned to the array elements. Therefore, all elements of the array are updated to update the background.

Next, control of the cursor 101 will be explained. The CPU 201 performs a cursor registration (generation of a trigger) when the CPU 201 detects the target point of the sword 3 on the selecting screen (refer to FIG. 12). More specifically, the CPU 201 registers storage location information of the animation table to animate the cursor 101. The animation table for the cursor 101 consists of image storage location information, picture specifying information, duration frame number information and size information as well as the animation table for the sword locus object 117.

In addition, the CPU 201 set the first coordinates of the cursor 101 to the coordinates of the target point of the sword 3. Furthermore, the CPU 201 calculates coordinates after movement of the cursor 101 in order to move the cursor 101 in response to movement of the sword 3. The calculation is same as the calculation to obtain the coordinates after movement of the shield object 123. Therefore, redundant explanation is dispensed.

Next, control of the content object 109 will be explained. The CPU 201 judges whether or not the cursor 101 exists in a predefined area “R1” around the leftward rotation instructing object 103 or a predefined area “R2” around the rightward rotation instructing object 105. If the cursor 101 exists in the predefined area “R1”, the CPU 201 subtracts the predefined value “v” from an x-coordinate of a static position of each content object 109. In the same way, if the cursor 101 exists in the predefined area “R2”, the CPU 201 adds the predefined value “v” to an x-coordinate of a static position of each content object 109. In this way, the x-coordinate after movement of each content object 109 is obtained. In this case, a y-coordinate is fixed. In addition, if the content object 109 moves to outside of the screen, the x-coordinate is set in such a manner that the content object 109 reappears from the right side (so as to loop).

In addition, the CPU 201 registers the content object 109. More specifically, the CPU 201 registers storage location information of the animation table to display the content object 109. The animation table for the content object 109 consists of image storage location information, picture specifying information, duration frame number information and size information as well as the animation table for the sword locus object 117. Incidentally, the content object 109 is not animated as well as the explanation object 129.

Next, a swing correction will be explained. The CPU 201 acquires correction information “Kx” in the x-direction and correction information “Ky” in the y-direction. The CPU 201 adds the correction information “Kx” and “Ky” to the coordinates (x, y) of the target point and defines it as the coordinates (Px[M], Py[M]) of the target point. In other words, the CPU 201 computes Px[M]=x+Kx and Py[M]=y+Ky. In what follows, the process of acquiring correction information will be explained in detail.

FIG. 31 is a view showing an example of a swing correcting screen when the content object 109 of “swing correction” is selected on the selecting screen of FIG. 12. As illustrated in FIG. 31, a circular object 111 and an explanation object 113 are contained in the swing correcting screen displayed on the screen 91. The operator 94 swings vertically or horizontally aiming at the circular object 111 located on the center of the screen in accordance with the instruction of the explanation object 113.

Even though the operator 94 swings the sword 3 at the position where the operator 94 supposes the center, the sword locus object 117 is not always displayed at the center of the screen 91 depending on relation among an orientation and a position of the image sensor 43 and a position where the sword 3 is swung. More specifically, although he/she swings the sword 3 vertically aiming at the circular object 111, the sword locus object 117 deviated by a certain distance in x-direction might be displayed. Furthermore, although he/she swings the sword 3 horizontally aiming at the circular object 111, the sword locus object 117 deviated by a certain distance in y-direction might be displayed. These deviances are the correction information “Kx” and “Ky”. By correcting the coordinates of the target point of the sword 3 using the correction information “Kx” and “Ky”, the sword locus object 117 can be displayed in a location where the operator 94 aims at.

By swinging the sword 3 once, several target points are detected. In case of the vertical swing operation, the correction information “Kx” is calculated using the average value “xA” of the x-coordinates of target points by a formula Kx=xc−xA. On the other hand, in case of the horizontal swing operation, the correction information “Ky” is calculated using the average value “yA” of the y-coordinates of target points by a formula Ky=yc−yA. Incidentally, the coordinates (xc, yc) is the center coordinates (0, 0) of the screen 91.

For example, coordinates of each object such as the sword locus object 117 described above are defined as the center coordinates of the object. In addition, coordinates of the sprite are defined as the center coordinates of the sprite. Furthermore, for example, the coordinates of the object may be defined as the center coordinates of the sprite on the top of the left of the sprites constituting the object.

The overall process flow of the information processing apparatus 1 of FIG. 1 will be explained with reference to flowcharts.

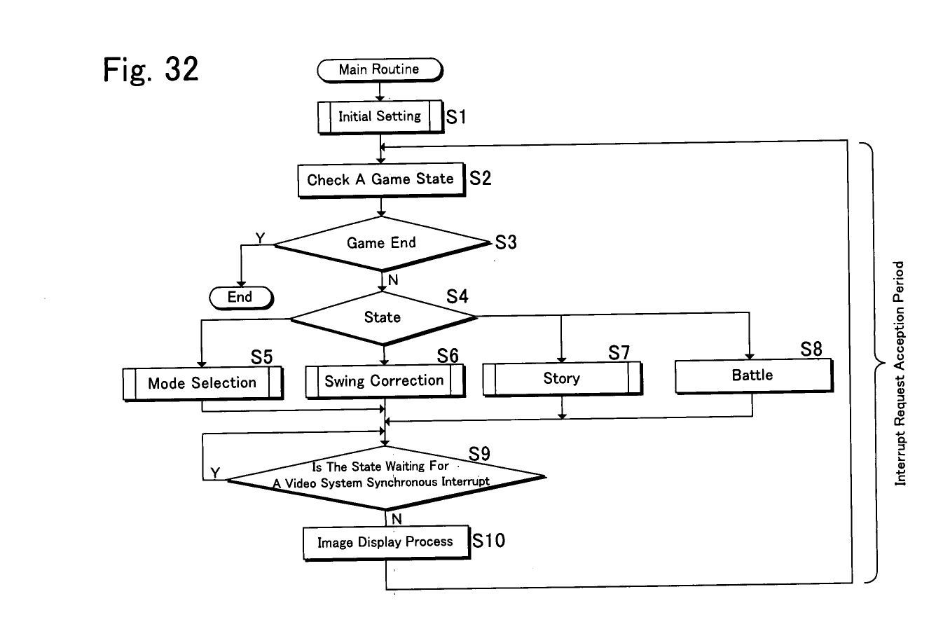

FIG. 32 is a flowchart showing the overall process flow of the information processing apparatus 1 of FIG. 1. As illustrated in FIG. 32, the CPU 201 performs the initial setting of the system in step S1.

In step S2, the CPU 201 checks the state of a game. In step S3, the CPU 201 determines whether or not the game is finished. If the game is not finished, the CPU 201 proceeds to step S4, but if the game is finished, the CPU 201 finishes the process.

In step S4, the CPU 201 determines the current state. If the state is in a state of mode selection, the process proceeds to step S5. If it is in a swing correcting mode, the process proceeds to step S6. If it is in a story mode, the process proceeds to step S7. If it is in a battle mode, the process proceeds to step S8. By the way, in step S8, the CPU 201 performs game processing for a the battle mode (refer to FIG. 19).

In step S9, the CPU 201 waits for the video system synchronous interrupt. In this embodiment, the CPU 201 transmits image data for updating a display screen of the television monitor 90 to the graphics processor 202 after the start of the vertical blanking period. Therefore, after an arithmetic process to update the display screen is completed, the progress of the process is refrained until the video system synchronous interrupt is issued.

If “Yes” is determined in step S9, i.e., while waiting for the video system synchronous interrupt (i.e., while there is no video system synchronous interrupt), the same step S9 is repeated. On the other hand, if “No” is determined in step S9, i.e., if the period of waiting the video system synchronous interrupt ends (i.e., if the video system synchronous interrupt is issued), the process proceeds to the step S10.

In step S10, the CPU 201 performs a image display process on the basis of the result of the process of step S5 to S8, and then, the CPU 201 proceeds to step S2. In this case, the image display process is indicative of giving an instruction to acquire image information of all sprites (storage location information of each sprite and coordinates of each sprite) to be displayed and an instruction to acquire all elements of the array to display the background to the graphic processor 202. The graphic processor 202 receives the information, and applies a necessary process, and then, generates a video signal to display each object and background.

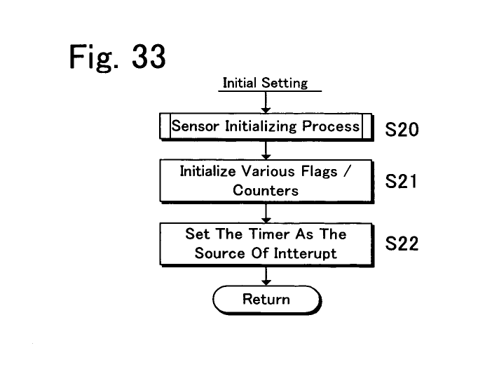

FIG. 33 is a flowchart showing the process of the initial setting in step S1 of FIG. 32. As illustrated in FIG. 33, the CPU 201 performs the initial setting of the image sensor 43 in step S20. In step S21, the CPU 201 initializes various flags and counters.

In step S22, the CPU 201 sets the timer circuit 210 as an interrupt source for sound output. The audio process is performed by this interruption process and then sounds such as sound effect and music are output from speakers of the television monitor 91. More specific description is as below.

The sound processor 203 acquires storage location information of the sound data 105 from the inner memory 207 in response to the instruction from the CPU 201 on the basis of the timer interruption.

The sound processor 203 reads the sound data 105 from ROM 65 on the basis of the storage location information, and applies a necessary process. Then, the sound processor 203 generates audio signals such as sound effect and music. After that, the sound processor 203 outputs the generated signal to the audio signal output terminal 63. In this way, the sounds such as sound effects and music are output from speakers of the television monitor 90. Incidentally, the sound data 105 includes wave data (sound source data) and/or envelope data.

For example, if the sword locus registration is performed (as a trigger), the CPU 201 transmits an instruction to acquire storage location information of sound effect data in response to the timer interruption. Then, the sound processor 203 acquires the storage location information and reads the sound effect data from the ROM 65, and then generates an audio signal for the sound effect. In this way, the sound effect occurs simultaneously with the appearance of the sword locus object 117 so that the operator 94 can have more enhancing actual feeling of swinging the sword 3.

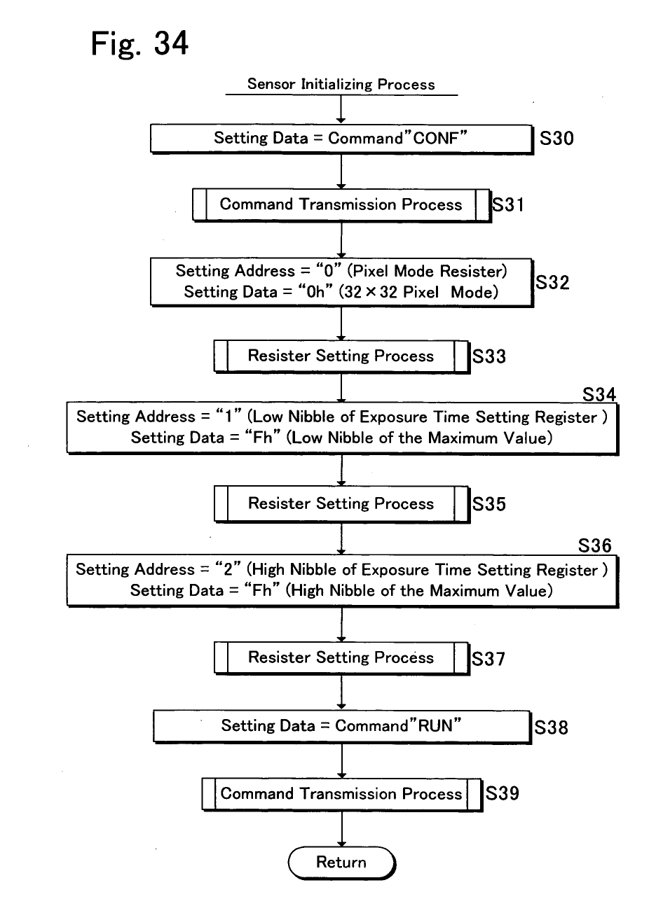

FIG. 34 is a flowchart showing the sensor initializing process in step S20 of FIG. 33. As illustrated in FIG. 34, the high-speed processor 200 sets a command “CONF” as setting data in step 30. It is noted that the command “CONF” is a command for informing the image sensor 43 of entering the setting mode for transmitting a command from the high-speed processor 200. Then, a command transmission process is executed in next step S31.

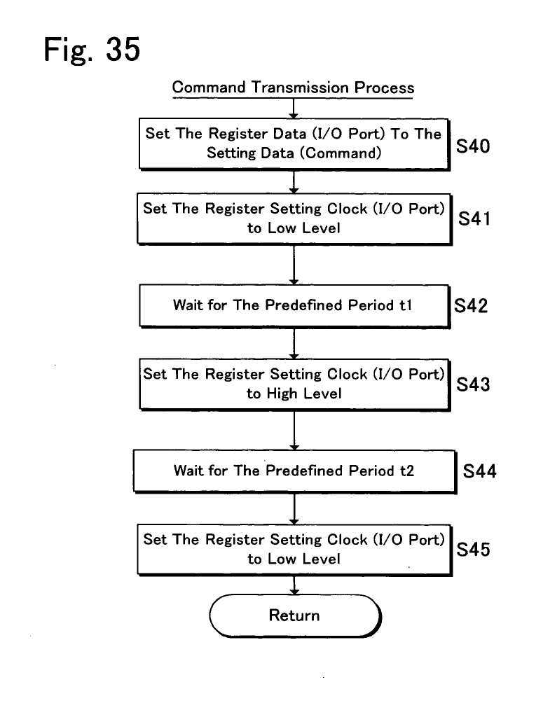

FIG. 35 is a flowchart showing the process flow of the command transmission in step S31 of the FIG. 34. As illustrated in FIG. 35, in the first step S40, the high-speed processor 200 sets register data (I/O ports) to the setting data (the command “CONF” in case of step S31), and then, sets a register setting clock “CLK” (an I/O port) to a low level in next step S41. Then, after a wait of a predetermined time period in step S42, the register setting clock “CLK” is set to a high level in step S43. Furthermore, after a wait of a predetermined time period in step S44, the register setting clock “CLK” is set to the low level once again in step S45.

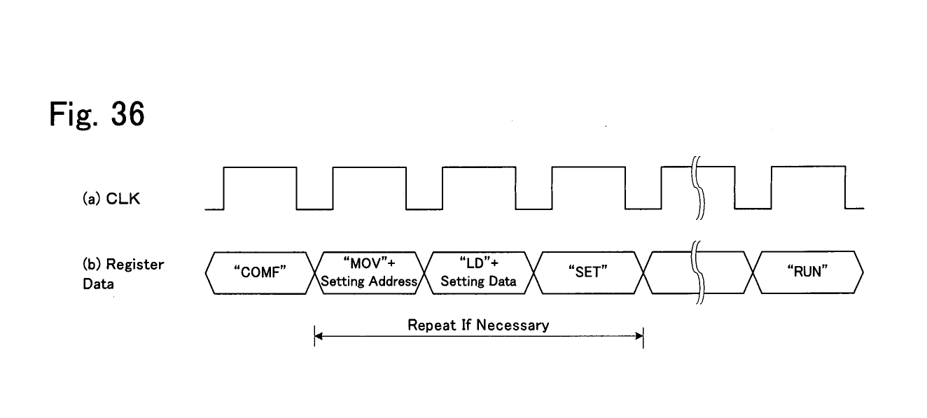

In this way, as illustrated in FIG. 36, the register setting clock “CLK” is changed to the low level, the high level, and the low level while the waits of the predetermined time periods are performed, and whereby, a transmitting process of the command (command or command+data) is performed.

Returning to FIG. 34, in step S32, a pixel mode is set and an exposure time is set. In this embodiment, as mentioned above, the image sensor 43 is a CMOS image sensor, for example, consisting of 32 pixels×32 pixels. Therefore, “Oh” indicative of 32 pixels×32 pixels is set to a pixel mode resister whose a setting address is “0”. Then, in next step S33, the high speed processor 200 performs a resister setting process.

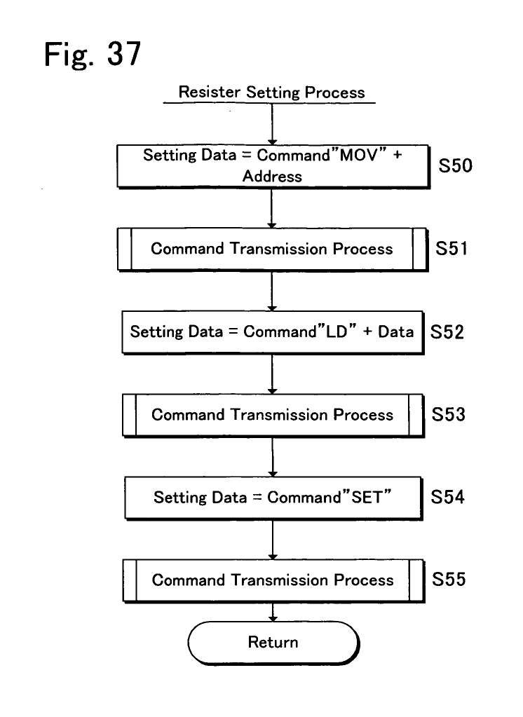

FIG. 37 is a flowchart showing the process flow of resister setting in step S33 of FIG. 34. As illustrated in FIG. 37, in the first step S50, the high speed processor 200 sets a command “MOV”+an address as setting data, and, in next step S51, executes the command transmitting process mentioned above in FIG. 35 to transmit them. In next step S52, the high speed processor 200 sets a command “LD”+data as setting data, and then executes the command transmitting process to transmit them in step S53. After that, the high speed processor 200 sets a command “SET” as setting data in step S54, and then, transmits it in step S55. Incidentally, the command “MOV” is a command indicative of transmitting an address of the control register; the command “LD” is a command indicative of transmitting data; and the command “SET” is a command indicative of setting the data to the address. Meanwhile, the process is repeatedly performed if there are several control resisters to be set.

Returning to FIG. 34, in step S34, the setting address is set to “1” (indicating an address of a low nibble of an exposure time setting register), and low nibble data “Fh” of “FFh” indicative of the maximum exposure time is set as data to be set. Then, in step S35, the register setting process referred in FIG. 37 is executed. In the same way, in step S36, the setting address is set to “2” (indicating an address of a high nibble of the exposure time setting register), high nibble data “Fh” of “FFh” indicative of the maximum exposure time is set as data to be set, and then the register setting process is executed in step S37.

After that, in step S38, a command “RUN” indicative of an end of the setting and for starting to output data from the image sensor 43 is set, and then is transmitted in step S39. In this way, the sensor initialization process is performed in the step S20 of FIG. 33. However, these examples shown in FIG. 34 to FIG. 37 can be changed depending on a specification of the image sensor 43 to be used.

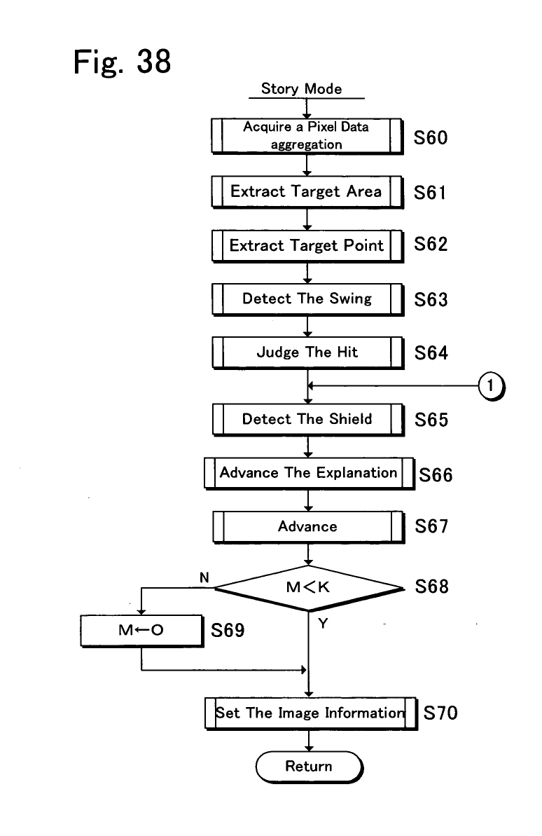

FIG. 38 is a flowchart showing the process flow of the story mode in step S7 of FIG. 32. As illustrated in FIG. 38, the CPU 201 obtains digital pixel data from ADC 208 in step 60. This digital pixel data is the result of converting analog pixel data from the image sensor 43 by the ADC 28.

In step S61, a target area extracting process is performed. More specifically, the CPU 201 calculates a difference between the pixel data acquired when the infrared light emitting diodes 7 are turned on and the pixel data acquired when the infrared light emitting diodes 7 are turned off to obtain differential data. Then, the CPU 201 compares the differential data to a predefined threshold value “Th”, and counts pixels which have the differential data exceeding the predefined threshold value “Th”.

In step S62, the CPU 201 finds a maximum value from the differential data exceeding the predefined threshold value “Th”, and then defines the coordinates of the pixel which has the maximum differential data as a target point of the sword 3.

In step S63, the CPU 201 detects a swing operation of sword 3 by the operator 94, and then issues a trigger to display a sword locus object 117 corresponding to the swing of the sword 3.

In step S64, the CPU 201 determines whether or not the sword locus object 117 hits the enemy object 115, and in case of a hit, issues a trigger to display the effect 119.

In step S65, when the CPU 201 detects the reflecting sheet 17 attached on the side of the blade 15 of the sword 3, the CPU 201 generates a trigger to display the shield object 123.

In step S66, the CPU 201 generates a trigger to display a next explanation object 129 if the sword 3 is swung down vertically while the explanation object 129 is displayed.

In step S67, the CPU 201 updates each element of the array for the background display for animating the background so as to advance if the target point of the sword 3 exists within a predefined area during the predetermined number of frames while the advance instruction is displayed.

In step S68, the CPU 201 determines whether or not “M” is smaller than a predefined value “K”. If “M” is more than or equal to the predefined value “K”, the CPU 201 proceeds to step S69, assigns “0” to “M”, and then proceeds to step S70. On the other hand, if “M” is smaller than the predefined value “K”, the CPU 201 proceeds from step S68 to step S70. The meaning of “M” will become evident in the after-mentioned explanation.

In step S70, the CPU 201 sets image information (such as the storage location information and display position information of each sprite) of all sprites to be displayed in the inner memory 207 on the basis of the result of the above process.

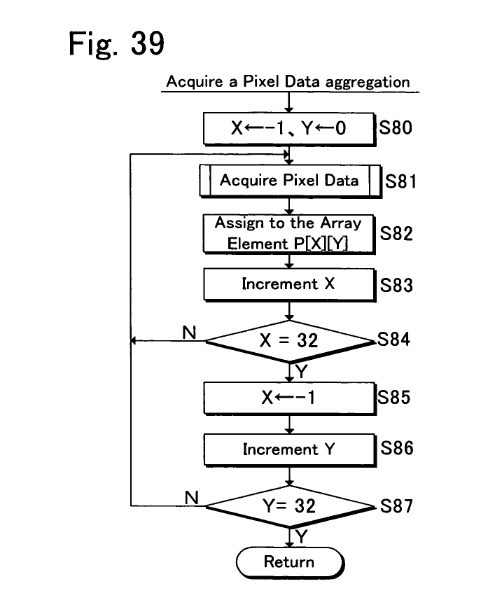

FIG. 39 is a flowchart showing the process flow of acquiring pixel data aggregation in step S60 of FIG. 38. As illustrated in FIG. 39, the CPU 201 sets “X” to “−1” and “Y” to “0” as element numbers of a pixel data array in the first step S80. In this embodiment, although the pixel data array is a two-dimensional array such as X=0 to 31 and Y=0 to 31, an initial value of “X” is set to “−1” because dummy data is output as pixel data at the head of each row as referred above. In the next step S81, the pixel data acquiring process is executed.

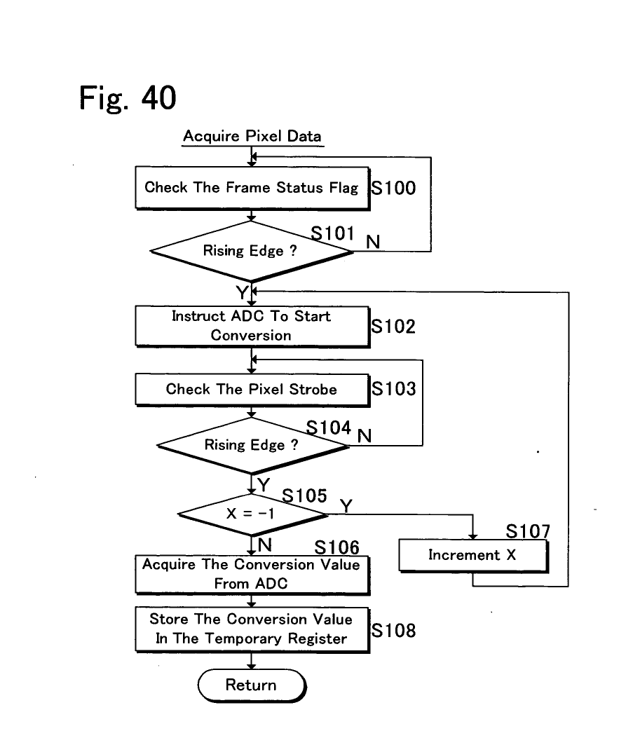

FIG. 40 is a flowchart showing the process flow of acquiring pixel data in step S81 of FIG. 39. As illustrated in FIG. 40, the CPU 201 checks a frame status flag signal “FSF” as output from the image sensor 43 in step S100, and determines whether or not a rising edge (from low level to high level) of the frame status flag takes place in step 101. If the rising edge of the flag signal “FSF” is detected in step 101, in next step S102, the CPU 201 instructs the ADC 208 to start converting analog pixel data to digital pixel data. After that, the CPU 201 checks a pixel strobe “PDS” from the image sensor 43 in step S103, and then determines whether or not a rising edge (from low level to high level) of the strobe signal “PDS” takes place in step S104.

If “Yes” is determined in step S104, the CPU 201 determines whether X=−1 or not, that is, whether the head pixel or not in step S105. As previously referred, since the head pixel of each row is set as a dummy pixel, if “YES” is determined in the step 105, without acquiring the pixel data at that time in the next step 107, the element number “X” is incremented.

If “NO” is determined in step 105, the pixel data is one of the second and succeeding pixel data of the row. Therefore, in step S106 and S108, the pixel data at that time is acquired and stored in a temporary register (not shown). After that, the process proceeds to step S82 of FIG. 39.

In step S82 of FIG. 39, the pixel data stored in the temporary register is assigned to the pixel data array element P[X][Y].

In the following step S83, “X” is incremented. If “X” is less than 32, the process from steps S81 to S83 described above is repeatedly performed. If “X” is equal to 32, i.e., the acquisition of the pixel data is reached to the end of the row, “X” is set to “−1” in the next step S85. Then “Y” is incremented in step S86 and the process to acquire the pixel data is repeatedly performed from the head of the next row.

In step S87, if “Y” is equal to 32, i.e., the acquisition of the pixel data is reached to the end of the pixel data array element P[X][Y], the process proceeds to step S61 of FIG. 38.

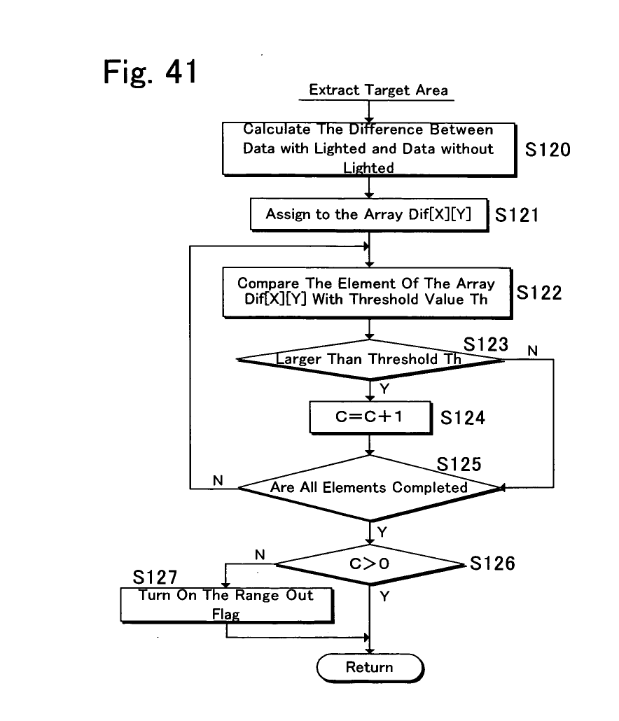

FIG. 41 is a flowchart showing the process flow of extracting a target area in step S61 of FIG. 38. As illustrated in FIG. 41, in step S120, the CPU 201 calculates a difference between the pixel data acquired when the infrared emitting diodes 7 are turned on and the pixel data acquired when the infrared emitting diodes 7 are turned off to obtain difference data.

In step S121, the CPU 201 assigns the calculated difference data to the array element Dif[X] [Y]. In this embodiment, since the 32×32 pixel image sensor 43 is used, X=0 to 31 and Y=0 to 31.

In step S122, the CPU 201 compares an element of the array Dif[X][Y] to a predefined threshold value “Th”.

In step S123, if the element of the array Dif[X] [Y] is larger than the predefined threshold value “Th”, the CPU 201 proceeds to step S124, otherwise proceeds to step S125.

In step S124, the CPU 201 increments a count value “c” by “1” in order to count the difference data (the elements of the array Dif[X][Y]) exceeding the predefined threshold value “Th”.

The CPU 201 repeatedly performs the process from step S122 to S124 until the comparison of all elements of the array Dif[X] [Y] with the predefined threshold value “Th” is completed (step S125).

After the comparison of all elements of the array Dif[X] [Y] with the predefined threshold value “Th” is completed, the CPU 201 determines whether or not the count value “c” is larger than “0” in step S126.

If the count value “c” is larger than “0”, the CPU 201 proceeds to step S62 of FIG. 38. The count value “c” exceeding “0” indicates that the reflecting surface (the reflecting sheet 17 or 23) of the sword 3 is detected.

On the other hand, if the count value “c” is equal to “0”, the process proceeds to step S127. The count value “c” equal to “0” indicates that the reflecting surface (the reflecting sheet 17 and 23) of the sword 3 is not detected. In other words, it is noted that the sword 3 exists out of the photographing range of the imaging unit 5. Therefore, the CPU 201 turns on a range out flag indicating the sword 3 is out of the photographing range in step S127.

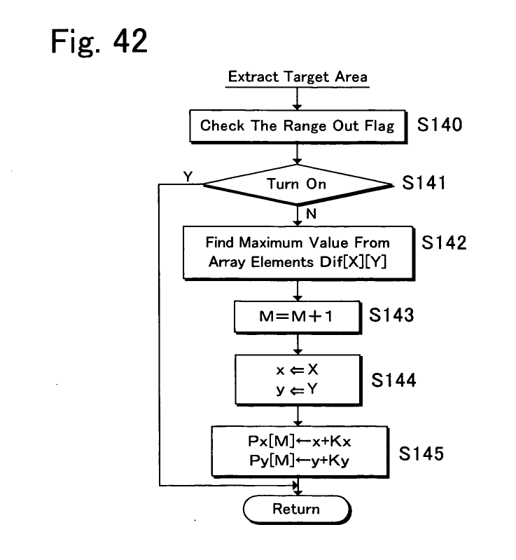

FIG. 42 is a flowchart showing the process flow of extracting a target point in step S62 of FIG. 38. As illustrated in FIG. 42, the CPU 201 checks the range out flag in step S140.

If the range out flag is turned on, the CPU 201 proceeds to step S63 of FIG. 38 (step S141). This is because if the sword 3 is out of the photographing range of the imaging unit 5, it is not necessary to perform the process to extract the target point. On the other hand, if the range out flag is turned off, i.e., the sword 3 is detected, the process proceeds to step S142 (step S141).

In step S142, the CPU 201 finds the maximum value from the elements of the array Dif[X][Y] (difference data).

In step S143, the CPU 201 increments “M” by 1. Incidentally, “M” is initialized to “0” in step S21 of FIG. 33.

In step S144, the CPU 201 converts the coordinates (X, Y) of the pixel which has the maximum difference data found in step S142 to coordinates (x, y) on the screen 91. In other words, the CPU 201 converts a coordinate space of an image (32 pixels×32 pixels) from the image sensor 43 to a coordinate space of the screen 91 (256 pixels (width)×224 pixels (Height)).

In step S145, the CPU 201 adds the correction information “Kx” to the x-coordinate after conversion, assigns the result to the array element Px[M], adds the correction information “Ky” to the y-coordinate after conversion, and assigns the result to the array element Py[M]. In this way, the coordinates (Px[M], Py[M]) of the target point of sword 3 is obtained.

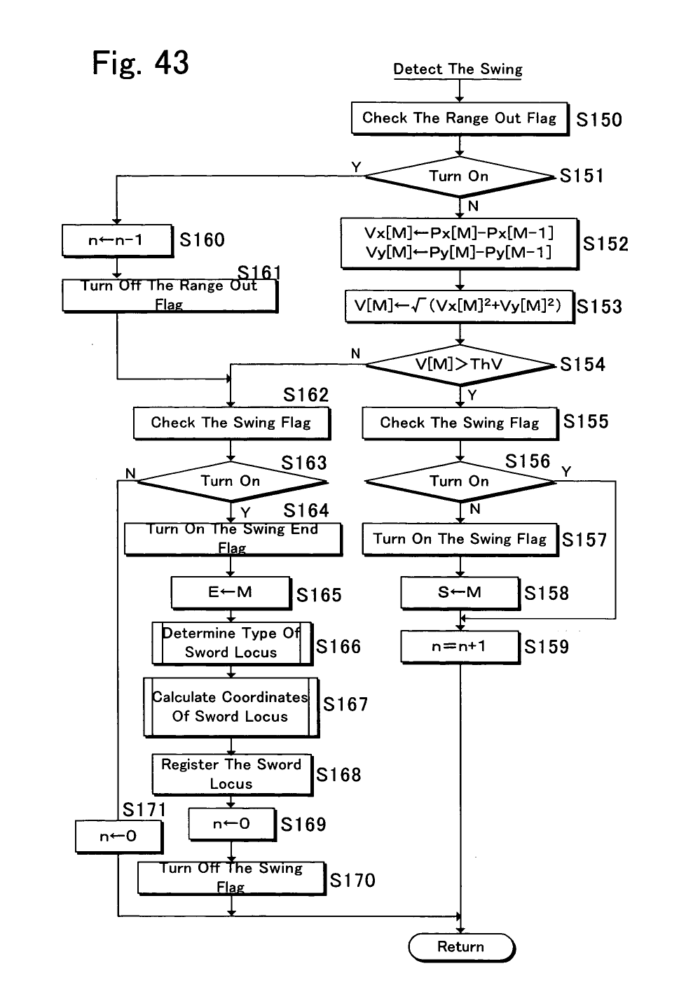

FIG. 43 is a flowchart showing the process flow of detecting a swing in step S63 of FIG. 38. As illustrated in FIG. 43, the CPU 201 checks the range out flag in step S150.

If the range out flag is turned on, the CPU 201 proceeds to step S160, otherwise proceeds to step S152.

In step S152, the CPU 201 calculates the velocity vector (Vx[M], Vy[M]) of the target point (Px[M], Py[M]) of sword 3 using the formulas (1) and (2).

In step S153, the CPU 201 calculates the speed “V[M]” of the target point (Px[M], Py[M]) of the sword 3 using the formula (3).

In step S154, the CPU 201 compares the speed “V[M]” of the target point (Px[M], Py[M]) of the sword 3 to a predefined threshold value “ThV”, and then determines which of them is large or small. If the speed “V[M]” is larger than the predefined threshold value “ThV”, the CPU 201 proceeds to step S155, otherwise proceeds to step S162.

In step S155, the CPU 201 checks a swing flag.

If the swing flag is turned on, the CPU 201 proceeds to step S159, otherwise proceeds to step S157 (step S156).

In step S157, the CPU 201 turns the swing flag on. Namely, if the speed “V[M]” is larger than the predefined threshold value “ThV”, it is determined that the sword 3 is swung, and then the swing flag is turned on.

In step S158, the CPU 201 assigns the element number “M” of the target point first exceeding the predefined threshold value “ThV” to “S”.

In step S159, the CPU 201 increments a target point counter “n” (a count value “n”) by 1 to count the number of the target points detected during the period when the sword 3 is swung once. In this case, only the target points whose speeds exceed the predefined threshold value “ThV” are counted (step S154). After step S159, the process proceeds to step S64 of FIG. 38.

In the mean time, the CPU 201 checks the swing flag in step S162.

If the swing flag is turned on, the CPU 201 proceeds to step S164, otherwise proceeds to step S171 (step S163).

If the swing flag is turned on (step S163) and the speed “V[M]” is less than or equal to the predefined threshold value “ThV” (step S154), it means that the swing of the sword 3 is finished. Therefore, the CPU 201 turns a swing end flag on in step S164.

In step S165, the CPU 201 assigns the element number “M” of the first target point which is equal to or smaller than the predefined threshold value “ThV” to “E”.

In step S166, the CPU 201 determines a type of sword locus object 117 corresponding to the swing of the sword 3.

In step S167, the CPU 201 calculates the coordinates of the sword locus object 117 to be displayed on the screen 91.

In step S168, the CPU 210 registers the storage location information of the animation table to animate the sword locus object 117 selected in step S166 (the sword locus registration, i.e., a trigger).

In step S169, the CPU 201 resets the target point counter “n” (the count value “n”).

In step S170, the CPU 201 turns the swing flag off.

In the mean time, in step S160, the CPU 201 decrements the target point counter “n” (the count value “n”) by “1”. The reason for this will be explained later with reference to FIG. 44.

In step S161, the CPU 201 turns off the range out flag which is currently on.

Then, if the swing flag is turned on after step S162 and step S163, it can be said the target point gets out of the photographing range before its speed is less than or equal to the predefined threshold value “ThV”. In this case, as mentioned above, the process from the steps S164 to S170 is performed in order to determine the type and the coordinates of the sword locus object 117 with using the target point captured just before getting out of the photographing range.

On the other hand, if it is determined the swing flag is turned off in step S163, the CPU 201 resets the target point counter “n” (the count value “n”) in step S171.

FIG. 44 is a flowchart showing the process flow of determining a type of the sword locus object in step S166 of FIG. 43. As illustrated in FIG. 44, the CPU 201 checks the target point counter “n” in step S180.

If the count value “n” is larger than “1”, the process proceeds to step S182, and if the count value “n” is less than or equal to “1”, the process proceeds to step S188 (step S181). In other words, if the count value “n” is more than or equal to “2”, namely, the number of the target points whose speeds exceed the predefined threshold value “ThV” is more than or equal to “2”, the process proceeds to step S182. Furthermore, in other words, if the number of the target points whose speeds exceed the predefined threshold value “ThV” is more than or equal to “2”, it is determined that the swing is not preformed without the intention of the operator 94 (malfunction) but performed with the intention of the operator 94, and then, the process proceeds to step S182.

In step S182, the CPU 201 calculates the swing lengths “Lx” and “Ly” using the formulas (4) and (5).

In step S183, the CPU 201 calculates average values “LxA” and “LyA” of the swing lengths “Lx” and “Ly” using the formulas (6) and (7). In case where the target point goes out the photographing range before the speed of the target point is less than or equal to the predefined threshold value “ThV”, as explained above, the type and the coordinates of the sword locus object 117 are determined using the target point just before getting out of the photographing range. In this case, the target point counter value “n” is “1” larger than a usual value, so that the target point counter “n” is decremented in step S160 of FIG. 43.

In step S184, the CPU 201 compares an absolute value of the average value “LxA” of the swing length “Lx” in the x-direction to a predefined threshold value “xr”. In addition, the CPU 201 compares an absolute value of the average value “LyA” of the swing length “Ly” in the y-direction to a predefined threshold value “yr”.

In step S185, the CPU 201 sets an angle flag on the basis of the result of the step S184 (refer to FIG. 23(a)).

In step S186, the CPU 201 judges the signs of the average values “LxA” and “LyA” of the swing lengths “Lx” and “Ly”.

In step S187, the CPU 201 sets a direction flag on the basis of the result of the step S186 (refer to FIG. 23(b)), and then the process proceeds to step S167 of FIG. 43.

In the mean time, in step S188, the CPU 201 resets the target point counter “n”. In step S189, the CPU 201 turns the swing flag and the swing end flag off. Then, the process proceeds to step S65 of FIG. 38.

FIG. 45 is a flowchart showing the process flow of calculating coordinates of the sword locus in step S167 of FIG. 43. As illustrated in FIG. 45, the CPU 201 determines swing information on the basis of the angle flag and the direction flag in step S200 (refer to FIG. 23(a) to 23(c)). Then, if the swing information is “A0” or “A1”, the CPU 201 proceeds to step S201. If the swing information is “A2” or “A3”, the CPU 201 proceeds to step S202. If the swing information is any one of “A4” to “A7”, the CPU 201 proceeds to step S203.

In step S201, the CPU 201 calculates the center coordinates (xt, yt) of the sword locus object 117 using the formulas (8) and (9).

In step S202, the CPU 201 calculates the center coordinates (xt, yt) of the sword locus object 117 using the formulas (10) and (11).

In step S203, the CPU 201 calculates the temporary coordinates (xs, ys) using the formulas (12) and (13), and then calculates the intersecting coordinates (xI, yI) where a straight line passing the temporary coordinates (xs, ys) intersects with a diagonal line of the screen.

Then, in step S204, the CPU 201 defines the intersecting coordinates (xI, yI) as the center coordinates (xt, yt) of the sword locus object 117.

Incidentally, after step S201, S202 and S204, the process proceeds to step S168 of FIG. 43.

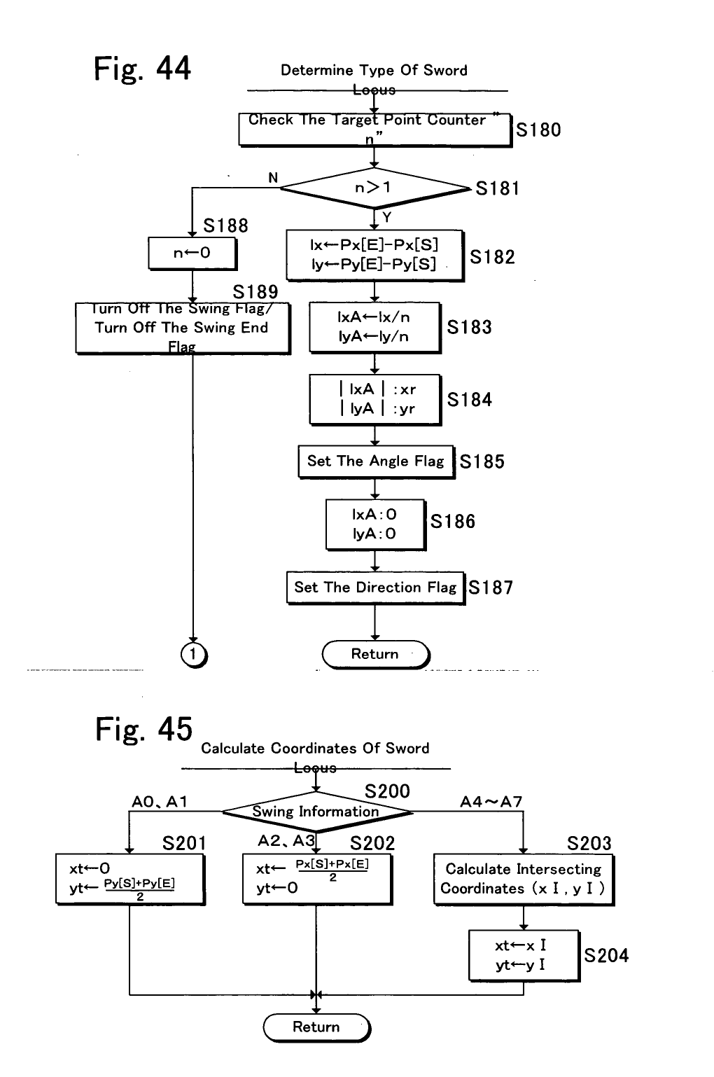

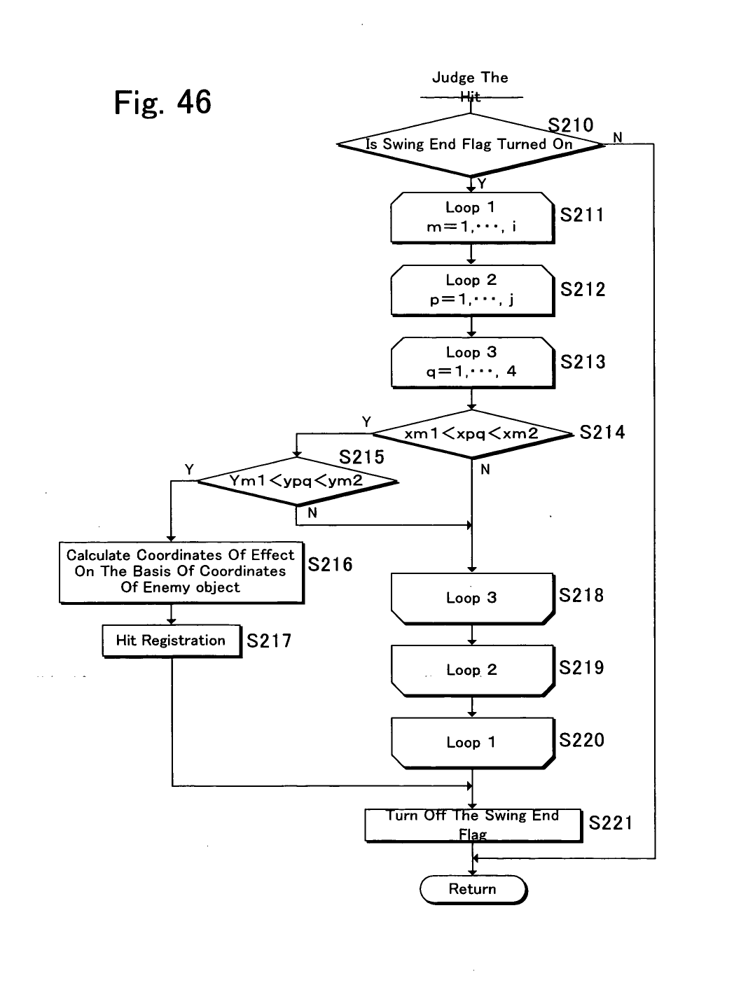

FIG. 46 is a flowchart showing the process flow of hit judging process in step S64 of FIG. 38. As illustrated in FIG. 46, if the swing end flag is turned off in step S210, the process from step S211 to S221 is skipped and then the process proceeds to step S65 of FIG. 38. This is because if the swing end flag is turned off, the speed of the target point is not less than or equal to the predefined threshold value and the target point does not go out of the photographing range as well, the swing of the sword 3 is not decided yet, and therefore the sword locus object 117 is not displayed. Namely, the performance of the hit judging process does not need.

Besides, the process from step S212 to S219 is repeatedly performed between steps S211 and S220. Incidentally, “m” represents the identification number which is assigned to the enemy object 115, and “i” represents the number of the enemy objects 115. Therefore, the process from step S212 to step S219 is repeatedly performed the same number of times as the number of the enemy objects 115. Namely, the hit judgment is applied to all enemy objects 115.

In addition, the process from step S213 to step S218 is repeatedly performed between step S212 and step S219. Incidentally, “p” represents the identification number which is assigned to the fictive rectangle and “j” represents the number of the fictive rectangles. In FIG. 30, j=5. Therefore, the process from step S213 to step S218 is repeatedly performed the same number of times as the number of the fictive rectangles. Namely, all fictive rectangles are judged whether or not they overlap with the enemy object 115. By the way, as explained above, the fictive rectangle is added virtually on the sword locus object 117. If this overlaps with the hit range 325 including the enemy object 15, it is the hit.

In addition, the process of steps S214 and S215 is repeatedly performed between step S213 and step S218. Incidentally, “q” represents the number which is assigned to the vertex of the fictive rectangle. Therefore, the process of step S215 and S216 is repeatedly performed the same number of times as the number of the vertexes of the fictive rectangle. Namely, if any one of the vertexes of the fictive rectangle is within the hit range 325 including the enemy object 15, it is the hit.

Meantime, in step S214, the CPU 201 judges whether or not an x-coordinate (xpq) of the vertex of the fictive rectangle is within the range from x-coordinate “xm1” of the hit range 325 to “xm2” thereof. If it is not within the range, the process proceeds to step S218, if it is within the range, the process proceeds to step S215.

In step S215, the CPU 201 judges whether or not the y-coordinate (ypq) of the vertex of the fictive rectangle is within the range from y-coordinate “ym1” of the hit range 325 to “ym2” thereof. If it is not within the range, the process proceeds to step S218, if it is within the range, process proceeds to step S216.

In step S216, the CPU 201 calculates the coordinates of the effect 119 on the basis of the coordinates of the enemy object 115. If xm1<xpq<xm2 and ym1<ypq<ym2 are satisfied, it can be considered that the sword locus object 117 hits the enemy object 115. Therefore, the effect 119 needs to be displayed.

In step 217, the CPU 201 registers storage location information of the animation table to animate the effect 119 according to the swing information “A0” to “A7” (a hit registration, i.e., a trigger).

In step S221, the CPU 201 turns the swing end flag off.

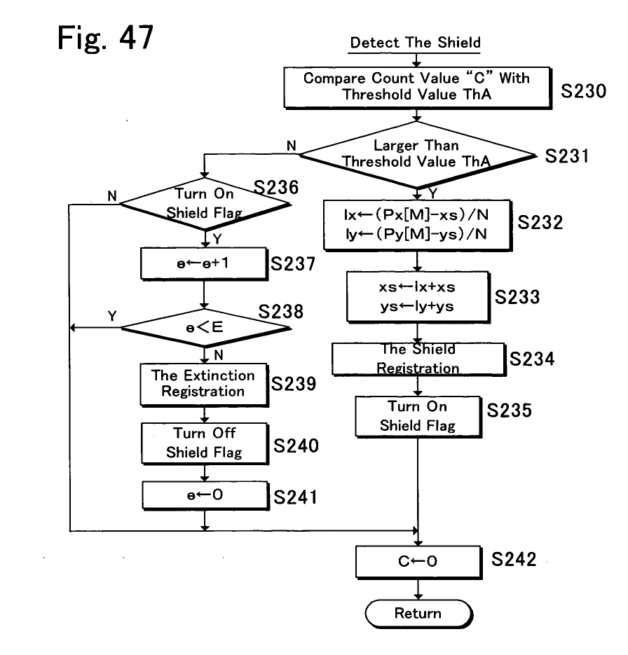

FIG. 47 is a flowchart showing the process flow of detecting a shield in step S65 of FIG. 38. As illustrated in FIG. 47, the CPU 201 compares the count value “c” of the target point counter to the predefined threshold value “ThA” in step S230.

In step S231, if the CPU 201 determines the count value “c” is larger than the predefined threshold value “ThA”, namely, if the reflecting sheet 17 attached on the side of the blade 15 of the sword 3 is detected, the process proceeds to step S232.

In step S232, the CPU 201 calculates a movement distance “lx” in the x-direction and a movement distance “ly” in the y-direction of the shield object 123 using the formulas (14) and (15).

In step S233, the CPU 201 calculates the coordinates (xs, ys) after movement of the shield object 123 using the formulas (16) and (17).

In step S234, the CPU 201 registers storage location information of the animation table to animate the shield object 123 (a registration of the shield, i.e., a trigger).

In step S235, the CPU 201 turns the shield flag on.

In step S242, the CPU 201 resets the target point counter “c”, and then proceeds to step S66 of FIG. 38.

Meantime, in step S231, if the CPU 201 determines the count value “c” is equal to or smaller than a predefined threshold value “ThA”, i.e., if the reflecting sheet 17 attached on the side of the blade 15 of the sword 3 is not detected, the process proceeds to step S236.

In step S236, the CPU 201 judges whether or not the shield flag is turned on. If the shield flag is turned on, the process proceeds to step S237, otherwise proceeds to step S242.

In step S237, the CPU 201 increments a shield extinction counter “e”.

In step S238, the CPU 201 judges whether or not the shield extinction counter “e” is smaller than a predefined value “E”. If the shield extinction counter “e” is smaller than the predefined value “E”, the process proceeds to step S242, otherwise proceeds to step S239. In other words, in step S238, if the reflecting sheet 17 attached on the side of the sword 3 is not detected for successively “E” times after the shield flag is turned on, the process proceeds to step S239 to extinguish the shield object 123.

In step S239, the CPU 201 sets the display coordinates of the shield object 123 to the outside of the screen 91 (an extinction registration). Therefore, the shield object 123 is not displayed on the screen 91.

In step S240, the CPU 201 turns the shield flag off. In step S241, the CPU 201 resets the shield extinction counter “e”.

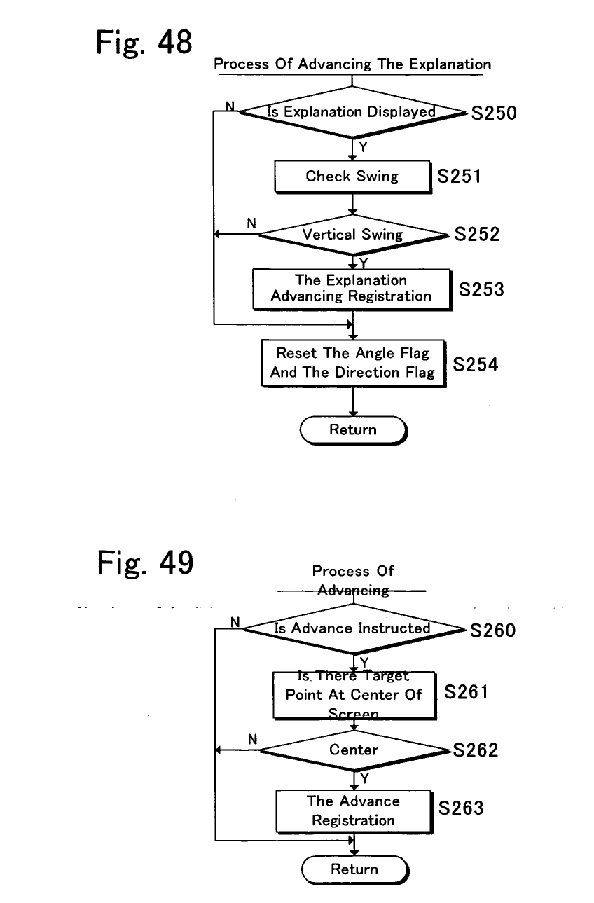

FIG. 48 is a flowchart showing the process flow of advancing an explanation in step S66 of FIG. 38. As illustrated in FIG. 48, the CPU 201 judges whether or not the explanation object 129 has been displayed in step S250. If the explanation object 129 has not been displayed, the process proceeds to step S254, otherwise proceeds to step S251.

In step S251, the CPU 201 checks the swing of the sword 3 with reference to the angle flag and the direction flag.

If the sword 3 is swung down vertically (the swing information is “A3”), the CPU 201 proceeds to step S253, otherwise proceeds to step S254 (step S252).

In step S253, the CPU 201 registers storage location information of the animation table to display the next explanation object 129 (an explanation advancing registration, i.e., a trigger).

In step S254, the CPU 201 resets the angle flag and the direction flag, and then the process proceeds to step S67 of FIG. 38.

FIG. 49 is a flowchart showing the process flow of advancing in step S67 of FIG. 38. As illustrated in FIG. 49, the CPU 201 judges whether or not the explanation object 132 instructing to advance is displayed on the screen 91 in step S260. If the explanation object 132 is displayed, the process proceeds to step S261, otherwise proceeds to step S68 of FIG. 38.

In step S261, the CPU 201 checks if the target point of the sword 3 exists in a predefined area around the center coordinates of the screen during the predetermined number of frames.

If the target point of the sword 3 exists in the predefined area around the center coordinates of the screen during the predetermined number of frames, the process proceeds to step S263, otherwise proceeds to step S68 of FIG. 38 (step S262).

In step S263, each time a predetermined distance is advanced within the virtual space, the CPU 201 updates all elements of the array to display the background (an advance registration).

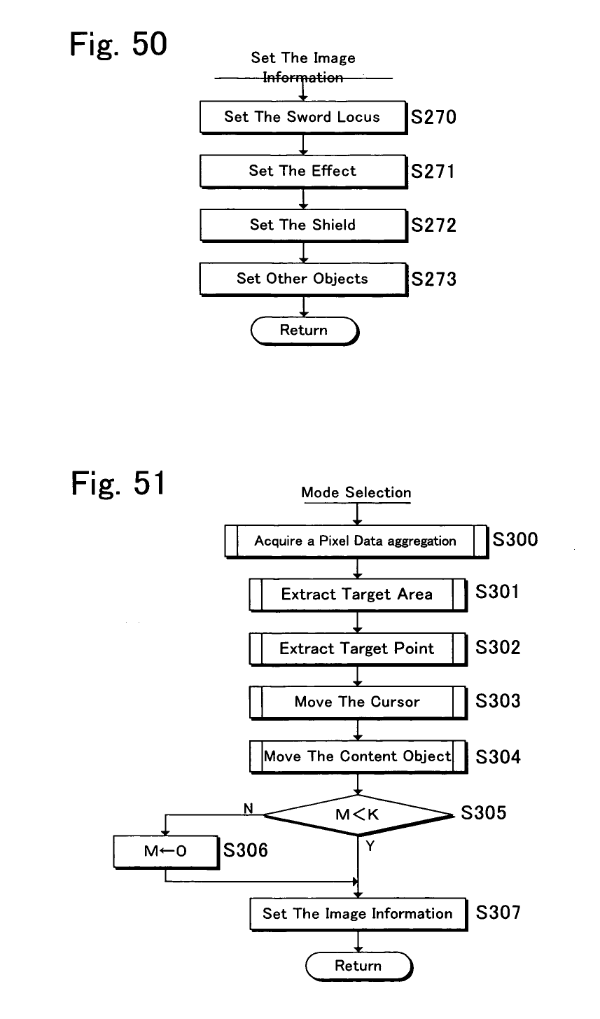

FIG. 50 is a flowchart showing the process flow of setting image information in step S70 of FIG. 38. As illustrated in FIG. 50, in step S270, if the sword locus registration has already been performed, the CPU 201 sets image information related to the sword locus object 117. More specific description is as below.

The CPU 201 calculates coordinates of each sprite constructing the sword locus object 117 on the basis of the center coordinates (xt, yt) of the sword locus 117, size information of the sword locus object 117 and size information of a sprite.

In addition, the CPU 201 calculates storage location information of the sword locus object 117 to be displayed on the basis of the image storage location information, the picture specifying information and the size information in accordance with the animation table. Furthermore, the CPU 201 obtains storage location information of each sprite constructing the sword locus object 117 to be displayed on the basis of the size information of the sprite.

In step S271, if the hit registration has already been performed, the CPU 201 sets image information related to the effect 119. More specific description is as below.

The CPU 201 calculates coordinates of each sprite constituting the effect 119 on the basis of the coordinates of the effect 119, size information of the effect 119 and size information of the sprite.

In addition, the CPU 201 calculates storage location information of the effect 119 to be displayed on the basis of image storage location information, the picture specifying information and size information in accordance with the animation table. Furthermore, the CPU 201 obtains storage location information of each sprite constructing the effect 119 to be displayed.

In step S272, if the shield registration has already been performed, the CPU 201 sets image information related to the shield object 123. More specific description is as below.

The CPU 201 calculates coordinates of each sprite constructing the shield object 123 on the basis of the center coordinates (xs, ys) of the shield object 123, size information of the shield object 123 and size information of sprite.

In addition, the CPU 201 calculates storage location information of the shield object 123 to be displayed on the basis of image storage location information, the picture specifying information and size information in accordance with the animation table. Furthermore, the CPU 201 obtains storage location information of each sprite constructing the shield object 123 to be displayed.

In step S273, the CPU 201 sets image information (storage location information and display coordinates of each sprite) related to other objects (e.g., the explanation object 129 and so forth) consisting of sprites.

FIG. 51 is a flowchart showing the process flow of selecting a mode in step S5 of FIG. 32. As illustrated in FIG. 51, the process from step S300 to S302 is same as the process from step S60 to S62 in FIG. 38, and therefore, no redundant description is repeated.

In step S303, the CPU 201 performs the movement process for a cursor 101.

FIG. 52 is a flowchart showing the process flow of moving the cursor 101 in step S303 of FIG. 51. As illustrated in FIG. 52, the CPU 201 calculates coordinates of the cursor 101 on the basis of the coordinates of the target point of the sword 3 in step S320.

In step S321, the CPU 201 registers storage location information of the animation table to animate the cursor 101 (a cursor registration, i.e., a trigger).

Returning to FIG. 51, the CPU 201 performs the movement process for the content object 109 in step S304.

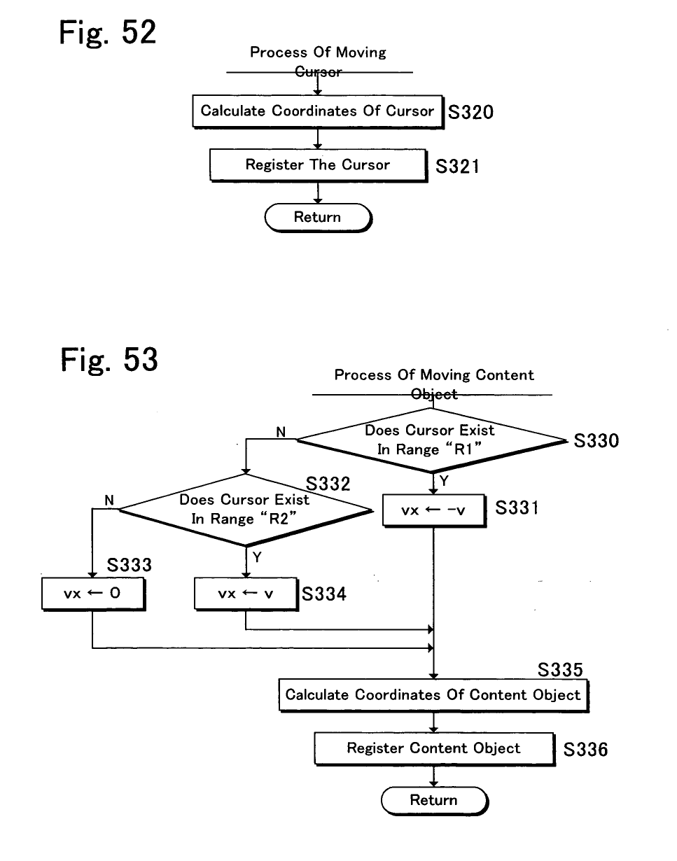

FIG. 53 is a flowchart showing the process flow of moving the content object in step S304 of FIG. 51. As illustrated in FIG. 53, the CPU 201 judges whether or not the cursor 101 exists in the range “R1” around the center point of the leftward rotation instructing object 103 of FIG. 12 in step S330. If the cursor 101 exists in the range “R1”, the CPU 201 proceeds to step S331, otherwise proceeds to step S332.

In step S331, the CPU 201 sets the speed “vx” in the x-direction of the content object 109 to “−v”.

On the other hand, in step S332, the CPU 201 judges whether or not the cursor 101 exists in the range “R2” around the center point of the rightward rotation instructing object 105 of FIG. 12. If the cursor 101 exists in the range “R2”, the CPU 201 proceeds to step S334, otherwise proceeds to step S333.

In step S334, the CPU 201 sets the speed “vx” in the x-direction of the content object 109 to “v”.

On the other hand, the CPU 201 sets the speed “vx” in the x-direction of the content object 109 to “0” in step S333.

In step S335, the CPU 201 adds the speed “vx” to an x-coordinate of the content object 109, and defines it as a x-coordinate of the content object 109 after moved.

In step S336, the CPU 201 registers storage location information of the animation table to animate the content object 109 (a content object registration).

Returning to FIG. 51, the process of step S305 and S306 are same as step S68 and S69 of FIG. 38, and therefore no redundant description is repeated.

In step S307, the CPU 201 sets the image information related to the cursor 101. More specific description is as below.

The CPU 201 calculates coordinates of each sprite constructing the cursor 101 on the basis of coordinates of the cursor 101, size information of the cursor 101 and size information of the sprite.

Then, the CPU 201 calculates storage location information of the cursor 101 to be displayed on the basis of image storage location information, the picture specifying information and the size information in accordance with the animation table. Furthermore, the CPU 201 calculates storage location information of each sprite constructing the cursor 101 to be displayed.

The CPU 201 sets the image information related to the content object 109. More specific description is as below.

The CPU 201 calculates coordinates of each sprite constructing the content object 109 on the basis of coordinates of the content object 109, size information of the content object 109 and size information of the sprite.

In addition, the CPU 201 calculates storage location information of the content object 109 to be displayed on the basis of image storage location information, the picture specifying information and the size information in accordance with the animation table. Furthermore, the CPU 201 obtains storage location information of each sprite constructing the content object 109 to be displayed.

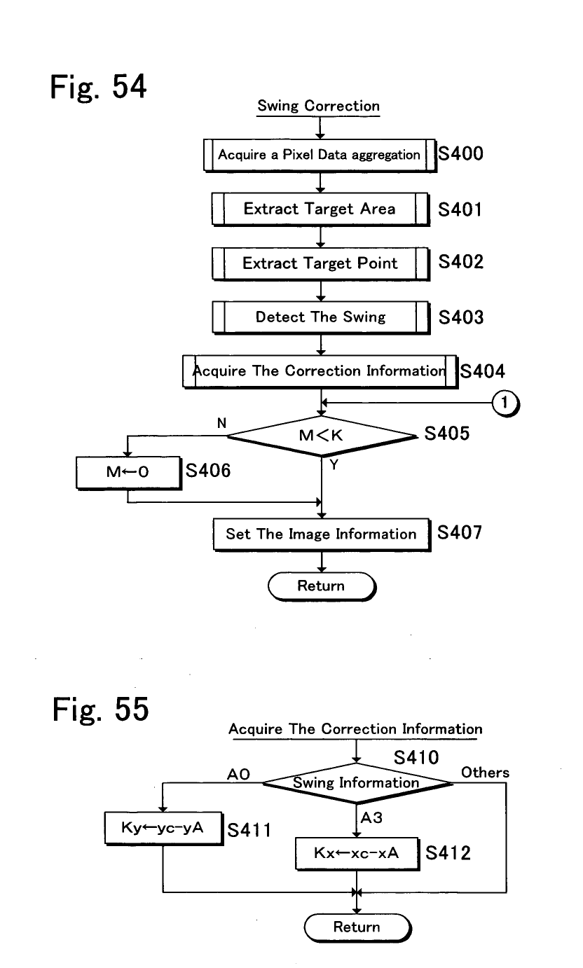

FIG. 54 is a flowchart showing the process flow of a swing correcting mode in step S6 of FIG. 32. As illustrated in FIG. 54, the process from step S400 to S403 is same as the process from step S60 to S63 of FIG. 38, and therefore, no redundant description is repeated.

In step S404, the CPU 201 obtains the correction information “Kx” and “Ky” (refer to FIG. 31).

FIG. 55 is a flowchart showing the process flow of acquiring the correction information in step S404 of FIG. 54. As illustrated in FIG. 55, in step S410, the CPU 201 determines the swing information on the basis of the angle flag and the direction flag (refer to FIG. 23(a) to 23(c)). Then, if the swing information is “A0”, the CPU 201 proceeds to step S411. If the swing information is “A3”, the CPU 201 proceeds to step S412. If the swing information is any one of the others, the CPU 201 proceeds to step S405 of FIG. 54.

In step S411, the CPU 201 calculates the correction information “Ky” in the y-direction because the sword 3 is swung horizontally.

On the other hand, in step S412, the CPU 201 calculates the correction information “Kx” in the x-direction because the sword 3 is swung vertically.

Returning to FIG. 54, each process of step S405 and S406 is same as step S68 and S69 of FIG. 38, and therefore, no redundant description is repeated.

In step S407, the CPU 201 sets the image information of all sprites to display the swing correction screen (refer to FIG. 31).

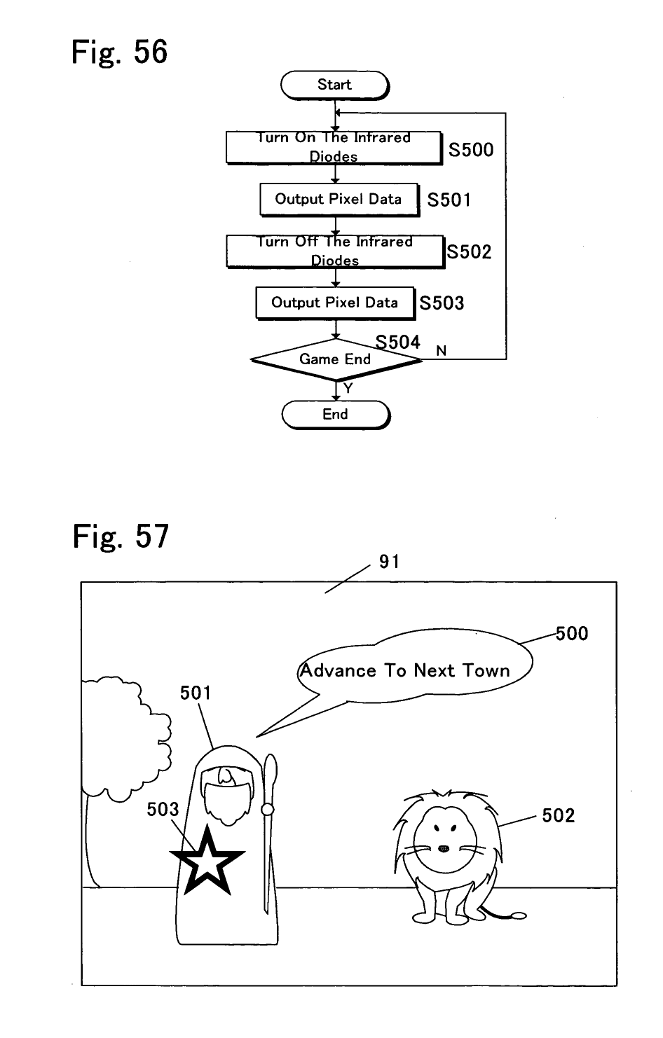

FIG. 56 is a flowchart showing the process flow of stroboscopic imaging by the imaging unit 5. In step S500, the high speed processor 200 turns the infrared-emitting diodes 7 for performing photographing with strobe light. More specifically, the LED control signal “LEDC” illustrated in FIG. 10 is transited to high level. After that, the image sensor 43 outputs pixel data in step S501.

In step S502, the high speed processor 200 turns the infrared-emitting diodes 7 off for performing photographing with strobe light. More specifically, the LED control signal “LEDC” illustrated in FIG. 10 is transited to low level. After that, the image sensor 43 outputs pixel data in step S503.

These processes are repeatedly performed until the game is over (step S504).

In what follows, other examples of a game screen are discussed. FIG. 57 is a view showing one of examples of a game screen. As illustrated in FIG. 57, a human object 501 and an animal object 502 are displayed on this game screen. A cursor 503 moves in response to the movement of the sword 3. When the cursor 503 is brought to the human object 501, an explanation object 500 associated with the human object 501 is displayed. On the other hand, when the operator 94 brings the cursor 503 to the animal object 502 by operating the sword 3, an explanation object associated with the animal object 502 is displayed as well (not shown).

The movement process for the cursor 503 is same as the movement process for the cursor 101. Then, when the cursor 502 is brought to a predefined range including the human object 501, the explanation object 500 associated with the human object 501 is displayed. Much the same is true on the animal object 502.

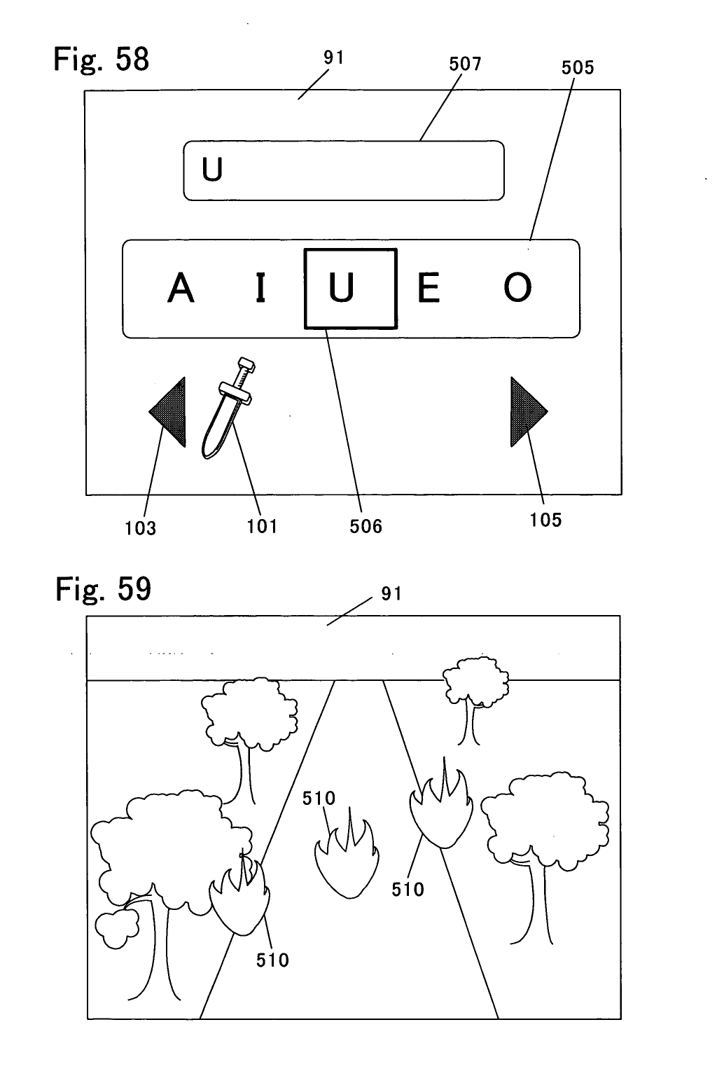

FIG. 58 is a view showing another one of examples of a game screen. As illustrated in FIG. 58, a character selecting part 505, a selection frame 506, a leftward rotation instructing object 103, a rightward rotation instructing object 105, a character display part 507 and a cursor 101 are displayed on this game screen. When the operator 94 moves the cursor 101 by operating the sword 3 and the cursor 101 overlaps with the leftward rotation instructing object 103, characters in the character selecting part 505 rotates leftwards. On the other hand, when it overlaps with the rightward rotation instructing object 105, characters in the character selecting part 505 rotates rightwards. In this way, a character from “A” to “N” is chosen. Then, if the sword 3 is vertically swung down faster than predefined velocity, the character in the selection frame 506 is displayed in the character display part 507. In this way, the operator 94 can display characters in the character display part 507 by operating the sword 3.

By the way, the character rotation process in the character selecting part 505 is same as the rotation process of the content object 109 of FIG. 12.

FIG. 59 is a view showing further one of the examples of a game screen. As illustrated in FIG. 59, flame objects 510 are displayed on diagonal line on this game screen. These are displayed in response to a fact that the operator 94 swings the sword 3 obliquely. In other words, in above examples, when the operator 94 swings the sword 3, the sword locus object 117 corresponding to the movement is displayed. Alternatively, the flame objects 510 are displayed. The process for generating a trigger to display the flame objects 510 is same as the process for generating a trigger to display the sword locus object 117. In addition, for example, the flame objects 510 are displayed on coordinates of the target points.

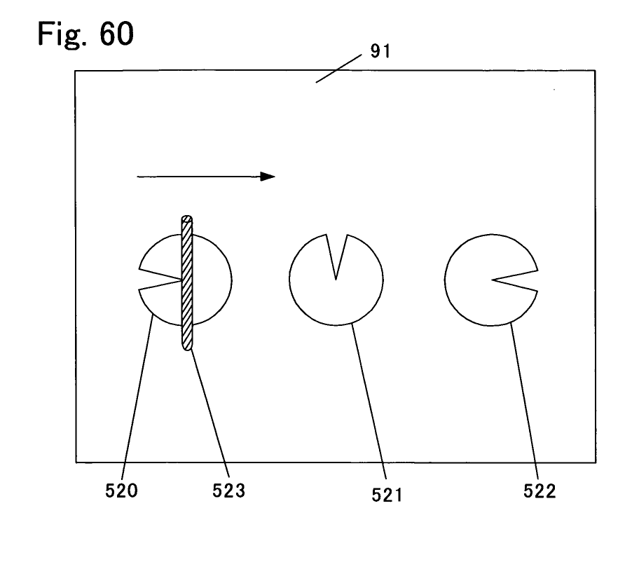

FIG. 60 is a view showing still further one of the examples of a game screen. As illustrated in FIG. 60, swing guides 520, 521 and 522 and a moving bar 523 are displayed on this game screen. The notch of each of the swing guides 520 to 522 instructs the direction that the sword 3 must be swung from. The operator 94 must swing the sword 3 from the direction which one of the swing guides 520 to 522 where the moving bar 523 is overlapped instructs at the time when the moving bar 523 overlaps with one of the swing guides 520 to 522. In the example of FIG. 60, the operator 94 must swing horizontally from left as the swing guide 520 where the moving bar 523 is overlapped indicates.

In addition, a special object can be displayed when the sword 3 is swung properly at the timing when the moving bar 523 indicates and also swung from the direction which each of the swing guides 520 to 522 instructs.

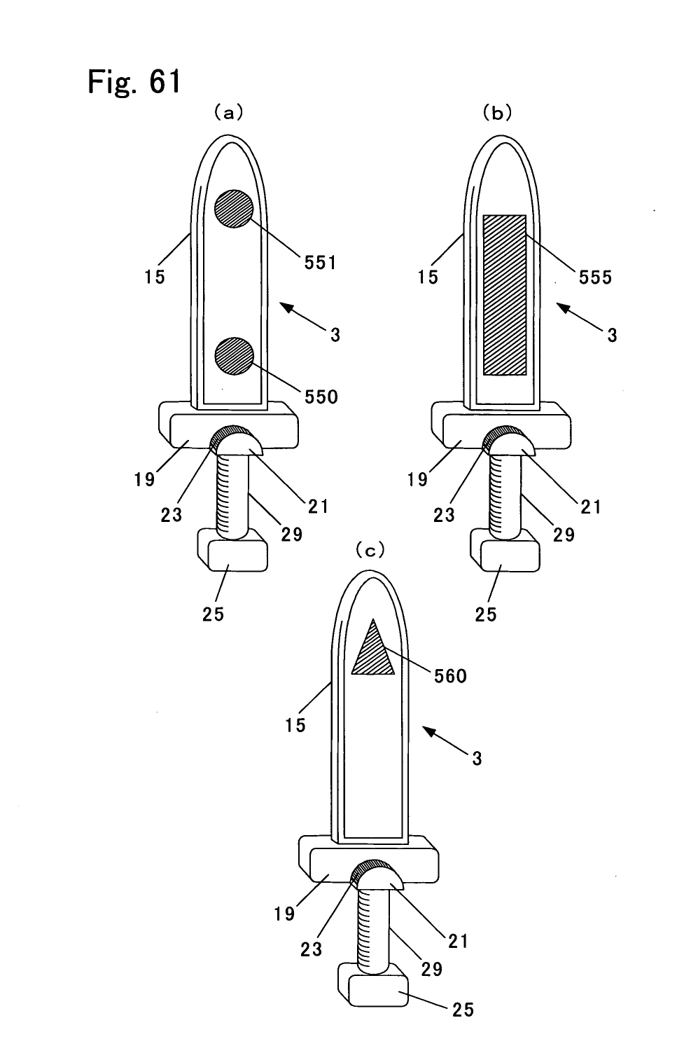

FIG. 61(a) to 61(c) are other examples of the sword 3 of FIG. 1. As illustrated in FIG. 61(a), the sword 3 is provided with circular reflecting sheets 550 and 551 at a certain interval on the sides of the blade 15 instead of the reflecting sheets 17 of FIG. 2. Therefore, it is possible to perform different subsequent process between when two points (the reflecting sheets 550 and 551) are detected and when one point (the reflecting sheets 23 attached in semicylinder-shaped parts 21) is detected. For example, the CPU 201 makes the graphic processor 202 display different images between when two points are detected and one point is detected. The way of detecting two points will be explained in detail later. Incidentally, the image sensor 43 captures the reflecting sheet 23 attached on the one semicylinder-shaped part 21 and the reflecting sheet 23 attached on the other semicylinder-shaped part 21 as one point because they are adjacent to each other.

In addition, as illustrated in FIG. 61(b), the sword 3 is provided with rectangular reflecting sheets 555 on the sides of the blade 15 instead of the reflecting sheets 17 of FIG. 2. The CPU 201 calculates long side to short side ratio of the detected reflecting sheet, and if this ratio is larger than the predefined value, the CPU 201 determines the rectangular reflecting sheet 555 is detected. Therefore, it is possible to change the subsequent processing between when the rectangular reflecting sheet 555 is detected and when the reflecting sheets 23 are detected. For example, the CPU 201 makes the graphics processor 202 display a different image depending on the detected reflective surface.

Furthermore, as illustrated in FIG. 61(c), the sword 3 is provided with triangular reflecting sheets 560 on the sides of the blade 15 instead of the reflecting sheets 17 of FIG. 2. The CPU 201 calculates the shape of the detected reflecting sheet, and if it is triangle, the CPU 201 determines the reflecting sheet 560 is detected. Therefore, it is possible to change the subsequent processing between when the triangular reflecting sheet 555 is detected and when the reflecting sheets 23 are detected. For example, the CPU 201 makes the graphics processor 202 display a different image depending on the detected reflective surface.

Incidentally, it is possible to attach the reflecting sheet 31 of FIGS. 4 and 5 on the tip of the sword 3 in FIG. 61(a) to FIG. 61(c) instead of attaching the semicylinder-shaped parts 21 and the reflecting sheets 23.

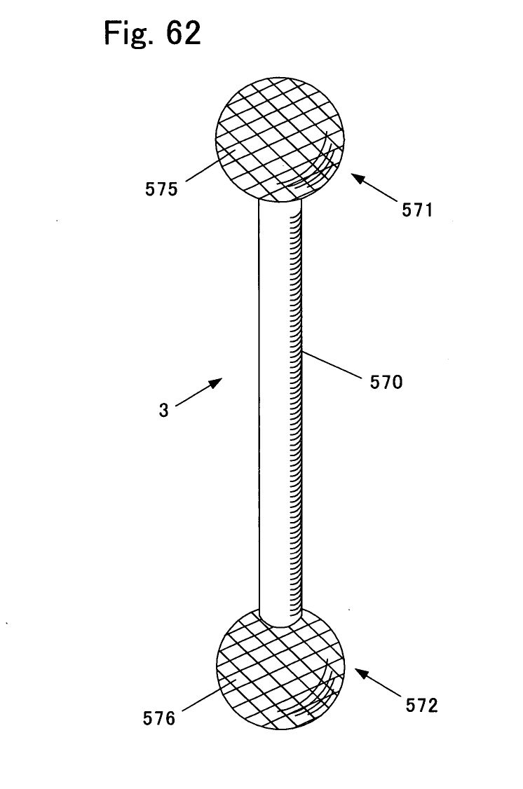

In above description, the sword-shaped operation article 3 is used as an example. Next, the example of the operation article 3 other than the sword-shaped ones will be explained. FIG. 62 is a view showing one of examples of the operation article operated by the operator 94. This operation article 3 is composed of a stick with sphere-shaped members 571 and 572 at both ends. Reflecting sheets 575 and 576 are respectively attached on the sphere-shaped members 571 and 572. The operator 94 operates the operation article 3 with holding the stick 570. The image sensor 43 captures two target points because the reflecting sheets 575 and 576 are attached in certain interval between each other. The CPU 201 calculates the state information of the reflecting sheets 575 and 576. Then the CPU 201 makes the graphics processor 202 display an image depending on the state information of the reflecting sheets 575 and 576.

Next, two points extracting process performed in FIG. 61(a) and FIG. 62 will be explained. In this case, one reflecting sheet is referred as the first reflection sheet, and the other one is referred as the second reflecting sheet.

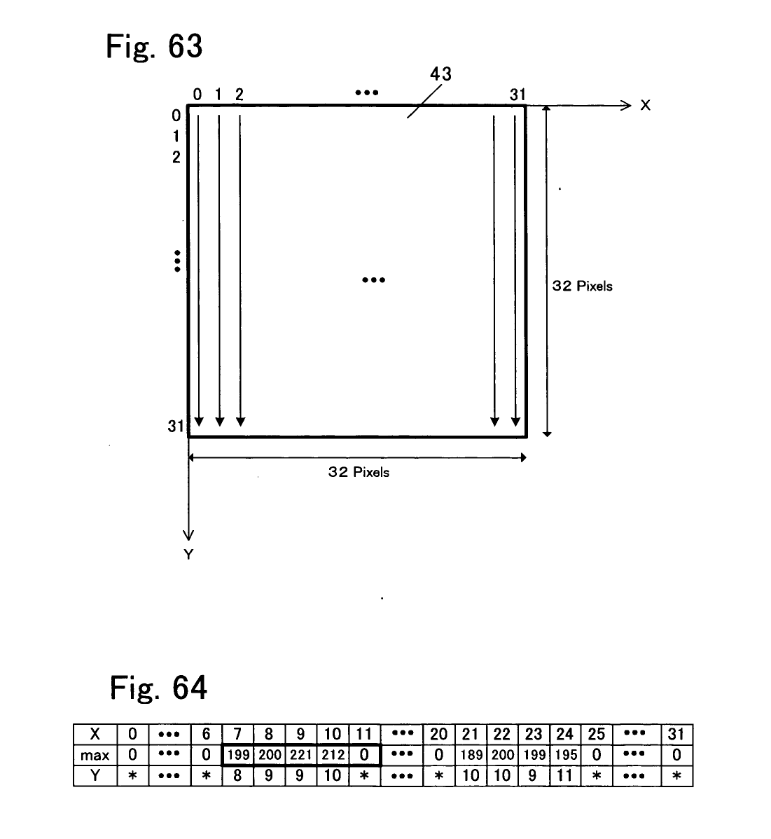

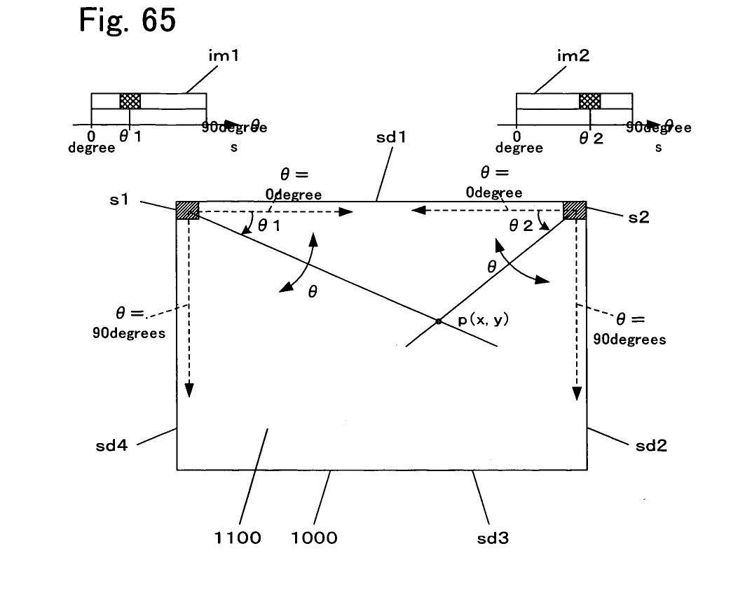

FIG. 63 is an explanatory diagram of calculating the coordinates of the first reflecting sheet (the first target point). As illustrated in FIG. 63, for example, the image sensor 43 consists of 32 pixels×32 pixels. The CPU 1 scans the difference data of the 32 pixels in Y-direction (column direction) while incrementing the X-coordinate in such a way that the difference data of the 32 pixels is scanned in Y-direction, then, the X-coordinate is incremented, then, the difference data of the 32 pixels is scanned in Y-direction, and then the X-coordinate is incremented.

In this case, the CPU 201 finds the difference data of the maximum luminance value from the difference data of the 32 pixels scanned in Y direction, and then compares the maximum luminance value to a predefined threshold “Th”. If the maximum luminance value is larger than the predefined threshold value “Th”, the CPU 201 assigns the value to the array element “max [n]”. On the other hand, if the maximum luminance value is less than or equal to the predefined threshold value “Th”, the CPU 201 assigns a predefined value (e.g., “0”) to the array element “max [n]”.

Incidentally, “n” is an X-coordinate. The CPU 201 can obtain the X-coordinate and the Y-coordinate of the pixel which has the maximum luminance value afterward by executing the storage while relating with the Y-coordinate of the pixel which has a maximum luminance value.

In addition, the CPU 201 scans the array elements “max [0]” to “max [31]”, and finds the maximum value. Then, the CPU 201 stores the X coordinate and the Y coordinate of the maximum value as the coordinates (X1, Y2) of the target point of the first reflecting sheet.

Next, calculations to obtain the coordinates of a target point (the second target point) of the second reflecting sheet will be explained. The CPU 201 masks a certain range around the maximum value between “max [0]” to “max [31]”, in other wards, the certain range around the difference data of the pixel at the coordinates (X1, Y1) of the target point of the first reflecting sheet. This will be explained with reference to figures.

FIG. 64 is an explanatory diagram showing a method to calculate coordinates of the target point of the second reflecting sheet. As illustrated in FIG. 64, the CPU 201 masks a predefined range (the part within a thick line) around a maximum value (in this example of FIG. 64, X=9, Y=9) between array elements “max [0]” and “max [31]”.

Then, the CPU 201 scans the array elements “max [0]” to “max [31]” except the masked range. In other wards, in this example, the CPU 201 scans the array elements “max [0]” to “max [6]” and array elements “max [12]” to “max [31]”.

After that, the CPU 201 finds a maximum value among array elements “max [0]” to “max [6]” and “max [12]” to “max [31]”. The CPU 201 stores an X coordinate and Y coordinate of the found maximum value as the coordinates (X2, Y2) of the target point of the second reflecting sheet. In FIG. 64, the maximum value is the array element “max [22]”. Therefore, the coordinates of the target point of the second reflecting sheet is X2=22, and Y2=10. Incidentally, in this example of FIG. 64, the coordinates of the target point of the first reflecting sheet is X1=9, and Y1=9.

The detection of the coordinates of both the first and second target points is performed while scanning. However, in above explanation, it is explained as if the maximum value is found after scanning for the sake of clarity in explanation.

By the way, in this embodiment, the image sensor 43 captures an image of the sword 3 illuminated intermittently by a stroboscope, and then, the CPU 201 calculates state information of the sword 3. In this way, the state information of the sword 3 within a three dimensional detection space as the photographing range of the image sensor 43 can be obtained without forming a two dimensional detection face in real space. Therefore, the operable range of the sword 3 is not restricted to the two dimensional plane so that the restriction of the operation of the sword 3 by the operator 94 decreases, and thereby it is possible to increase the flexibility of the operation of the sword 3

In addition, it is not necessary to create a detection face corresponding to the screen 91 of the television monitor 90 in real space. Therefore, it is possible to reduce the limitation on the installation places (the saving of a space).

Furthermore, the sword locus object 117 showing a movement locus of the sword 3 is displayed on the screen 91 according to a trigger (registration of the sword locus) in response to a swing of the sword 3. Because of this, the operator 94 can see on the screen 91 the movement locus which is actually invisible, and the operator 94 can swing the sword 3 with more feeling.

In this case, the movement locus of the sword 3 is expressed by displaying the belt-like object which a width is different for each frame. The width of the belt-like object is wide as the frame is updated, and then, narrow as the frame is updated (refer to FIG. 27 to FIG. 29).

Consequently, it is possible to display a movement locus of the sword 3 like a sharp flash. In addition, the effect can be enhanced by selecting appropriately the color of the belt-like object.

The movement locus of the sword 3 operated by the operator appears in a virtual world displayed on the screen 91. Consequently, the operator can make contact with the virtual world through the display of the movement locus of the sword 3 and can furthermore enjoy the virtual world. Namely, it is possible for the operator 94 to have an experience as if the operator 94 were enjoying a game in a game world displayed on the screen 91.

In addition, since the different image (e.g., the sword locus object 117 or the shield object 123) is displayed depending on the reflecting surface which is detected by the imaging unit 5, the different images corresponding to the number of the reflection surfaces can be displayed only by operating the single operation article 3. Therefore, there is no need to prepare a different operation article for each different image and provide a switch, an analog stick and the like on the operation article. Accordingly, it is possible to reduce the cost of the operation article 3, and improve the operationality of the operation article 3 by the operator 94.

Furthermore, the operator 94 can display a desired image (e.g., the sword locus object 117 or the shield object 123) by turning an appropriate one of the reflecting surfaces (e.g., the reflecting sheet 17 and 23) of the sword 3 toward the imaging unit 5. Therefore, it is possible for the operator 94 to display a variety of images by operating the single sword 3, and smoothly enjoy the game.

In addition, the CPU 201 can compute any one, or combination of area information (refer to FIG. 2 to FIG. 5), number information (refer to FIG. 61(a)), profile information (refer to FIG. 61(c)) and ratio information indicative of a profile (refer to FIG. 61(b)) about the sword 3. Accordingly, it is possible to determine which is photographed on the basis of the above information, any one of the reflecting sheets 17, 550, 551, 555 and 560 attached on the side of the blade of the sword 3 or any one of the reflecting sheet 23 attached on semicylinder-shaped component 21 of the sword 3 and the reflecting sheet 31 attached on tip of the sword 3.

In this way, it is easy to decide which of the reflecting sheets is photographed only by making the size or the shape of the reflecting sheet attached on the blade 15 of the sword 3 different from that of the reflecting sheet attached on the tip of the sword 3 or the semicylinder-shaped component 21 of the sword 3. Especially, in the case where the reflecting sheets are distinguished with reference to the area information of sword 3, it is possible not only to avoid erroneous determination as much as possible but also to facilitate and speed up the processing.

The enemy object 115 given the effect 119 is displayed on the screen 91 on the basis of the trigger (an effect registration) generated when the positional relation between the sword locus object 117 and the enemy object 115 satisfies the prescribed condition (refer to FIG. 15).

As has been discussed above, the effect is given to the enemy object 115 existing in a so-called virtual world displayed on the screen 91 through the sword locus object 117 displayed in response to operation by the operator 94. Because of this, the operator 94 can furthermore enjoy the virtual world.

In addition, the CPU 201 generates a trigger (a sword locus registration) to display the sword locus object 117 when the number of target points of the sword 3, i.e., the number of times the sword 3 is detected is three or more. Therefore, it is possible to prevent the sword locus object 117 from unintentionally appearing when the operator 94 involuntarily operates (refer to FIG. 22). Also, in the case where the number of the target points of the sword 3 (the number of times the sword 3 is detected) is three or more, the appearance of the sword locus object 117 (swing information) is determined on the basis of the first target point and the last target point of the sword 3 (refer to FIG. 22 to FIG. 26). Because of this, it is possible to decide the appearance of the sword locus object 117 reflected the movement locus of the sword 3 in a more appropriate manner.

Incidentally, if the appearance of the sword locus object 117 is determined on the basis of the two adjacent target points of the sword 3, for example, there will be following shortcomings. Even though the operator 94 intends to move the sword 3 linearly, it may be moved with drawing like an arc in practice. In this case, the sword 3 is naturally photographed so as to draw an arc by the image sensor 43. If the appearance of the sword locus object 117 is determined on the basis of the two adjacent target points in the above situation, the sword locus object 117 is displayed in such an appearance as departing from the intention of the operator 94. For example, even though it is intended to swing the sword 3 horizontally, the sword locus object 117 may be displayed in an oblique direction.

In addition, since a character string can be displayed one after another on the screen 91 on the basis of the trigger (an explanation proceeding registration) in accordance with the state information of the sword 3, there is no need to provide a switch, an analog stick and suchlike which are used to update a character string on the sword 3. Therefore, it is possible not only to reduce the production cost of the sword 3 but also to improve the user-friendliness (refer to FIG. 17).

Additionally, since the background can be updated on the basis of the trigger (a forwarding registration) in accordance with the state information of the sword 3, there is no need to provide a switch, an analog stick and suchlike which are used to update the background on the sword 3. Therefore, it is possible not only to reduce the production cost of the sword 3 but also to improve the user-friendliness (refer to FIG. 18).

Furthermore, the CPU 201 obtains correction information “Kx” and “Ky” to correct position information of the sword 3. The CPU 201 computes corrected position information of the sword 3 using the correction information “Kx” and “Ky”. Consequently, since it is possible to eliminate, as much as possible, the gap between the feeling of the operator 94 operating the sword 3 and the position information of the sword 3 as calculated by the CPU 1, a suitable image can be displayed to reflect the operation of the sword 3 by the operator 94 in a more appropriate manner.

Furthermore, since the cursor 101 can be moved on the basis of the position information of the sword 3, there is no need to provide a switch, an analog stick and suchlike which are used to move the cursor 101 on the sword 3. Therefore, it is possible not only to reduce the production cost of the sword 3 but also to improve the user-friendliness (refer to FIG. 12).

Moreover, it is fixed to perform a prescribed process in accordance with the state information of the sword 3. For example, when the sword 3 is vertically swung down faster than a predefined speed, the selection of the content object 109 is fixed. Then, it is started to perform the process corresponding to the selected content (refer to FIG. 12). In this way, since the execution of the process can be fixed on the basis of the state information of the sword 3, there is no need to provide a switch, an analog stick and suchlike which are used to fix the execution of the process on the sword 3. Therefore, it is possible not only to reduce the production cost of the sword 3 but also to improve the user-friendliness.

Additionally, when the cursor 503 overlaps the human object 501, the explanation object 500 associated with the human object 501 is displayed (refer to FIG. 57). Therefore, the operator 94 can display an image associated with the human object 501 being displayed only by operating the sword 3 to move the cursor 503.

Furthermore, it is possible to display a character selected by the cursor 101 on the screen 91 (refer to FIG. 58). Consequently, by just operating the sword 3 to move the cursor 101 and then selecting a desired character, the operator 94 can input a character. Therefore, it is not necessary to provide a switch, an analog stick and suchlike with the sword 3 for inputting characters. As a result, it is possible not only to reduce the production cost of the sword but also to improve the user-friendliness.

In addition, it is possible to display the flame objects 510 corresponding to a movement of the sword 3 on screen 91 in response to a trigger in accordance with the state information of the sword 3. Consequently, it is possible to give the operator 94 a different visual effect from the sword locus object 117 showing a movement locus of the sword 3 (refer to FIG. 59).

Furthermore, it is possible to display the sword locus object 117 expressing the movement locus of sword 3 on the screen 91 after the elapse of a predetermined time (in terms of human sensibility) from the sword locus registration (generation of a trigger). In this case, it is possible to give the operator 94 different effects as compared to the case that the sword locus object 117 is displayed at the substantially same time (at the same time in terms of human sensibility) as the sword locus registration (generation of the trigger).

Furthermore, it is possible to display a predetermined object when the continuous state information of the sword 3 satisfies a predetermined condition (e.g., the sword 3 is sequentially swung such as vertically, then, horizontally, and then vertically). Consequently, since the predetermined object is displayed only when the operation of the sword 3 satisfies the predetermined condition, it is possible to arbitrarily control the operation of the sword 3 by the operator 94 for displaying the predetermined object by changing the setting of this predetermined condition.

Furthermore, it is possible to display guide objects 520 to 522 which instruct the operation directions of the sword 3 and the moving bar 523 which instructs operation timing of the sword 3. In this case, the operator 94 can visually recognize the operation directions and the operation timing of the sword 3 as required by the information processing apparatus 1.

Furthermore, the CPU 201 can compute one of, some of, or all of speed information, moving direction information, moving distance information, velocity vector information, acceleration information, movement locus information, area information, and positional information as state information. Therefore, it is possible to display objects on the screen 91 in response to a variety of motion patterns of the sword 3 operated by the operator 94.

Furthermore, it is possible to output sound effects through a speaker of television monitor 90 on the basis of the sword locus registration (trigger). By of this, it is possible to provide the operator 94 with auditory effects in addition to visual effects. Consequently, the operator 94 can furthermore enjoy the virtual world displayed on the screen 91. For example, if sound effects are output at the same time as the movement locus 117 of the sword 3 operated by the operator 94 appears in the virtual world, the operator 94 can furthermore enjoy the virtual world.

Additionally, it is possible to display the image in accordance with state information of the reflecting sheets 575 and 576 attached on the operation article 3. In this way, it is possible to display an image which is reflected the state of the operation article 3 more as compared with the case where an images is displayed in accordance with state information of a single reflecting sheet (refer to FIG. 62).

Furthermore, the detection can be performed with a high degree of accuracy and less influences of noise and external disturbance, only by a simple process of generating a differential signal between the lighted image signal and the non-lighted image signal. Therefore, it becomes possible to realize the system with ease even under the limitation on the performance of the information processing apparatus 1 due to a cost and tolerable power consumption.

Incidentally, the present invention is not limited to the above embodiment, and a variety of variations and modifications may be effected without departing from the spirit and scope thereof, as described in the following exemplary modifications.

(1) In this embodiment, the sword-shaped operation article 3 is used as an example (refer to FIGS. 2, 4 and 61), however, it is not limited thereto. In addition, it is not limited to the operation article 3 illustrated in FIG. 62 either. Namely, it is possible to change the shape of the operation article 3 into arbitrary shape as long as it has a component which reflects light (e.g., retroreflective sheet).

(2) In this embodiment, the sword locus object 117 is expressed by animations as illustrated in FIG. 27 to FIG. 29. However, it is not limited thereto.

(3) In this embodiment, the operation article 3 is provided with two kinds of reflecting surfaces (e.g., reflecting sheets 17 and 23 of FIG. 2). However, it is possible to be provided with only one reflecting surface, or more than three kinds of reflecting surfaces.

(4) While any appropriate processor can be used as the high speed processor 200 of FIG. 7, it is preferred to use the high speed processor (trade name: XaviX) in relation to which the applicant has been filed patent applications. The details of this high speed processor are disclosed, for example, in Jpn. unexamined patent publication No. 10-307790 and U.S. Pat. No. 6,070,205 corresponding thereto.

While the present invention has been described in terms of embodiments, those skilled in the art will recognize that the invention is not limited to the embodiments described. The present invention can be practiced with modification and alteration within the spirit and scope of the appended claims. The description is thus to be regarded as illustrative instead of limiting in any way on the present invention.

1.-32. (canceled)

33. An information processing apparatus for displaying on a display device an image on which a motion of an operation article which is held and given the motion by an operator is reflected, said information processing apparatus comprising:
an imaging unit operable to photograph the operation article which has a reflecting surface;
a state information computing unit operable to compute state information of the reflecting surface on the basis of an image obtained by said imaging unit and generate a first trigger on the basis of the state information; and
an image display processing unit operable to display on the display device a first object representing a movement locus of the operation article in response to the first trigger.

34. The information processing apparatus as claimed in claim 33, wherein the first object representing the movement locus comprises a beltlike object,
said image display processing unit represents the movement locus of the operation article by displaying the beltlike object on the display device so that a width of the beltlike object varies for each prescribed unit which includes at least one frame, and
the width of the beltlike object increases as the frame is updated, and thereafter decreases as the frame is updated.

35. The information processing apparatus as claimed in claim 34, wherein said image display processing unit displays a second object on the display device,
said state information computing unit generates a second trigger when positional relation between the second object and the first object representing the movement locus of the operation article meets a predetermined condition, and
said image display processing unit displays a predetermined effect on the display device in response to the second trigger.

36. The information processing apparatus as claimed in claim 33, wherein said state information computing unit computes positional information as the state information of the reflecting surface after speed information as the state information of the reflecting surface exceeds a predetermined first threshold value until the speed information becomes less than a predetermined second threshold value, or computes the positional information of the reflecting surface after the speed information of the reflecting surface exceeds the predetermined first threshold value but before the reflecting surface deviates beyond a photographing range of said imaging unit,
said state information computing unit determines, when the positional information of the reflecting surface is obtained for three or more times, appearance of the first object representing the movement locus of the operation article on the basis of the first positional information of the reflecting surface and the last positional information of the reflecting surface, and
said state information computing unit generates, when the positional information of the reflecting surface is obtained for three or more times, the first trigger on the basis of the state information.

37. The information processing apparatus as claimed in claim 33, wherein the first object representing the movement locus comprises a beltlike object,
said image display processing unit represents the movement locus of the operation article by displaying the beltlike object on the display device so that a width and a length of the beltlike object vary for each prescribed unit which includes at least one frame, and
the beltlike object increases in length as the frame is updated, and when the length becomes a predetermined length, the width of the beltlike object decreases as the frame is updated.

38. The information processing apparatus as claimed in claim 33 further comprising a correction information acquisition unit operable to acquire correction information for correcting positional information as the state information of the reflecting surface, and
said state information computing unit computes corrected positional information by using the correction information.

39. The information processing apparatus as claimed in claim 33, wherein the first object includes a plurality of objects.

40. The information processing apparatus as claimed in claim 33, wherein said image display processing unit displays the first object representing the movement locus of the operation article on the display device after a lapse of a predetermined time from a generation of the first trigger.

41. An information processing apparatus for displaying an image on a display device on the basis of a result of detecting an operation article which is grasped and given a motion by an operator, said information processing apparatus comprising:
an imaging unit operable to photograph the operation article which has a plurality of reflecting surfaces;
a state information computing unit operable to compute state information of the reflecting surface on the basis of an image obtained by said imaging unit and determine which of the plurality of reflecting surfaces is photographed on the basis of the state information; and
an image display processing unit operable to display a different image on the display device depending on the determined reflecting surface.

42. The information processing apparatus as claimed in claim 41, wherein the state information includes any one of area information, profile information, and ratio information indicative of a profile, or a combination thereof about the reflecting surface.

43. An information processing apparatus for displaying an image on a display device on the basis of a result of detecting an operation article which is grasped and given a motion by an operator, said information processing apparatus comprising:
an imaging unit operable to photograph the operation article which has a plurality of reflecting surfaces;
a state information computing unit operable to compute state information of each of the reflecting surfaces on the basis of an image by said imaging unit; and
an image display processing unit operable to display an image on the display device in accordance with the state information of the plurality of reflecting surfaces.

44. An information processing apparatus for displaying on a display device an image on which a motion of an operation article which is held and given the motion by an operator is reflected, said information processing apparatus comprising:
an imaging unit operable to photograph the operation article which has a reflecting surface;
an area information computing unit operable to compute area information of the reflecting surface on the basis of an image obtained by said imaging unit, and generate a trigger when the area information exceeds a predetermined threshold value; and
an image display processing unit operable to display a predetermined object on the display device in response to the trigger.

45. The information processing apparatus as claimed in claim 44, wherein said image display processing unit moves the predetermined object in response to positional information of the reflecting surface, and
a color of the predetermined object is transparent or translucent.

46. An information processing apparatus for displaying on a display device an image on which a motion of an operation article which is held and given the motion by an operator is reflected, said information processing apparatus comprising:
an imaging unit operable to photograph the operation article which has a reflecting surface;
a state information computing unit operable to compute state information of the reflecting surface on the basis of an image obtained by said imaging unit, and generate a trigger on the basis of the state information; and
an image display processing unit operable to display a character string on the display device, and wherein
said image display processing unit displays a character string differing from the character string on the display device in response to the trigger.

47. An information processing apparatus for displaying on a display device an image on which a motion of an operation article which is held and given the motion by an operator is reflected, said information processing apparatus comprising:
an imaging unit operable to photograph the operation article which has a reflecting surface;
a state information computing unit operable to compute state information of the reflecting surface on the basis of an image obtained by said imaging unit, and generate a trigger on the basis of the state information; and
an image display processing unit updates a background image in response to the trigger.

48. An information processing apparatus for displaying on a display device an image on which a motion of an operation article which is held and given the motion by an operator is reflected, said information processing apparatus comprising:
an imaging unit operable to photograph the operation article which has a reflecting surface;
a positional information computing unit operable to compute positional information of the reflecting surface on the basis of an image obtained by said imaging unit; and
an image display processing unit operable to display a cursor on the display device and moves the cursor in accordance with the positional information of the reflecting surface.

49. The information processing apparatus as claimed in claim 48, wherein, when the cursor is displayed so as to be overlapped on a predetermined object, said image display processing unit displays an image associated with the predetermined object on the display device.

50. The information processing apparatus as claimed in claim 48, wherein said image display processing unit displays a character selected by the cursor on the display device.

51. An information processing apparatus for displaying on a display device an image on which a motion of an operation article which is held and given the motion by an operator is reflected, said information processing apparatus comprising:
an imaging unit operable to photograph the operation article which has a reflecting surface;
a state information computing unit operable to compute state information of the reflecting surface on the basis of an image obtained by said imaging unit; and
a process fixing unit operable to fix execution of a predetermined process on the basis of the state information of the reflecting surface.

52. An information processing apparatus for displaying on a display device an image on which a motion of an operation article which is held and given the motion by an operator is reflected, said information processing apparatus comprising:
an imaging unit operable to photograph the operation article which has a reflecting surface;
a state information computing unit operable to compute state information of the reflecting surface on the basis of an image obtained by said imaging unit; and
an image display processing unit operable to display a predetermined object on the display device when the state information that is obtained successively meets a predetermined condition.

53. An information processing apparatus for displaying an image on a display device on the basis of a result of detecting an operation article which is grasped and given a motion by an operator, said information processing apparatus comprising:
an imaging unit operable to photograph the operation article which has a reflecting surface;
a state information computing unit operable to compute state information of the reflecting surface on the basis of an image obtained by said imaging unit; and
an image display processing unit operable to display on the display device a guide which instructs an operation direction and operation timing of the operation article and display an image on the display device in accordance with the state information.

54. The information processing apparatus as claimed in claim 33, wherein the state information includes one or a combination of two or more being selected from speed information, moving direction information, moving distance information, velocity vector information, acceleration information, movement locus information, area information, and positional information.

55. The information processing apparatus as claimed in claim 43, wherein the state information includes one or a combination of two or more being selected from speed information, moving direction information, moving distance information, velocity vector information, acceleration information, movement locus information, area information, number information, and positional information.

56. The information processing apparatus as claimed in claim 46, wherein the state information includes one or a combination of two or more being selected from speed information, moving direction information, moving distance information, velocity vector information, acceleration information, movement locus information, area information, and positional information.

57. The information processing apparatus as claimed in claim 47, wherein the state information includes one or a combination of two- or more being selected from speed information, moving direction information, moving distance information, velocity vector information, acceleration information, movement locus information, area information, and positional information.

58. The information processing apparatus as claimed in claim 51, wherein the state information includes one or a combination of two or more being selected from speed information, moving direction information, moving distance information, velocity vector information, acceleration information, movement locus information, area information, and positional information.

59. The information processing apparatus as claimed in claim 52, wherein the state information includes one or a combination of two or more being selected from speed information, moving direction information, moving distance information, velocity vector information, acceleration information, movement locus information, area information, and positional information.

60. The information processing apparatus as claimed in claim 53, wherein the state information includes one or a combination of two or more being selected from speed information, moving direction information, moving distance information, velocity vector information, acceleration information, movement locus information, area information, and positional information.

61. An operation article which is operated by the operator of the information processing apparatus as set forth in claim 41,
wherein said operation article is provided with a plurality of reflecting surfaces.

62. An operation article which is operated by the operator of the information processing apparatus as set forth in claim 43, wherein said operation article is provided with a plurality of reflecting surfaces.
